(19) United States
(12) Patent Application Publication
(10) Pub. No.: US 2026/0134823 A1
(43) Pub. Date: May 14, 2026

(54) CONFIGURABLE SUBPIXEL DEFECT COMPENSATION

(71) Applicant: GOOGLE LLC, Mountain View, CA (US)

(72) Inventors: Stuart James Myron Nicholson, San Jose, CA (US); Alexandra Elizabeth Boehm, San Jose, CA (US); Björn Nicolaas Servatius Vlaskamp, Seattle, WA (US); Aurelien Jean Francois David, San Francisco, CA (US); Craig Homer Peters, Belmont, CA (US); Michael Anthony Klug, Austin, TX (US); Richard Peter Schneider, JR., Mountain View, CA (US); Hagar Adler, Seattle, WA (US); Emel Tasyurek, Santa Clara, CA (US)

(21) Appl. No.: 19/389,947

(22) Filed: Nov. 14, 2025

Related U.S. Application Data
(60) Provisional application No. 63/720,434, filed on Nov. 14, 2024.
(60) Provisional application No. 63/895,167, filed on Oct. 7, 2025.

(51) Int. Cl. G09G 3/32

(52) U.S. Cl. CPC G09G 3/32; G09G 2300/0452; G09G 2320/0233; G09G 2320/0242; G09G 2330/08; G09G 2330/10

(57) ABSTRACT

Implementations for configurable subpixel defect compensation are disclosed. A display controller may be configured to determine a defect of a subpixel on a panel of subpixels. The controller may include a module configured to identify the defect of a first subpixel configured to emit light of a first color. The controller may include first circuitry configured to at least partially compensate for the defect using a at least two subpixels configured to emit light of the first color. The controller may also include second circuitry configured to at least partially compensate for the defect using an additional subpixel configured to emit light of a second color different from the first color. The first circuitry and/or the second circuitry may be selectively enabled based on a criterion. Corresponding systems, methods, and computer-readable media are also disclosed.

### CROSS-REFERENCE TO RELATED APPLICATIONS

This application claims priority to U.S. Provisional Patent Application No. 63/720,434, filed on Nov. 14, 2024, entitled “SUBPIXEL DEFECT COMPENSATION”, and U.S. Provisional Patent Application No. 63/895,167 , filed on Oct. 7, 2025, entitled “CONFIGURABLE SUBPIXEL DEFECT COMPENSATION”, the disclosures of which are incorporated herein by reference in their entirety.

### BACKGROUND

Digital displays, and particularly emissive displays such as those using micro light-emitting diode (microLED) or other light-emitting technologies, are used in a wide variety of devices. These displays are typically composed of a large number of individual light-emitting elements, which may be referred to as pixels. A full-color pixel is typically formed from a set of these individual elements, which may be referred to as subpixels and may be configured to each emit light of a single, fundamental color (e.g., red, green, or blue). By controlling the light output of each individual element or subpixel, these displays can collectively form a high-resolution image for a viewer. To produce a full-color image, a display may include an array of subpixels (e.g., red, green, and blue subpixels) that can be combined in various ways to generate a wide spectrum of perceived colors.

Producing a display panel that includes many thousands or millions of these individual light-emitting subpixels involves a complex manufacturing process. For a display to provide a high-quality viewing experience, it may be desirable for the performance of these subpixels to be consistent and uniform across the entire area of the display panel. Achieving such uniformity across a large population of individual electronic components, however, presents various technical challenges. These challenges can, for example, result in performance variations among the individual subpixels.

### SUMMARY

Methods and systems are described herein that provide for a configurable system and method for subpixel compensation. In various implementations, one or more neighboring subpixels may be used to compensate for a subpixel defect, which may improve manufacturing yields and overall display performance. This compensation may be performed in a systematic way using a configurable, multi-phase algorithm that acts as a flexible “toolkit” of compensation options, including both same-color and other-color compensation. To mitigate visual artifacts that may otherwise result, the system may employ novel techniques such as capability-aware symmetric compensation to prevent spatial distortion and content-aware other-color compensation to prevent color distortion.

The heterochromatic (or other-color) aspect of subpixel compensation techniques herein operates based on the principle that the human visual system may be incapable of resolving color for light emitting areas smaller than a certain size, particularly at high display resolutions. Accordingly, certain implementations described herein may use a surrogate subpixel to compensate for light that a deficient subpixel fails to produce, even though the light emitted by the surrogate subpixel is a different color. For example, if a red subpixel is deficient, a proximate green subpixel, which may produce light that is perceived as brighter, may be used to produce extra light to compensate for the missing red light, thereby mitigating the likelihood that a user could perceive the defect. These and other aspects of both same-color and other-color compensation will be described in more detail below.

In some aspects, the techniques described herein relate to a system including: a panel configured to display an image using a plurality of subpixels; and a controller including: a module configured to identify a defect of a first subpixel configured to emit light of a first color, the defect being identified based on a value for the first subpixel in the image; first circuitry configured to at least partially compensate for the defect using a second subpixel and a third subpixel configured to emit light of the first color; and second circuitry configured to at least partially compensate for the defect using a fourth subpixel configured to emit light of a second color different from the first color; wherein at least one of the first circuitry or the second circuitry is enabled based on a criterion.

In some aspects, the techniques described herein relate to a method including:
identifying a defect of a deficient subpixel configured to emit light of a first color, the defect being identified based on a value for the deficient subpixel in an image and including a portion of the defect that is not yet compensated; determining a request value, a headroom of a first same-color surrogate subpixel for the image, and a headroom of a second same-color surrogate subpixel for the image, the first same-color surrogate subpixel and the second same-color surrogate subpixel being configured to emit light of the first color and the request value being based on the portion of the defect; determining an amount of compensation based on the request value, the headroom of the first same-color surrogate subpixel, and the headroom of the second same-color surrogate subpixel; and increasing a value for the first same-color surrogate subpixel in the image and a value for the second same-color surrogate subpixel in the image by the amount of compensation.

In some aspects, the techniques described herein relate to a method including: determining a defect of a deficient subpixel configured to emit light of a first color, the defect being determined based on a value for the deficient subpixel in an image and including a portion of the defect that is not yet compensated; determining that a value for a different-color surrogate subpixel in the image exceeds a threshold, the different-color surrogate subpixel being configured to emit light of a second color different from the first color; determining, in response to the determining that the value for the different-color surrogate subpixel exceeds the threshold, a request value and a headroom of the different-color surrogate subpixel for the image, the request value being based on the portion of the defect; determining an amount of compensation based on the request value and the headroom of the different-color surrogate subpixel; and increasing the value for the different-color surrogate subpixel by the amount of compensation.

In some aspects, the techniques described herein relate to a method including: identifying a first subpixel within an array of subpixels forming a color image, the first subpixel being identified based on a brightness threshold and being configured to emit light of a first color at a first position within the color image; selecting a second subpixel within the array of subpixels, the second subpixel being selected based on the first position and the brightness threshold and being configured to emit light of a second color different from the first color at a second position within a proximity threshold of the first position within the color image; and using the second subpixel to compensate for the first subpixel for a presentation of the color image.

In some aspects, the techniques described herein relate to a non-transitory computer-readable medium storing instructions that, when executed, cause a processor of a computing device to perform a process including: identifying a first subpixel within an array of subpixels forming a color image, the first subpixel being identified based on a brightness threshold and being configured to emit light of a first color at a first position within the color image; selecting a second subpixel within the array of subpixels, the second subpixel being selected based on the first position and the brightness threshold and being configured to emit light of a second color different from the first color at a second position within a proximity threshold of the first position within the color image; and using the second subpixel to compensate for the first subpixel for a presentation of the color image.

In some aspects, the techniques described herein relate to a display system including: an array of subpixels configured to form a color image, the array including: a first subpixel that fails to meet a threshold brightness level and is configured to emit light of a first color at a first position within the color image, and a second subpixel that meets the threshold brightness level and is configured to emit light of a second color different from the first color at a second position within a proximity threshold of the first position within the color image; and a display controller configured to cause the array of subpixels to present the color image using the second subpixel to compensate for the first subpixel.

Various additional implementations are explicitly described herein or may follow from principles described below. It will be understood that each of the examples mentioned above and described below may be implemented in different types of implementations. For example, the various display systems described herein could each be implemented in a variety of different types of devices, methods described herein could be implemented by instructions stored in a non-transitory computer-readable medium, a non-transitory computer-readable medium storing such instructions could be implemented in a display system, or the like.

The details of these and other implementations are set forth in the accompanying drawings and the description below. Other features will also be made apparent from the following description, drawings, and claims.

### BRIEF DESCRIPTION OF THE DRAWINGS

FIG. 1 shows an illustrative implementation of system for configurable subpixel defect compensation in accordance with principles described herein.

FIG. 2 shows a block diagram of an illustrative system for configurable subpixel defect compensation in accordance with principles described herein.

FIGS. 3A-3B show flowcharts of illustrative methods for configurable subpixel defect compensation in accordance with principles described herein.

FIGS. 4A-4B show flowcharts of additional illustrative methods for configurable subpixel defect compensation in accordance with principles described herein.

FIG. 5 shows an illustrative subpixel lattice in accordance with principles described herein.

FIGS. 6A-6C show aspects of illustrative recruitment geometries in accordance with principles described herein.

FIGS. 7A-7C show aspects of an illustrative multi-stage algorithm for subpixel defect compensation in accordance with principles described herein.

FIG. 8 shows aspects of illustrative parameters used in subpixel defect compensation in accordance with principles described herein.

FIGS. 9A-9F show illustrative operational modes for configurable subpixel defect compensation in accordance with principles described herein.

FIG. 10 shows an illustrative computing system in accordance with principles described herein.

FIG. 11 shows certain aspects of an illustrative implementation of heterochromatic subpixel defect compensation in accordance with principles described herein.

FIG. 12 shows an illustrative method for heterochromatic subpixel defect compensation in accordance with principles described herein.

FIG. 13 shows a block diagram of an illustrative display system configured to perform heterochromatic subpixel defect compensation in accordance with principles described herein.

FIG. 14A shows how heterochromatic subpixel defect compensation may be performed for a first image display architecture in accordance with principles described herein.

FIG. 14B shows how heterochromatic subpixel defect compensation may be performed for a second image display architecture in accordance with principles described herein.

FIG. 14C shows how heterochromatic subpixel defect compensation may be performed for a third image display architecture in accordance with principles described herein.

FIG. 15A shows several example surrogate subpixels that may be selected to compensate for a deficient subpixel in a first illustrative array of subpixels in accordance with principles described herein.

FIG. 15B shows several example surrogate subpixels that may be selected to compensate for a deficient subpixel in a second illustrative array of subpixels in accordance with principles described herein.

FIG. 15C shows several example surrogate subpixels that may be selected to compensate for a deficient subpixel in a third illustrative array of subpixels in accordance with principles described herein.

FIG. 16A shows an illustrative arrangement for an array of subpixels configured to perform heterochromatic subpixel defect compensation using non-dedicated surrogate subpixels in accordance with principles described herein.

FIG. 16B shows another illustrative arrangement for an array of subpixels configured to perform heterochromatic subpixel defect compensation using non-dedicated surrogate subpixels in accordance with principles described herein.

FIG. 16C shows an illustrative arrangement for an array of subpixels configured to perform heterochromatic subpixel defect compensation using non-dedicated or dedicated surrogate subpixels in accordance with principles described herein.

FIG. 16D shows another illustrative arrangement for an array of subpixels configured to perform heterochromatic subpixel defect compensation using non-dedicated or dedicated surrogate subpixels in accordance with principles described herein.

FIG. 16E shows yet another illustrative arrangement for an array of subpixels configured to perform heterochromatic subpixel defect compensation using non-dedicated or dedicated surrogate subpixels in accordance with principles described herein.

FIG. 17 shows an illustrative device in which heterochromatic subpixel defect compensation may be employed in accordance with principles described herein.

### DETAILED DESCRIPTION

Modern digital displays are complex systems that rely on millions of individual light-emitting elements, or subpixels, to create a high-quality image. In an ideal display, every one of these subpixels would perform identically, resulting in a perfectly uniform picture. However, due to the inherent statistical variations in manufacturing processes, it is common for some subpixels to be “deficient” in the sense that they may not be capable of producing the full range of brightness required by the image content. Such subpixel deficiencies may lead to visible dark spots or non-uniformities that degrade the viewing experience and can reduce manufacturing yields. To address this challenge, systems and methods described herein provide for a configurable compensation framework. This framework intelligently recruits nearby, functioning (i.e., not deficient) subpixels to make up for the brightness shortfall of the subpixels that are deficient. One aspect of this framework is its ability to leverage principles of heterochromatic (i.e., other color) compensation, which involves using subpixels of a different color for compensation by taking advantage of the human visual system's limitations at high display resolutions. By using a combination of same-color and different-color neighbors in a way that is aware of both the capabilities of the recruited subpixels and the content of the image itself, this approach can effectively and efficiently “heal” (i.e., repair, compensate for, etc.) defects while minimizing visual artifacts like spatial or color distortion.

To provide a comprehensive disclosure, the following detailed description is organized to first describe the configurable compensation framework in detail, and to then provide a more foundational discussion of the principles of heterochromatic compensation.

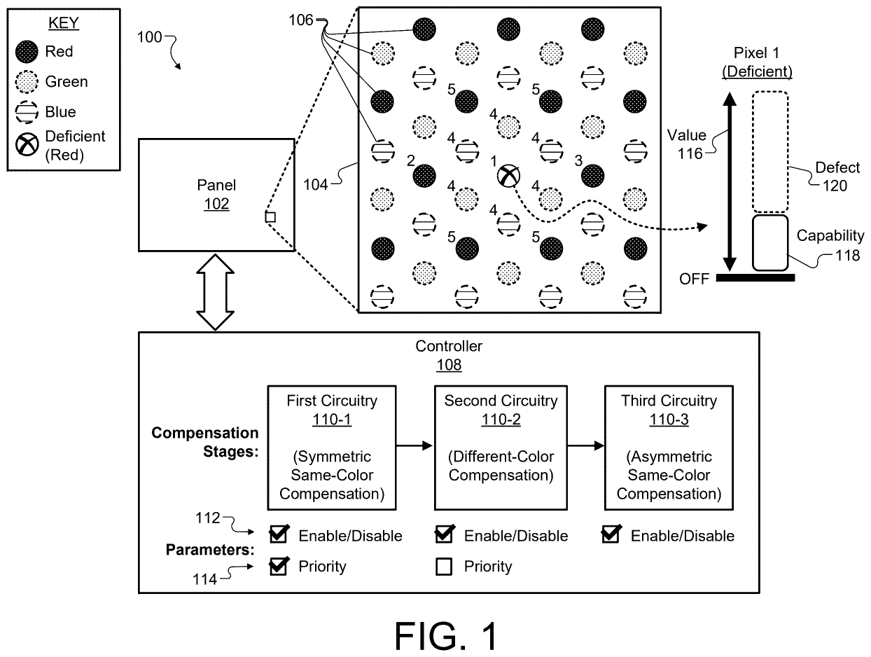

Accordingly, an introduction will now be provided that lays out the technical problems, conventional solutions, and the specific technical solutions and effects associated with the configurable compensation framework. Following this introduction, a variety of illustrative implementations, hardware architectures, and operational modes of this framework will be described in detail with reference to FIGS. 1-10.

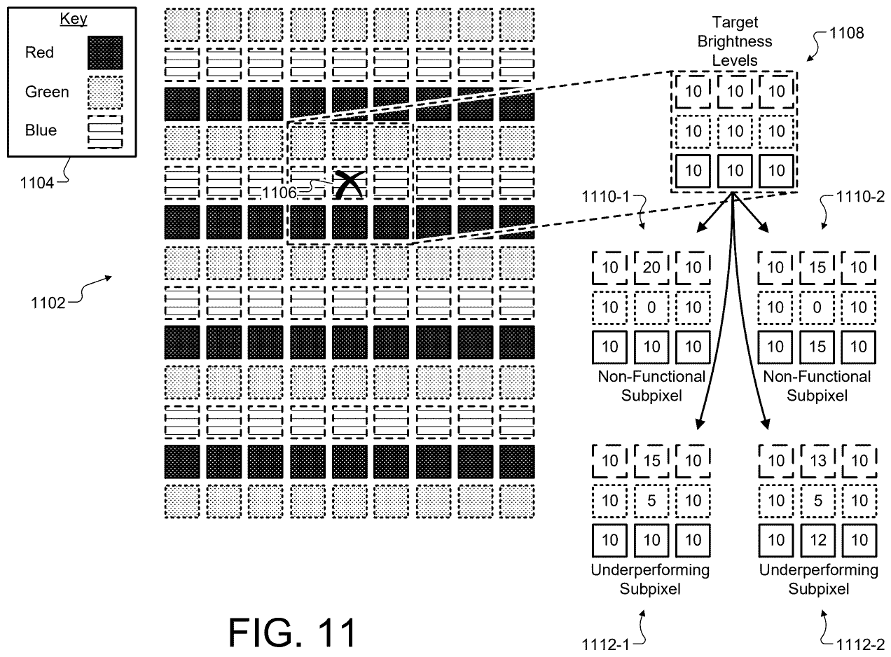

Following the detailed description of the configurable compensation framework, the specification will then turn to a more detailed discussion of the underlying principles of heterochromatic compensation. An introduction to this section will similarly lay out the foundational concepts, technical problems, and benefits associated with using different-colored subpixels for compensation. This discussion will then be illustrated with a variety of example architectures, subpixel layouts, and methods with reference to FIGS. 11-17.

It will be understood that the two sets of principles described herein are closely related and complementary. To facilitate a clear reading of the entire specification, certain terms that may be used differently in the two sections may be understood as being equivalent or related. For example, the term “defect” as used in the description of the configurable compensation framework may be understood as being identified when a subpixel is determined to be “failing to meet a brightness threshold,” or “failing to meet a threshold brightness level.” Similarly, a subpixel described as being “deficient” or “underperforming” may be understood as a subpixel having a “defect.”

Furthermore, a subpixel that is recruited to perform compensation may be generally referred to as a “surrogate subpixel.” In the context of the configurable compensation framework, these surrogate subpixels may be referred to with specific ordinals based on their role, such as a “second subpixel,” a “third subpixel,” or a “fourth subpixel.” The act of “using a surrogate subpixel to compensate” for a defect may involve, for example, “increasing a value” for that surrogate subpixel to make up for a performance shortfall of a defective subpixel. This and other terminology will be further defined and clarified by the detailed examples that follow.

With this context and terminology established, various principles and implementations relating to the configurable compensation framework will now be described in more detail.

Digital displays form the visual interface for a vast array of modern electronic devices, from large-format televisions to compact wearables (extended reality (XR) head-mounted display devices such as virtual reality (VR) headsets or augmented reality (AR) glasses). The fundamental building block of a digital image on such displays is the pixel, which represents the smallest controllable element of the picture. To produce a full spectrum of colors, each pixel may be composed of a set of smaller, individual light-emitting elements known as subpixels. In a common configuration, these subpixels are designed to emit primary colors of light, such as red, green, and blue (RGB). By precisely modulating the intensity of each red, green, and blue subpixel within a pixel, a display controller can cause the human eye to perceive a single, combined color for that pixel. Through the collective action of millions of such pixels, a detailed, full-color image may be rendered.

Among the various types of display technologies, modern emissive displays, such as those employing micro light-emitting diodes (microLEDs), have gained prominence for their superior image quality. Unlike traditional liquid-crystal displays (LCDs) that rely on a shared backlight filtered through a grid of pixels, each subpixel in an emissive display is its own independent light source. This per-pixel illumination capability allows for exceptional contrast ratios (including the ability to display true black by simply turning subpixels completely off) and vibrant colors. The compact size of individual microLEDs (e.g., measuring in the tens of microns) also allows for the creation of extremely high-resolution, high-pixel-density displays. This combination of high efficiency and small form factor makes microLED technology particularly well-suited for power-constrained applications requiring a bright, compact display, such as in wearable devices like augmented reality (AR) glasses. However, this technological advantage comes with significant manufacturing complexity. Fabricating a display panel may involve depositing and connecting thousands or millions of individual semiconductor light sources, a process that is subject to inherent statistical variations which can impact the performance of individual subpixels.

These statistical variations in the manufacturing process may give rise to a significant technical problem: the occurrence of subpixel deficiencies or “defects.” While some defects may result in a subpixel being completely non-functional, a more common and challenging issue is the presence of subpixels that are merely “deficient,” “dim,” or “underperforming.” Such subpixels are functional but have a maximum brightness capability that is lower than that of their neighbors and/or below the specification for the display. This performance shortfall in even a small percentage of subpixels can limit the maximum uniform brightness of the entire panel if the overall brightness were to be capped by the capability of the weakest emitters (to avoid visible non-uniformity). This technical problem therefore may negatively impact manufacturing yields, as panels with too many (and/or too severe of) defects may fail quality control tests.

The consequences of this technical problem are substantial, particularly for premium display applications. The cost associated with discarding panels that fail to meet stringent quality standards can be high, directly impacting the commercial viability of advanced display technologies like microLEDs. Furthermore, for applications demanding a pristine and immersive viewing experience, such as in high-end consumer electronics or augmented reality (AR) glasses, display uniformity is of paramount importance. A single dim subpixel can create a distracting dark spot that degrades the user's experience. Therefore, a robust method for addressing these subpixel defects (and thereby healing defective or underperforming subpixels) may help not only to improve manufacturing yields but also to enable the high levels of performance and visual quality desired for next-generation devices.

One solution to this technical problem is a method known as homochromatic, or same-color, compensation. In this approach, when a subpixel is identified as deficient, one or more neighboring subpixels of the same color are instructed to increase their brightness to make up for the shortfall. While this may be effective under certain circumstances, this solution may be less effective when implemented in an “open-loop” fashion, where the compensating subpixels are instructed to provide extra light without any awareness of their own individual capabilities or available headroom. This simplistic approach may create a new visual artifact, as one neighbor may have more headroom than another, leading to an unequal and asymmetric application of the compensating light. The result can be a visually distracting, distorted “halo” effect around the original defect, which may be as perceptible as the defect itself.

Another solution to this technical problem attempts to use heterochromatic, or other-color, compensation. This approach can offer a spatial advantage, since in many modern pixel layouts, the physically closest neighbor to a subpixel of one color may likely be a subpixel of a different color. By recruiting this closer neighbor, the compensating light may be emitted nearer to the location of the defect, which can reduce spatial artifacts. Additionally, because the subpixels are so close together, the human visual system may be unable to resolve the color difference between them and instead perceives only their combined brightness. However, this type of solution may introduce a significant drawback in the form of chromatic artifacts, particularly when reproducing very saturated colors (e.g., deep reds, vivid greens, etc.) or presenting other specific content. For example, if a green subpixel is used to compensate for a deficient red subpixel in an image that is meant to be pure red, the addition of green light will desaturate the intended color, possibly creating a noticeable yellow or orange spot. This color distortion makes basic heterochromatic compensation challenging for high-quality image reproduction.

Technical solutions described herein address the technical problems described above, along with the shortcomings of the more simplistic homochromatic and heterochromatic solutions mentioned above. As will be described, technical solutions disclosed herein may provide a sophisticated, configurable, multi-phase hardware algorithm. In essence, this algorithm may act as a flexible toolkit of compensation options that can be selectively enabled and prioritized to systematically mitigate subpixel defects while avoiding the creation of new visual artifacts such as those mentioned above. These technical solutions may be implemented in hardware for real-time, low-power operation, processing image data on a frame-by-frame basis to apply the most appropriate compensation strategy based on both the nature of the defect and the content of the image being displayed.

A first aspect of technical solutions described herein is a technique for providing capability-aware symmetric compensation. This technique provides a direct solution to the “halo” artifact problem described above to be associated with homochromatic compensation. Unlike the “open-loop” solution, this approach operates in a “closed-loop” manner. The algorithm is aware of the available brightness headroom of each of several recruited same-color subpixels that are distributed symmetrically around the defective subpixel. It then determines the maximum amount of compensation that can be added equally to each recruited neighbor without exceeding the capability of the weakest of the group (e.g., the weaker of the two in an example involving two recruited subpixels on either side of the deficient subpixel). By intelligently limiting the compensation in this initial phase to a symmetrical amount, the system actively avoids creating the distorted spatial artifacts that plague conventional methods.

A second aspect of technical solutions described herein is a technique for providing content-aware other-color compensation. This technique provides a direct solution to the color artifact problem described above to be associated with heterochromatic compensation. The system incorporates an intelligent mechanism that analyzes the image content in real time so as to intelligently activate or bypass the other-color compensation phase based on the present content. This mechanism may prevent the other-color compensation phase from being activated if the image content is a pure, saturated color. For example, the system will not turn on a green subpixel to heal a red defect if the image data for that pixel location calls only for red light. This content-aware control allows the system to realize the spatial benefits of using a physically closer other-color neighbor but only in image regions, such as mixed-color or white areas, where doing so will not introduce a perceptible color shift.

A third aspect of technical solutions described herein is a technique for providing residual asymmetric same-color compensation. This technique may be optionally engaged as a final “clean-up” phase to address any portion of the brightness deficit that remains after the symmetric same-color and/or content-aware other-color phases (described above as the first aspect and the second aspect) have been exhausted. In this phase, the system may optionally revisit the recruited same-color subpixels and uses any remaining, individual brightness headroom to make up the final portion of the defect. Because this phase is driven by the individual capabilities of each neighbor, it may result in an asymmetric application of the final compensating light. By serving as the final step in a prioritized sequence, this approach allows the system to achieve the target luminance even in challenging scenarios while ensuring that more visually ideal, symmetrical methods are always attempted first.

Technical solutions described herein may provide several advantageous technical effects. For example, by integrating these techniques into a configurable system, a number of synergistic may be achieved to address the technical problems described above to be associated with subpixel deficiencies.

One technical effect of this integrated technical solution may be a systematic and automatic mitigation of visual artifacts. Whereas a conventional solution might force a choice between a spatial artifact (an asymmetric halo) and a chromatic artifact (color desaturation), the present technical solution intelligently navigates these trade-offs. The prioritized, multi-phase structure may help ensure that the least intrusive healing methods are attempted first. The capability-aware and content-aware logic of the respective phases may also result in a visually clean output that effectively conceals subpixel defects without introducing distracting secondary artifacts, thereby producing a higher quality image.

Other technical effects provided by technical solutions described herein may include significant improvements in manufacturing yields and overall display performance. By effectively healing deficient subpixels, the system allows for the salvage of display panels that might otherwise be discarded, leading to lower manufacturing costs. Furthermore, the ability to distribute the compensation load across a greater number of subpixels, using advanced recruitment geometries described herein (e.g., a “line” pattern, a “half” pattern, or a “full” pattern) may reduce the brightness headroom required from any single compensating subpixel. This technical effect may help directly enable the display to be specified and sold with a higher maximum brightness level, as less of the subpixels'total capability needs to be reserved for potential compensation tasks.

Further benefits of technical solutions described herein relate to efficiency and practicality for commercial implementation. By recruiting the minimum number of subpixels necessary and by prioritizing spatially proximate subpixels, implementations described herein may help to preserve the display's sharpness. The architectural design of the hardware is also highly efficient, leveraging existing data structures (e.g., demura maps, etc.) to determine subpixel capability, thereby avoiding the need for additional dedicated memory. As will be described in more detail, efficient implementations of subpixel compensation in low-power raster pipelines makes the solution well-suited for power-constrained devices such as AR glasses, providing a powerful yet practical technical solution to a persistent technical problem in the field of digital displays.

Certain terminology used in this description may be understood in the following sense to aid in describing principles set forth herein. These definitions are provided as examples and are not intended to be limiting; they may be added to and/or further defined and clarified by the examples described herein.

As used herein, a “defect” of a subpixel will be understood to refer to a performance shortfall where a subpixel is unable to meet a target output level for an image (e.g., a particular frame). In other words, while a defect may refer to an incapacity of the subpixel (e.g., a complete failure to operate) in certain examples, in other examples, the defect may refer to a brightness deficit that is present only for certain content (e.g., a specific image or frame), such that for other content (e.g., other images or frames) the subpixel would not be considered to have a defect. In this sense, the defect may be understood to be a deficit of brightness, or an amount of light output that the subpixel is being asked to produce for the image but is unable to generate due to its limited capability.

As used herein, to “compensate” for a defect is to at least partially make up for the subpixel's shortfall or deficit by increasing the output of one or more other subpixels from what they would otherwise be requested to provide for a given image. The term “value” may be understood as the dynamic, per-image target brightness or output level assigned to a subpixel to render a specific image, whereas the term “capability” may be understood as the static, inherent maximum light output a subpixel is able to produce (often determined during a calibration process). The term “headroom” may be understood as the available capacity for additional output, representing the difference between a subpixel's capability and its current value (target value) for an image.

Certain structural and system elements may also be understood in a particular sense. For instance, as used herein, a “panel” may be understood as the physical display component that includes the array of subpixels. An “image” may be understood as the set of values that represent the visual content to be displayed by the panel for a given frame. A “subpixel” may be understood as an individual, controllable light-emitting element of a panel, typically configured to emit a single color of light such as red, green, or blue in implementations described herein. “Circuitry” may be understood broadly as any combination of hardware (e.g., logic gates, flip-flops or other memory elements, etc.) and firmware or software that may be configured to perform a specific function or set of operations. A “block of circuitry” or a “module” may similarly be understood to broadly refer to similar hardware, firmware, and/or software, including a combination of two or more of these. A circuit or process that is “enabled” may be understood as being in a functional state in which it is permitted to operate, often determined by how a configuration parameter is set.

Certain algorithmic and control parameters may also be understood in a particular sense. For example, as used herein, a “criterion” (or “selection criterion”) may be understood as a rule or condition used to select an operational mode or behavior of the system. For example, a selection criterion may be based on a value of a configuration parameter, such as a parameter being set to enable the first circuitry or the second circuitry. A “parameter” may be understood as a configurable stored value, such as a register setting, used to control the operation and/or selection of system circuitry (e.g., whether certain compensation circuitry is enabled). A “portion of a defect that is not yet compensated” may be understood as the amount of a defect (or deficit, deficiency, shortfall, etc.) that has not been handled by a prior compensation operation. This portion may include the entire initial defect (e.g., if compensation circuitry is the first to be applied to the subpixel defect) or a smaller, remaining amount of the defect (e.g., after one or more previous compensation operations have been applied). A “request value” may be understood as a target amount of compensation requested from one or more recruited subpixels. Depending on the type of compensation and other factors (such as what portion of the defect remains), such request values may be determined in various ways, as will be described. A “threshold” may be understood as a configurable value against which a subpixel's value may be compared to make a conditional operational decision. A “strength parameter” may be understood as a configurable scaling factor used to determine a request value (as will be further detailed below). The “ratio of luminance efficiency” may be understood as a conversion factor that accounts for the difference in perceived brightness between different colors of light.

Various implementations will now be described in more detail with reference to the figures. It will be understood that particular implementations described below are provided as non-limiting examples and may be applied in various situations. Additionally, it will be understood that other implementations not explicitly described herein may also fall within the scope of the claims set forth below. Methods and systems for configurable subpixel defect compensation in a display system may result in any or all of the beneficial technical effects mentioned above, as well as various additional and/or alternative technical effects and benefits that will be described and/or made apparent below.

FIG. 1 shows an illustrative implementation of a system 100 for configurable subpixel defect compensation in accordance with principles described herein. As shown, system 100 includes a panel 102 (e.g., a pixel panel) that, as shown by a zoomed-in view 104 of a small part of the panel, may include a plurality of subpixels 106 of various colors (e.g., Red, Green, and Blue, as shown by the KEY and the different fill patterns of the circles representing the subpixels). It will be understood that the reference numbers for individual subpixels 106 in zoomed-in view 104 are labeled for clarity according to the digit shown next to them in the figure. For example, subpixel 106-1 refers to the subpixel labeled with the digit ‘1’, subpixel 106-2 refers to the subpixel labeled with the digit ‘2’, and so on for the subpixels that are labeled with digits ‘3’, ‘4’, and ‘5’.

System 100 is also shown to include a controller 108 that is communicatively coupled to panel 102. As shown, this controller may include circuitry configured to perform various compensation techniques, including first circuitry 110-1 configured to provide “Symmetric Same-Color Compensation,” second circuitry 110-2 configured to provide “Different-Color Compensation,” and third circuitry 110-3 configured to provide “Asymmetric Same-Color Compensation.” Additionally, a selection module (not explicitly shown) may be included to facilitate the effect of setting parameters 112 to select which compensation circuitry 110-1, 110-2, and 110-3 to activate for a given compensation configuration and/or setting parameters 114 to select whether same-color or different-color compensation is to be prioritized. Each of these elements will now be described in more detail.

Panel 102 may be configured to display an image using a plurality of subpixels. For example, panel 102 may be an emissive display panel, such as a micro light-emitting diode (microLED) panel, or another type of display technology. To illustrate the arrangement of individual subpixels on panel 102, FIG. 1 shows zoomed-in view 104 of a portion of panel 102. Zoomed-in view 104 shows a plurality of individual subpixels 106 arranged in a lattice. In this illustrative example, and throughout the figures herein, the subpixels are coded by their line and fill patterns to represent subpixels configured to emit light of a first color (e.g., red, represented by a solid outline and a darkened pattern), a second color (e.g., green, represented by a dotted line and a dotted pattern), and a third color (e.g., blue, represented by a dashed line and horizontal stripe pattern). Accordingly, zoomed-in view 104 shows subpixels that are configured to emit light of the first color (e.g., red), the second color (e.g., green), and the third color (e.g., blue). One of the subpixels, such as subpixel 106-1, is identified as an example of a “first subpixel” (also referred to as a “deficient subpixel”) that may be determined to have a defect. As shown in the KEY, for example, this subpixel 106-1 is a deficient red subpixel that is marked with an ‘X’ symbol and, at least for certain content, may have a defect that is to be compensated by one or more neighboring subpixels. For instance, as will be described, system 100 may be configured to identify and compensate for the defect of subpixel 106-1 by recruiting neighboring subpixels such as certain subpixels 106-2, 106-3, 106-4, or 106-5, as will be described.

It will be understood that terms such as “first subpixel,” “second subpixel,” “third subpixel,” “fourth subpixel,” and “fifth subpixel” may be used as generic placeholders for subpixels performing particular roles in the compensation process. For example, a “first subpixel” may refer to a subpixel determined to have a defect, such as subpixel 106-1 in FIG. 1. The “first subpixel” may also be referred to as a “deficient subpixel” or “defective subpixel.” A “second subpixel” and a “third subpixel” may refer to two same-color subpixels flanking the first subpixel on the same scan line, such as subpixels 106-2 and 106-3. The “second subpixel” may also be referred to as a “first same-color surrogate subpixel” while the “third subpixel” may also be referred to as a “second same-color surrogate subpixel.” Same-color surrogate subpixels such as the second and third subpixels may also be referred to as “recruited same-color subpixels.” These may be referred to consistently as they can be acted upon in different compensation stages (e.g., a symmetric stage and a later asymmetric stage). A “fourth subpixel” may refer to a different-color subpixel used for compensation. For example, as shown in zoomed-in view 104, there may be several potential candidates for this role (e.g., any of the subpixels 106-4), and the term may refer to any one or more of these candidates. The “fourth subpixel” may also be referred to as a “different-color surrogate subpixel.” Different-color surrogate subpixels such as the fourth subpixel may also be referred to as “recruited different-color subpixels.” Similarly, a “fifth subpixel” may refer to a same-color subpixel that is used for compensation and is located on a different scan line from the first subpixel, such as any of subpixels 106-5 in FIG. 1. The “fifth subpixel” may also be referred to as a “different-line same-color surrogate subpixel” or a “recruited different-line same-color subpixel.”

System 100 is configured to determine a defect of a subpixel by comparing the subpixel's target output for a given image with its inherent performance capability. For example, to render a particular image, a first subpixel (e.g., subpixel 106-1) may be assigned a specific value 116. This value 116 will be understood to represent the target output level, such as a target brightness, for the first subpixel in the image. However, since the first subpixel also has an inherent capability 118 (representing its maximum achievable output level) circuitry within controller 108 may be configured to determine a defect 120 of the first subpixel by determining a difference between the value 116 for the first subpixel in the image and the capability 118 of the first subpixel. This defect 120 may also be referred to as a deficit of the subpixel for that image, or by other terms such as a performance shortfall, an underperformance, or the like.

Capability 118 may be determined during a calibration process, such as a factory calibration of panel 102, and may be stored in a memory that is communicatively coupled to controller 108 (not explicitly shown in FIG. 1). This calibration process, sometimes referred to as “demura” or display mura correction, is a technique used to correct for inherent, low-frequency variations in brightness and color across a display panel. During factory calibration, each of the many subpixels on panel 102 may be individually measured using a sensitive optical system to characterize its unique performance. The resulting performance data, which includes the maximum achievable brightness for each subpixel, may be compiled into a comprehensive map. This map, which may be referred to as a demura map or a uniformity map, may then be stored in the memory. In a conventional demura process, the controller uses this map to apply per-subpixel correction factors to the image data to make the display appear perfectly uniform to a viewer. A significant architectural advantage of implementations described herein is that the same, pre-existing demura map may be repurposed to provide the capability data for the defect compensation system (e.g., including capability 118 of subpixel 106-1). By leveraging this map, controller 108 can determine the capability of any subpixel in real time without requiring additional, costly memory dedicated to storing a separate defect list or capability database. For example, capability 118 of the first subpixel may be determined based on the performance data for the first subpixel that is stored in the map.

Controller 108 may be implemented using backplane logic for the display panel, one or more processors, application-specific integrated circuits (ASICs), or other hardware logic. As such, controller 108 may be configured to provide image data to panel 102 to facilitate compensation operations described herein.

As shown, controller 108 may include circuitry configured to perform the various compensation operations of system 100. For example, FIG. 1 shows that controller 108 may include circuitry 110-1, second circuitry 110-2, and third circuitry 110-3. In some implementations, these may represent distinct hardware blocks, while in others they may represent different operational modes or functions of a unified processing pipeline. Certain circuitry within controller 108 (e.g., separate from or integrated with circuitry 110-1, 110-2, and/or 110-3) may be configured to determine, with respect to a given image, a defect of a first subpixel configured to emit light of a first color. For instance, a defect of subpixel 106-1, which in this example is shown to be a red subpixel, may be determined based on the value 116 for the first subpixel in the image.

First circuitry 110-1 may be configured to at least partially compensate for the defect using at least a second subpixel and a third subpixel that are also configured to emit light of the first color. For example, if subpixel 106-1 is a defective red subpixel, first circuitry 110-1 may recruit neighboring red subpixels on the same scan line (i.e., subpixels 106-2 and 106-3 on either side of subpixel 106-1) to provide additional red light to compensate for defect 120. Second circuitry 110-2 may be configured to at least partially compensate for the defect using a fourth subpixel configured to emit light of a second color different from the first color (or multiple such subpixels). For instance, second circuitry 110-2 may recruit one or more nearby green subpixels (e.g., subpixels 106-4) to provide additional luminance from a location even closer to subpixel 106-1 than the same-color subpixels 106-2 and 106-3. Third circuitry 110-3 may then provide additional same-color compensation functionalities (e.g., involving, again, subpixels 106-2 and 106-3), such as applying an asymmetric compensation to make up for any remaining portion of the defect.

A key aspect of system 100 is its configurability. To this end, the selection of which circuitry to enable may be based on a selection criterion that defines the desired operational behavior of the system. For example, this criterion may be implemented as one or more configuration parameters, such as one or more parameters 112 and 114, which may be values stored in hardware registers within controller 108. In some implementations, these parameter values may be static, meaning they are determined during a system design and tuning phase based on the specific characteristics of panel 102 and then programmed into the controller during manufacturing. This allows for a fixed, optimized healing behavior for the lifetime of the device. In some implementations the selection criterion could be software parameters, such as may be configured automatically (e.g., based on environmental conditions) or by a user (e.g., an advanced setting representing a user preference).

In the example of FIG. 1, the operation of the various compensation circuits may be controlled by criteria consisting of parameters 112 and 114. Accordingly, at least one of first circuitry 110-1 or second circuitry 110-2 may be enabled based on a criterion implemented by one or more of these parameters. This therefore may allow a system operator (e.g., a user) or an automated process to select from a toolkit of compensation strategies to best suit the characteristics of a particular panel, the strategies motivating a certain display device, the content of a particular image or set of images (e.g., application, etc.), or the like. Parameters 112 and 114 represent examples of how this configurability can be implemented. For instance, parameters 112 are shown to represent enable/disable flags for each of the blocks of circuitry 110-1, 110-2, and 110-3. By setting these parameters, a user can configure system 100 to operate in different modes, such as a “same-color only” mode (by disabling second circuitry 110-2) or an “other-color only” mode (by disabling first circuitry 110-1 and third circuitry 110-3). Parameters 114 may then control the priority or operational sequence of the circuitry blocks. For example, by prioritizing first circuitry 110-1, the system may be configured to first attempt a symmetric, same-color compensation, and only if a deficit remains, to then engage second circuitry 110-2. This configurability provides a flexible and powerful mechanism for managing trade-offs between different types of potential visual artifacts, such as spatial distortion and chromatic distortion.

Zoomed-in view 104 can also be used to illustrate various recruitment geometries that may be employed by controller 108. In one example, referred to as a “LINE” geometry, the second subpixel and the third subpixel are located on a same scan line of panel 102 as the first subpixel. As illustrated by the arrangement of subpixels 106, a second subpixel (e.g., subpixel 106-2) may be located on a first side of the first subpixel (subpixel 106-1), and a third subpixel (e.g., subpixel 106-3) may be located on a second side of the first subpixel, where the second side is opposite the first side. This configuration is efficient for a raster-based hardware implementation as it may minimize memory requirements as each line is scanned.

In other examples, first circuitry 110-1 may be configured to at least partially compensate for the defect using a larger set of subpixels. This set of subpixels may include the second subpixel (106-2) and the third subpixel (106-3), as well as a fifth subpixel located on a different scan line. For example, the first subpixel, the second subpixel, and the third subpixel may be located on a first scan line of the panel, and a fifth subpixel (e.g., either or both of subpixels 106-5) may be located on a second scan line of the panel, where the second scan line is subsequent to (i.e., scanned after) the first scan line. Such a geometry, which may be part of a “HALF” or “FULL” recruitment pattern, may distribute the compensation load over a greater number of subpixels, which can reduce the headroom required from any single compensating subpixel. Further, the circuitry may be configured to employ a hierarchical recruitment method. For example, first circuitry 110-1 may be configured to first compensate for a first subportion of a portion of the defect that is not yet compensated using a first subset of the set of subpixels (e.g., the same-line subpixels 106-2 and 106-3). Then, in response to determining that a second subportion of the portion remains after compensating for the first subportion, the circuitry may compensate for the second subportion using a second subset of the set of subpixels, such as a subset that includes one or more same-color subpixels (e.g., subpixels 106-5) from another scan line.

A “HALF” recruitment pattern may involve same-color subpixels on and subsequent to the scan line of the deficient subpixel 106-1 (e.g., subpixels 106-2, 106-3, and 106-5), as well as other-color subpixels from subsequent scan lines (e.g., subpixels 106-4, in this example). In contrast, a “FULL” recruitment pattern may involve not only these subpixels from the “HALF”, but also subpixels from a scan line preceding the scan line of the deficient subpixel. These HALF and FULL recruitment patterns may advantageously allow the compensation load to be distributed over a greater number of subpixels, thereby reducing the headroom required from any single compensating subpixel. However, there is a tradeoff for this benefit, as these larger recruitment patterns may also require additional memory (e.g., line buffers) to transfer compensation data between scan lines. For instance, a FULL pattern may recruit subpixels from both a preceding and a subsequent scan line.

As mentioned above, in some examples, the system may be configured to employ a hierarchical recruitment method. For example, first circuitry 110-1 may be configured to first compensate for a first subportion of a portion of the defect that is not yet compensated using a first subset of the set of subpixels (e.g., the same-line subpixels 106-2 and 106-3). Then, in response to determining that a second subportion of the portion remains after compensating for the first subportion, the circuitry may compensate for the second subportion using a second subset of the set of subpixels, such as a subset that includes one or more subpixels from subsequent and/or prior scan lines (e.g., any or all of the labeled subpixels 106-4 and/or 106-5).

In summary, FIG. 1 provides a conceptual overview of a system 100 for configurable subpixel defect compensation. The system includes a controller 108 configured to identify a defect 120 of a subpixel by comparing its target value 116 for an image against its inherent capability 118, which may be derived from a map of performance data. The controller includes a flexible toolkit of compensation circuits, including first circuitry 110-1 for symmetric same-color compensation, second circuitry 110-2 for different-color compensation, and third circuitry 110-3 for asymmetric same-color compensation. The operation of these circuits is controlled by a set of parameters 112 and 114, which allow for the selection of different operational modes and priorities. This configurability enables system 100 to intelligently manage the trade-offs between spatial and chromatic artifacts to produce a high-quality, uniform image. By applying these techniques, system 100 can effectively “heal” deficient subpixels, thereby improving manufacturing yields for display panels and enabling higher overall display brightness and performance. The system's ability to adapt its compensation strategy based on both its configuration and the capabilities of the individual subpixels provides a robust and practical solution to the technical challenges of subpixel performance variation in modern emissive displays.

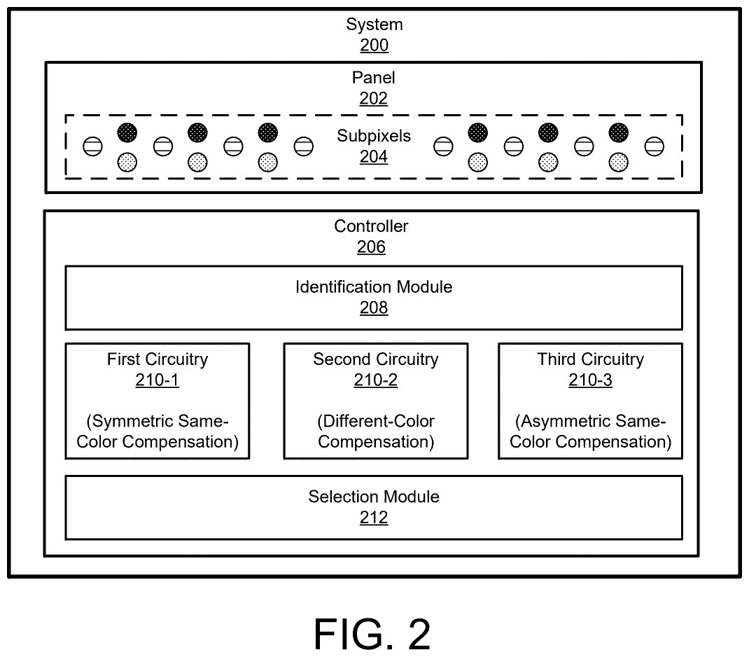

FIG. 2 shows a block diagram of an illustrative system 200 for configurable subpixel defect compensation in accordance with principles described herein. As shown, system 200 provides a more detailed hardware-level view of a particular implementation. System 200 includes a panel 202, which includes a plurality of subpixels 204 that use a same color-coding scheme as described above in relation to FIG. 1 (and as shown by the KEY in FIG. 1). System 200 further includes a controller 206 that is communicatively coupled to panel 202. Controller 206 may be configured to manage the rendering of image data on panel 202 and to perform the various defect identification and compensation operations that will be described.

Panel 202 and the plurality of subpixels 204 may be implemented using various display technologies. In some implementations, the plurality of subpixels 204 includes a plurality of micro light-emitting diodes (microLEDs), which may be well-suited for high-brightness and high-efficiency display applications. The plurality of subpixels 204 may be arranged on panel 202 in various geometric layouts. For example, as illustrated in zoomed-in view 104 of FIG. 1 (and as will be further illustrated below), the plurality of subpixels 204 may be arranged on panel 202 in a non-rectilinear lattice. For instance, a triangular or hexagonal lattice may implement the non-rectilinear lattice, since these may offer certain advantages in pixel density and/or perceived resolution. In other examples, a rectilinear lattice may be employed that arranges the different colors in a manner that similarly benefits from compensation solutions described herein.

Controller 206 may serve as the central processing and control component of system 200. Controller 206 may be implemented as dedicated circuitry on a backplane of the display system in some implementations, or as a dedicated integrated circuit (e.g., an ASIC, a part of a larger system-on-chip (SoC) that manages overall device operation, etc.) in other implementations. As illustrated in the block diagram, controller 206 may incorporate a number of specialized hardware blocks, modules, or circuits, configured to execute the various stages of the compensation algorithm (according to which certain circuits may be selected to be enabled). These circuits, including a block of first circuitry 210-1, a block of second circuitry 210-2, and a block of third circuitry 210-3, may together form an efficient hardware pipeline for real-time defect compensation. Additionally, as further shown, an identification module 208 may serve this pipeline by identifying a defective subpixel and determining the defect it has for a given image, while a selection module 212 may serve the pipeline by setting the various parameters of the circuits to enable desired compensation strategies and configurations.

Identification module 208 may be configured to perform the initial step of identifying subpixel defects. For instance, module 208 may be configured to determine a defect of a first subpixel of the plurality of subpixels 204. As described in connection with FIG. 1, this defect may be determined based on a target value for the first subpixel in the image by, for example, comparing the target value for the subpixel (as dictated by the image data for a given frame) with a stored value representing the subpixel's inherent performance capability. When the target value exceeds the known capability, identification module 208 may calculate the difference, or deficit, and may flag that subpixel as having a defect that is to be compensated.

First circuitry 210-1 and second circuitry 210-2 may then represent two of the primary compensation tools available to controller 206. First circuitry 210-1 may be configured to at least partially compensate for the defect using a second subpixel and a third subpixel configured to emit light of the first color (i.e., the same color as the defective subpixel). This circuitry may perform capability-aware symmetric compensation described herein. Second circuitry 210-2 may then be configured to at least partially compensate for the defect using a fourth subpixel configured to emit light of a second color different from the first color. This circuitry may perform content-aware other-color compensation described herein. In some implementations, at least one of first circuitry 210-1 or second circuitry 210-2 may be configured to determine a request value by scaling a portion of the defect by a strength parameter. The strength parameter may be based on a number of subpixels being used to compensate for the portion of the defect, allowing the compensation request to be appropriately distributed among the recruited subpixels.

In certain operational modes, the behavior of the compensation circuitry may be further refined based on known principles of human light perception. For example, in an implementation where the operation of second circuitry 210-2 is enabled by a parameter, the strength parameter used by second circuitry 210-2 may be further based on a ratio of luminance efficiency between the first color and the second color. This accounts for the fact that the human eye perceives different colors as having different levels of brightness for the same amount of radiant energy. For instance, if second circuitry 210-2 is using a green subpixel to compensate for a red subpixel defect, the strength parameter may incorporate a conversion factor to ensure that the amount of green light added produces the correct amount of perceived luminance to compensate for the missing red light.

In an implementation that incorporates third circuitry 210-3, this module may provide an additional compensation capability. Specifically, third circuitry 210-3 may be configured to perform a residual, asymmetric same-color compensation. This phase may be thought of as an optional a “clean-up” operation that may be used after first circuitry 210-1 and/or second circuitry 210-2 have performed their operations (as selected and prioritized by the parameters). For instance, if a portion of the original defect still remains uncompensated after circuitry 210-1 and/or 210-2 have performed their compensation operations, third circuitry 210-3 may be engaged to address any remaining portion of the defect by using any leftover headroom in the same-color neighbors (e.g., on the same line or using the HALF or FULL recruitment patterns), even if doing so results in an asymmetric application of the compensating light.

Selection module 212 may serve as the primary control hub for the compensation process, orchestrating the operation of the various compensation circuits. Selection module 212 may be configured to select an operation of at least one of the first circuitry or the second circuitry, wherein this selection is enabled based on a parameter. This parameter, which may be implemented by a set of values stored in one or more configuration registers, may dictate the operational mode of system 200. For example, by adjusting the parameter, selection module 212 may enable a “same-color first” mode where first circuitry 210-1 operates first, followed by second circuitry 210-2, and then third circuitry 210-3. Alternatively, a different parameter setting could configure an “other-color first” mode or a “same-color only” mode. This allows the behavior of controller 206 to be finely tuned to the specific characteristics of panel 202 or to the priorities of a particular application.

In summary, the hardware architecture of system 200 provides for a flexible and powerful defect compensation solution. The overall logical flow may be performed such that a given image can be displayed on panel 202. First, identification module 208 may analyze each of the subpixels 204 in to identify and characterize (i.e., determine) any defects that exist for the given image. When a defect is found, selection module 212, operating based on its stored configuration parameters, enables one or more of the compensation circuits (e.g., first circuitry 210-1, second circuitry 210-2, and third circuitry 210-3) in a specific, prioritized sequence. The selected circuits then perform their respective compensation operations in the priority order set by the selection module, recruiting healthy neighboring subpixels to make up for the brightness deficit of the defective subpixel. The specific compensation applied may be intelligently managed to minimize visual artifacts, for example by prioritizing symmetrical healing and by being aware of the image content. The resulting corrected values for the subpixels are then sent to the drivers for panel 202 to render the final, compensated image. This architecture provides an efficient, hardware-based solution to the technical problem of subpixel defects that is both highly effective and readily configurable.

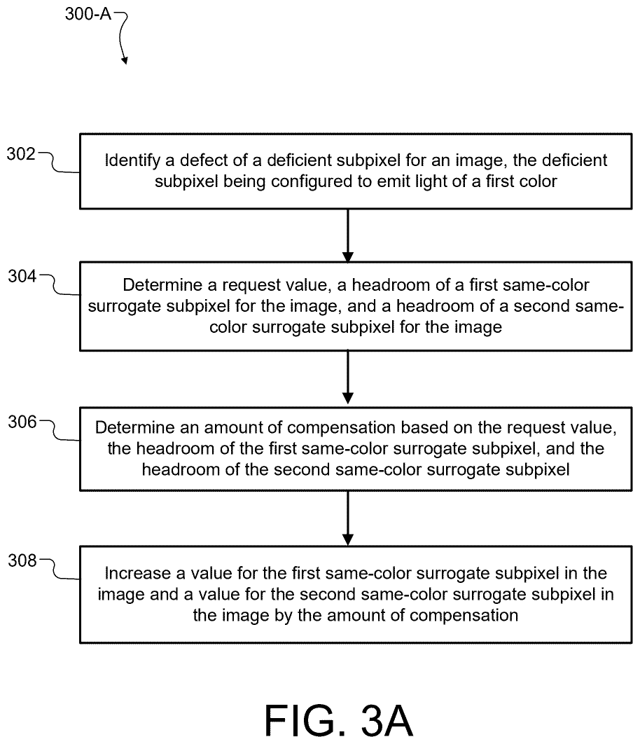

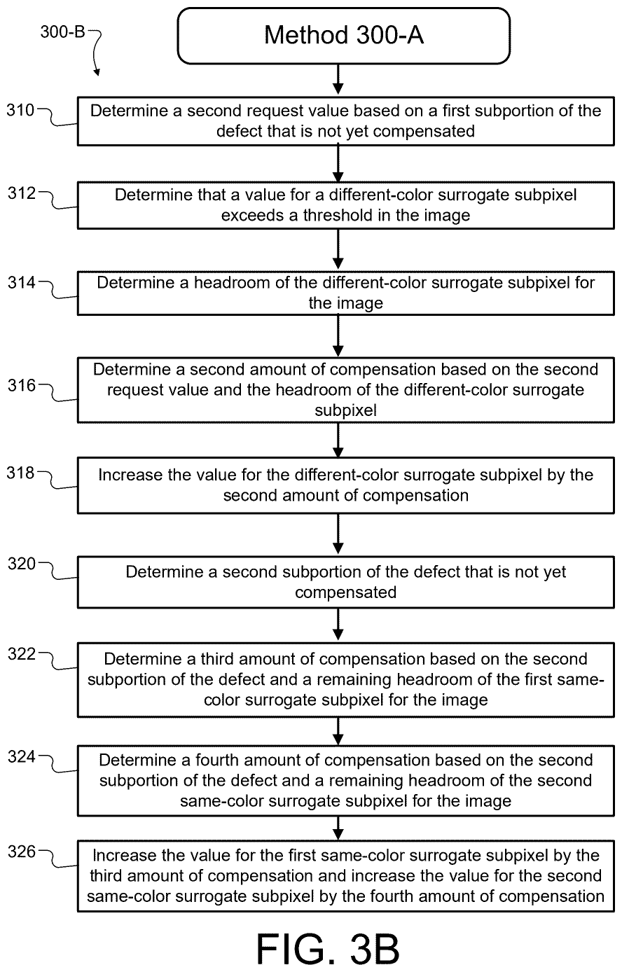

FIGS. 3A-3B show flowcharts of illustrative methods 300-A and 300-B, respectively, for configurable subpixel defect compensation in accordance with principles described herein. Methods 300-A and 300-B may be performed, for example, by a system described herein, such as by controller 108 of system 100 or by controller 206 of system 200. It will be understood that the operations shown in FIGS. 3A-3B are for example purposes and are not intended to be limiting. In other implementations, operations may be added to or omitted from the methods described herein. Additionally, operations may be reordered, performed serially or concurrently, combined into fewer operations, or separated into additional operations.

Method 300-A, as shown in FIG. 3A, illustrates an example of a method for capability-aware symmetric same-color compensation. This method may be performed by first circuitry 110-1 or first circuitry 210-1, as described above. The sequence shown in method 300-A represents a stage of compensation that prioritizes maintaining color purity (e.g., for use with saturated colors, etc.) and spatial symmetry.

At operation 302, method 300-A includes determining a defect of a deficient subpixel (also referred to herein as a “first subpixel”) configured to emit light of a first color. The defect is determined based on a value for the deficient subpixel in an image, which may involve comparing a target output value for the deficient subpixel against a known, stored capability of that subpixel. The result of this operation is a value representing the deficit, which may include a portion of the defect that is not yet compensated.

At operation 304, method 300-A proceeds by determining a request value, a headroom of a first same-color surrogate subpixel (also referred to herein as a “second subpixel”) for the image, and a headroom of a second same-color surrogate subpixel (also referred to herein as a “third subpixel”) for the image. The first and second same-color surrogate subpixels are configured to emit light of the first color, and the headroom for the first and second same-color surrogate subpixels may represent their available capacity to provide additional light beyond what their values already request for the image. The request value is based on the portion of the defect from operation 302. For example, if the first and second same-color surrogate subpixels are the only two subpixels recruited to help heal the deficient subpixel, the request value may be computed as the portion of the defect divided by two (since each of the two recruited subpixels may work together to compensate for that portion of the defect).

At operation 306, method 300-A includes determining an amount of compensation based on the request value, the headroom of the first same-color surrogate subpixel, and the headroom of the second same-color surrogate subpixel. For example, the amount of compensation determined at operation 306 may be whichever of these three values is lowest (e.g., a minimum of the request value, the headroom of the first same-color surrogate subpixel, and the headroom of the second same-color surrogate subpixel). In this way, operation 306 may be capability-aware and may prioritize symmetry by, for example, selecting the minimum value from among the request value and the headrooms of the two subpixels. This logic ensures the added compensation is equal for both recruited subpixels and does not exceed the capability of either one.

At operation 308, method 300-A may increase a value for the first same-color surrogate subpixel in the image and a value for the second same-color surrogate subpixel in the image by the amount of compensation determined in operation 306. By applying the same amount of compensation to both same-color subpixels, this stage performs a symmetrical compensation that at least partially addresses the defect while minimizing visual artifacts in the ways described herein.

Method 300-B, as shown in FIG. 3B, illustrates a continuation of the compensation process from method 300-A, showing how subsequent stages may continue contributing to the compensation in a “waterfall” manner if there is insufficient headroom for the symmetric same-color compensation to handle the entire defect. Thus, method 300-B represents a “same-color first” operational mode. The first stage of method 300-B (operations 310-318) details the content-aware other-color compensation process, while the second stage (operations 320-326) details the residual, asymmetric same-color compensation.

The first stage of method 300-B begins at operation 310, which includes determining a second request value. This second request value is based on a first subportion of the defect that is not yet compensated after the operations of method 300-A.

At operation 312, a determination is made that a value for a fourth subpixel in the image exceeds a threshold, where the fourth subpixel is configured to emit light of a second color different from the first color. This operation serves as a content-aware gate that permits other-color compensation to proceed only if the recruited subpixel is already sufficiently illuminated by the image content. In other words, the system may avoid turning on an other-color subpixel just for healing purposes in an image area where that color is otherwise absent (or relatively small). This is important for preventing chromatic artifacts. For example, if a green subpixel were used to compensate for a dim red subpixel in an image region meant to be pure, saturated red, the addition of green light where none was intended would desaturate the red, creating a perceptible and distracting yellow or orange spot. By ensuring the green subpixel is already contributing to the image's color mixture (e.g., in a white or mixed-color area), the additional brightness can be added to compensate for luminance without noticeably shifting the perceived color.

At operation 314, based on the determination that the value for the fourth subpixel exceeds the threshold, a headroom of the fourth subpixel for the image is determined. This headroom represents the available capacity of the other-color subpixel to provide additional luminance.

At operation 316, a second amount of compensation is determined based on the second request value and the headroom of the fourth subpixel. This determination may also, in some implementations, include limiting the amount of compensation such that the amount of compensation does not exceed at least one of a predetermined limit or a predetermined portion of the value for the deficient subpixel in the image. For example, even when the image content is desaturated enough to permit other-color healing, a configurable parameter may allow for capping the maximum contribution from the other-color subpixel. This provides an additional mechanism to control potential color shift, for example by ensuring that no more than a certain percentage of the final perceived luminance for the pixel comes from a different-colored source, which prevents the perceived color of the pixel from drifting too far from its intended hue.

At operation 318, the value for the fourth subpixel is increased by the second amount of compensation. This action at least partially compensates for the remaining portion of the defect using an other-color subpixel.

The second stage of method 300-B addresses any portion of the defect that may still remain uncompensated. At operation 320, this stage begins by determining a second subportion of the defect that is not yet compensated after the previous same-color and other-color compensation stages.

At operation 322, a third amount of compensation is determined. This amount is based on the second subportion of the defect and a remaining headroom of the first same-color surrogate subpixel for the image.

At operation 324, a fourth amount of compensation is determined based on the second subportion of the defect and a remaining headroom of the second same-color surrogate subpixel for the image. These amounts are determined individually, which may result in an asymmetric application of compensation.

Finally, at operation 326, the value for the first same-color surrogate subpixel is increased by the third amount of compensation and the value for the second same-color surrogate subpixel is increased by the fourth amount of compensation. This residual phase prioritizes achieving the target luminance even if there is some asymmetry in the contributions of the various recruited subpixels.

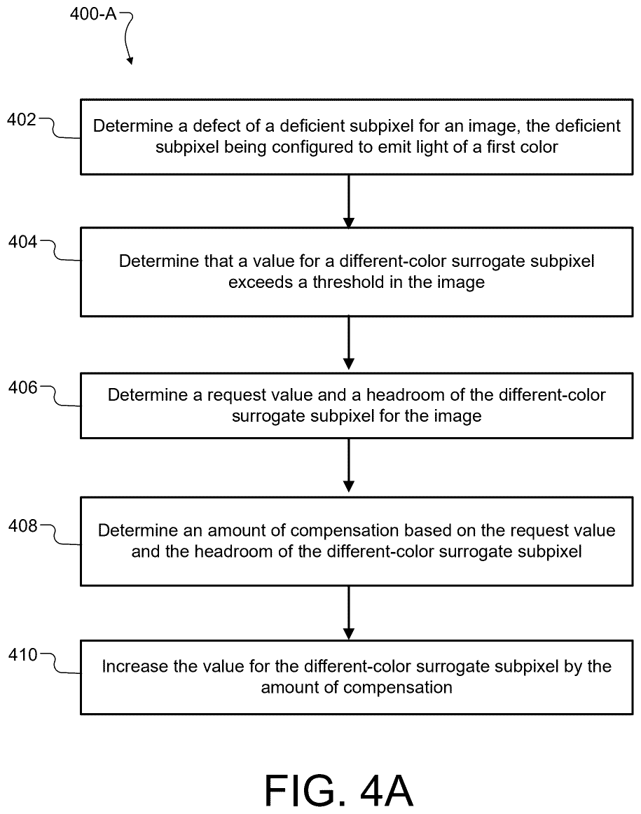

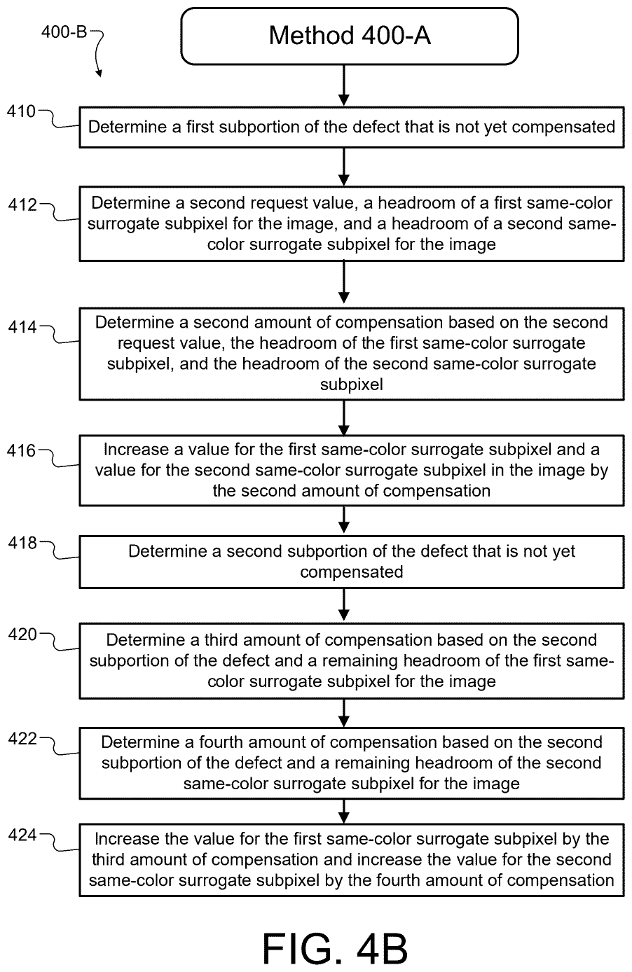

FIGS. 4A-4B show flowcharts of additional illustrative methods 400-A and 400-B, respectively, for configurable subpixel defect compensation. These figures illustrate an alternative operational mode that may be configured by setting appropriate parameters. Methods 400-A and 400-B may be performed, for example, by a system described herein, such as by controller 108 of system 100 or by controller 206 of system 200. It will be understood that the operations shown in FIGS. 4A-4B are for example purposes and are not intended to be limiting. In other implementations, operations may be added to or omitted from the methods described herein. Additionally, operations may be reordered, performed serially or concurrently, combined into fewer operations, or separated into additional operations.

Method 400-A, as shown in FIG. 4A, illustrates an example of a method for content-aware other-color compensation. This method may correspond to an “other-color-first” operational mode that can be configured by a user. This mode may be selected to prioritize the minimization of spatial artifacts by first attempting to use the physically closest neighboring subpixels for compensation, which may be of a different color for certain subpixel arrangements such as shown in FIG. 1.

At operation 402, method 400-A includes determining a defect of a deficient subpixel (also referred to herein as a “first subpixel”) configured to emit light of a first color. The defect is determined based on a value for the deficient subpixel in an image. When method 400-A is performed, there will be understood to be a portion of the defect that is not yet compensated.

At operation 404, method 400-A includes determining that a value for a fourth subpixel in the image exceeds a threshold. As described above, this threshold may be in place to prevent chromatic artifacts by ensuring the other-color compensation is only used when the subpixel is already contributing significantly to the image's color mixture. The fourth subpixel may be configured to emit light of a second color different from the first color. As described previously, this operation may function as a content-aware gate.

At operation 406, in response to the determining that the value for the fourth subpixel exceeds the threshold, a request value and a headroom of the fourth subpixel for the image are determined. The request value may be based on the portion of the defect determined at operation 402, such as by being scaled by a strength parameter in the ways described herein. The headroom of the fourth subpixel may represent its available capacity to provide additional light beyond its current value for the image.

At operation 408, an amount of compensation is determined based on the request value and the headroom of the fourth subpixel. This determination may also, in some implementations, include limiting the amount of compensation, as described previously, to prevent excessive color shift.

At operation 410, method 400-A includes increasing the value for the fourth subpixel by the amount of compensation, thereby at least partially compensating for the defect by leveraging the available capacity of at least one nearby, different-colored subpixel.

Method 400-B, as shown in FIG. 4B, illustrates a continuation of the compensation process from method 400-A, showing illustrative subsequent stages to which the algorithm may “waterfall” in this “other-color-first” sequence. The first stage of method 400-B (operations 410-416) details the capability-aware symmetric same-color compensation process, while the second stage (operations 418-424) details the residual, asymmetric same-color compensation.

The first stage of method 400-B begins at operation 410, which includes determining a first subportion of the defect that is not yet compensated after the increasing of the value for the fourth subpixel in method 400-A.

At operation 412, a second request value, a headroom of a first same-color surrogate subpixel (also referred to as a “second subpixel”) for the image, and a headroom of a second same-color surrogate subpixel (also referred to as a “third subpixel”) for the image are determined. The first and second same-color surrogate subpixels are configured to emit light of the first color, as indicated above. The second request value may be based on the first subportion of the defect. For example, in one possible implementation, the second request value may be determined by scaling the first subportion of the defect. As one example, since the first subportion of the defect is to be at least partially compensated for by two recruited subpixels (e.g., the first same-color surrogate subpixel and the second same-color surrogate subpixel), this scaling may involve dividing the first subportion of the defect by two.

At operation 414, a second amount of compensation is determined based on the second request value, the headroom of the first same-color surrogate subpixel, and the headroom of the second same-color surrogate subpixel. This determination may use the minimum-function logic described previously to ensure symmetry.

At operation 416, a value for the first same-color surrogate subpixel in the image and a value for the second same-color surrogate subpixel in the image are increased by the second amount of compensation. By adding the same, second amount of compensation to both the first same-color surrogate subpixel and the second same-color surrogate subpixel, operation 416 ensures that the compensation is symmetric to avoid introducing spatial artifacts.

The second stage of method 400-B may be used to address any remaining deficit after the other operations have been performed. At operation 418, this stage determines a second subportion of the defect that is not yet compensated after the operations of method 400-A and the first stage of method 400-B.

At operation 420, a third amount of compensation is determined based on the second subportion of the defect and a remaining headroom of the first same-color surrogate subpixel for the image. This amount may be calculated to use some or all of the available capacity of the first same-color surrogate subpixel.

At operation 422, a fourth amount of compensation is determined based on the second subportion of the defect and a remaining headroom of the second same-color surrogate subpixel for the image. These individually determined amounts allow for an asymmetric application of the remaining compensation to the two same-color subpixels.

At operation 424, the value for the first same-color surrogate subpixel is increased by the third amount of compensation and the value for the second same-color surrogate subpixel is increased by the fourth amount of compensation, completing this final “clean-up” phase.

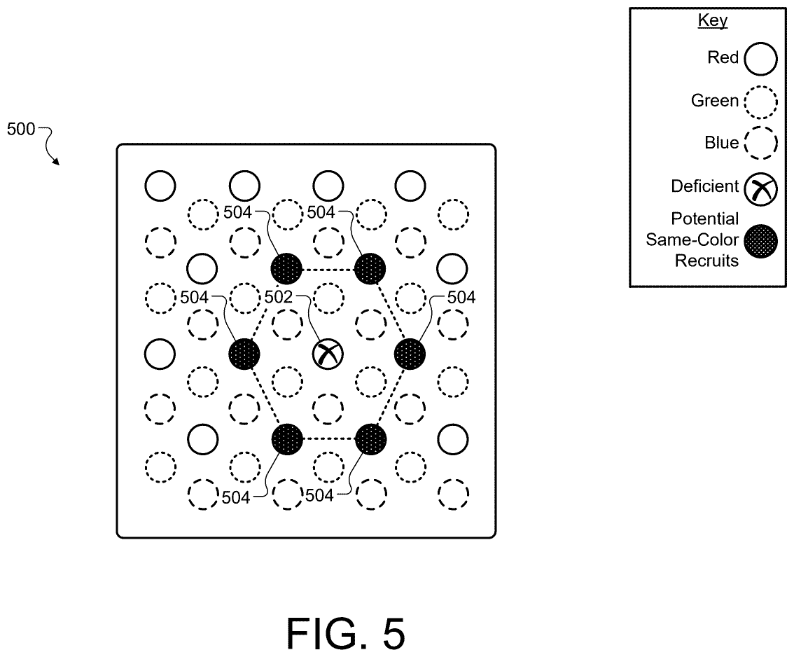

Having described operational modes and methods in relation to FIGS. 1-4B, a more detailed examination of certain aspects of the systems and algorithms will now be provided with reference to FIGS. 5-9F. The following figures will further illustrate various hardware configurations, subpixel arrangements, and parameter interactions that may be employed in different implementations of the configurable subpixel defect compensation techniques described herein.

FIG. 5 shows an illustrative subpixel lattice 500 in accordance with principles described herein. The arrangement of subpixels shown in FIG. 5 provides a visual example of a physical layout that may be used for a panel, such as panel 202 described above. In some implementations, the plurality of subpixels are arranged on the panel in a non-rectilinear lattice. FIG. 5 illustrates an example of such a layout, where repeating triangular units of red, green, and blue subpixels are arranged to form a hexagonal lattice. The plurality of subpixels may include a plurality of micro light-emitting diodes (microLEDs), and this hexagonal layout is one example of an arrangement for such emitters on a display panel.

As indicated by the KEY shown in FIG. 5, and consistent with other figures herein, red subpixels are indicated by a solid outline, green subpixels by a dotted outline, and blue subpixels by a dashed outline. To highlight the compensation concept in this particular figure, the subpixels identified as potential same-color recruits are shown with a fill pattern (e.g., a darkened pattern for red), while other subpixels are shown without a fill pattern for clarity.

FIG. 5 further illustrates the identification of a defective subpixel 502 and its potential compensating neighbors. A central red subpixel is shown as defective subpixel 502, indicated by an ‘X’ symbol. In this illustrative hexagonal layout, the figure also identifies a set of potential same-color recruits 504. Specifically, the six nearest emitters of the same color (e.g., six red subpixels that form a hexagonal ring around defective subpixel 502) are identified as potential same-color recruits 504. While this figure highlights same-color recruitment, it will be understood that other subpixels within this hexagonal arrangement, such as the proximate green and blue subpixels, may also be recruited for compensation, as will be described.

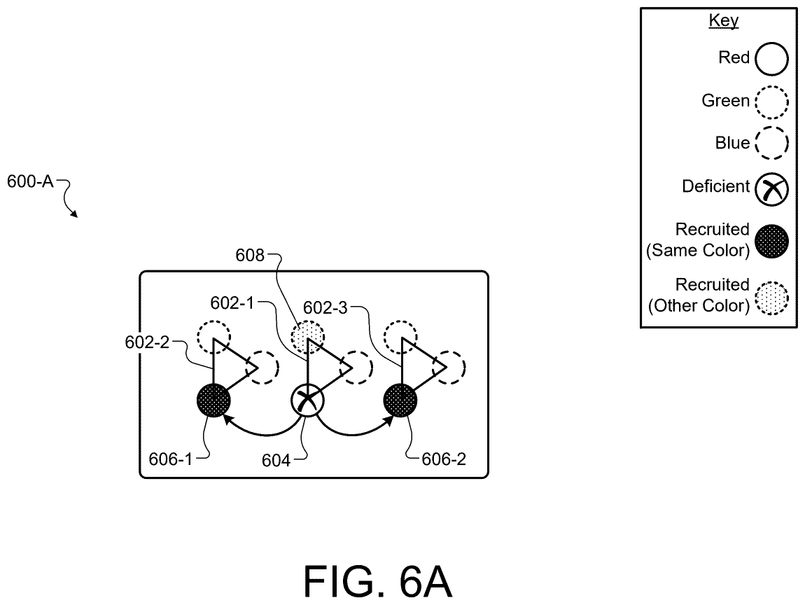

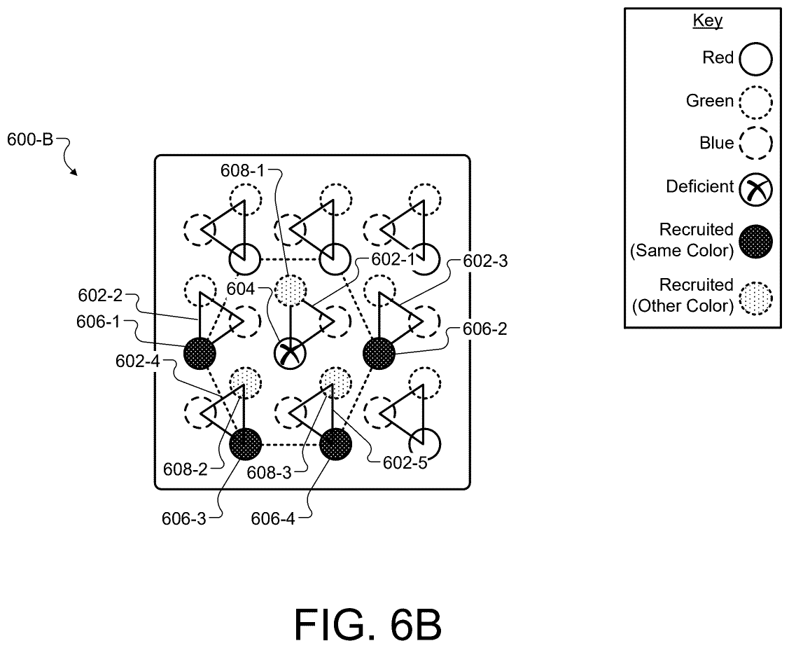

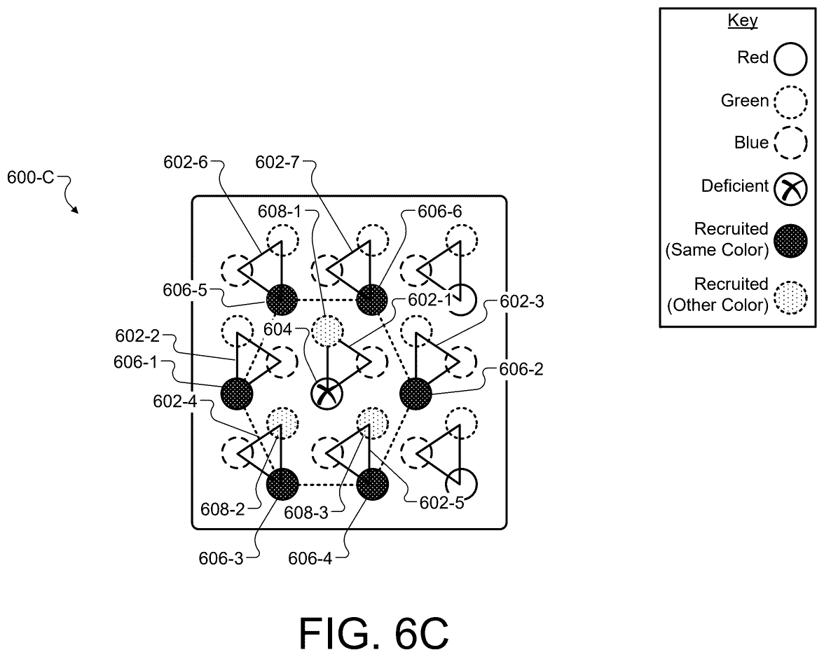

FIGS. 6A-6C show aspects of illustrative recruitment geometries 600-A, 600-B, and 600-C, respectively, in accordance with principles described herein. These figures illustrate different strategies that may be employed by a controller, such as controller 108 or controller 206, to select a set of subpixels for compensating for a defect. As indicated by the KEY, and consistent with other figures herein, the color of a subpixel is indicated by its outline (solid for red, dotted for green, and dashed for blue). In these figures, similar to FIG. 5, the role of each subpixel in the compensation process may be indicated by its fill pattern (or lack thereof). For example, a defective subpixel is marked with an ‘X’, and a recruited surrogate subpixel is drawn with a fill pattern, while non-recruited subpixels remain empty. More specifically, since the defective subpixel is red in this example, recruited same-color subpixels are shown with a darkened fill pattern while recruited other-color subpixels (green subpixels, in this example) are shown with a dotted fill pattern. The choice of which recruitment geometry to use involves various technical trade-offs between hardware implementation complexity, memory requirements, and compensation performance. Each of FIGS. 6A-6C will now be described in more detail.

FIG. 6A shows a “LINE” recruitment geometry 600-A. In this illustrative configuration, three pixels 602-1, 602-2, and 602-3 are shown, each comprising a triangular arrangement of one red, one green, and one blue subpixel. The red subpixel of the central pixel 602-1 is identified as a defective subpixel 604. To compensate for this defect, a minimal set of neighboring subpixels is recruited. This set includes two same-color subpixels, recruited same-color subpixel 606-1 and recruited same-color subpixel 606-2, which are the red subpixels of adjacent pixels 602-2 and 602-3, respectively. The set also includes an other-color subpixel, recruited other-color subpixel 608, which is the green subpixel of the same central pixel 602-1. In this “LINE” geometry, all recruited subpixels are located on the same horizontal scan line of the panel. As shown, recruited same-color subpixel 606-1 (the second subpixel) may be located on a first side of defective subpixel 604 (the first subpixel), and recruited same-color subpixel 606-2 (the third subpixel) may be located on a second side, opposite the first side.

The “LINE” geometry 600-A offers a highly efficient hardware implementation. Because it only recruits subpixels from the current scan line being processed, it has minimal requirements for additional data storage, as no data needs to be buffered between scan lines. This reduces hardware cost and complexity. This efficiency may come at the cost of performance for certain images, however, since the full compensation load is distributed among a smaller number of subpixels. This can result in a large headroom requirement for the few recruited subpixels, which may limit the system's ability to heal significant defects in bright areas of an image.

FIG. 6B shows a “HALF” recruitment geometry 600-B. This configuration uses a larger “half-circle” set of subpixels to compensate for a defective subpixel 604 by recruiting subpixels from a subsequent scan line. The figure shows the same pixels 602-1, 602-2, and 602-3 from the first scan line, with defective subpixel 604 in pixel 602-1, recruited same-color subpixels 606-1 and 606-2 in pixels 602-2 and 602-3 respectively, and a recruited other-color subpixel 608-1 in pixel 602-1. In addition, two pixels from a subsequent scan line are introduced:
pixel 602-4 and pixel 602-5. Pixel 602-4 includes a recruited same-color subpixel 606-3 and a recruited other-color subpixel 608-2. Pixel 602-5 includes a recruited same-color subpixel 606-4 and a recruited other-color subpixel 608-3. This set of subpixels, including same-color subpixels from the first scan line (subpixels 606-1, 606-2) and at least one fifth subpixel (e.g., subpixels 606-3 and/or 606-4) from a second, subsequent scan line, demonstrates the “HALF” geometry.

By distributing the compensation load over a greater number of subpixels, the “HALF” geometry reduces the headroom requirement on any single recruited subpixel. This technical effect can enable a higher overall display brightness, as less of each subpixel's capability needs to be reserved for potential compensation tasks. This improved performance, however, requires additional hardware resources. To recruit subpixels from a subsequent scan line, the system may use additional memory, such as line buffers, to store data and transfer compensation requests from one scan line to the next.

FIG. 6C shows a “FULL” recruitment geometry 600-C. This configuration uses a complete “full-circle” of neighboring subpixels by recruiting from scan lines both preceding and subsequent to the scan line of the defective subpixel. This figure includes all the elements shown in FIG. 6B, and further introduces two pixels from a preceding scan line: pixel 602-6 and pixel 602-7. Pixel 602-6 includes a recruited same-color subpixel 606-5, and pixel 602-7 includes a recruited same-color subpixel 606-6. This complete set, including recruits from the same line, the subsequent line, and the preceding line, forms the “FULL” geometry.

The “FULL” recruitment geometry provides a further reduction in the per-pixel headroom requirement by distributing the compensation load over the largest possible area of surrounding subpixels. This may allow for the most effective compensation of significant defects in very bright image areas. The trade-off for this enhanced performance is a corresponding increase in hardware complexity and memory requirements, as the controller must be able to buffer and process data from multiple scan lines (both preceding and subsequent) simultaneously to orchestrate the compensation. This figure provides further visual support for the concept of recruiting a “set of subpixels” from multiple scan lines to perform a compensation operation.

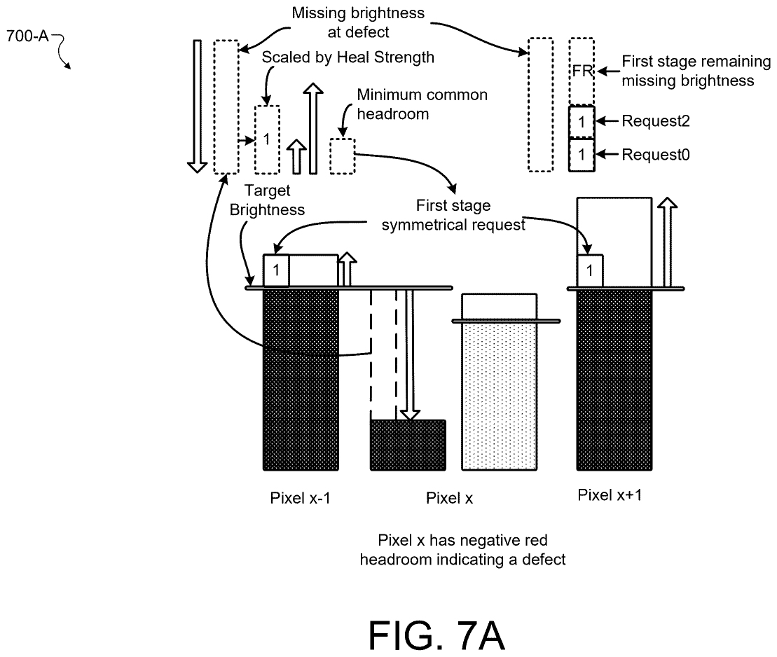

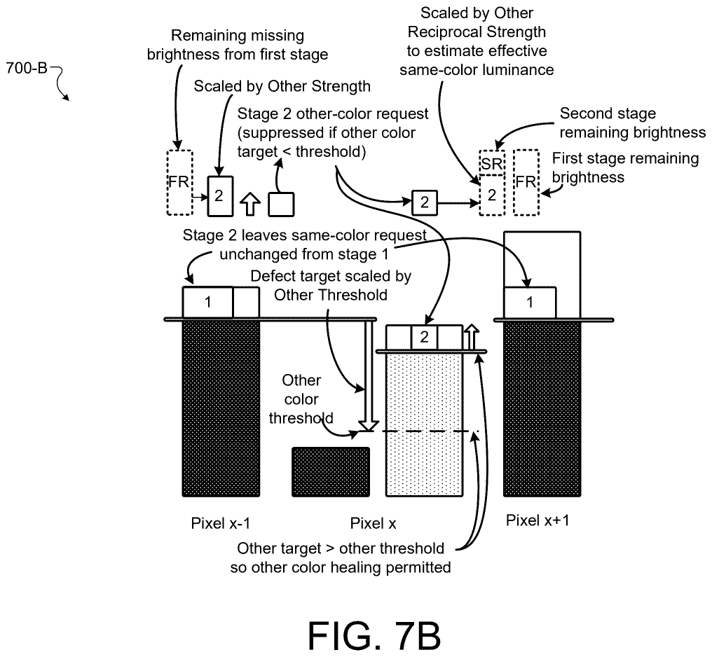

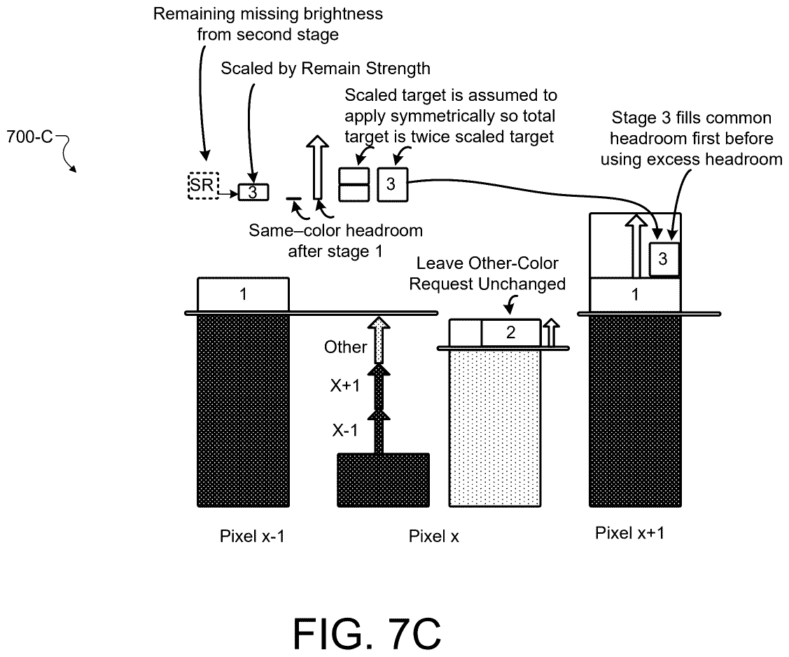

FIGS. 7A-7C show aspects of an illustrative multi-stage algorithm for subpixel defect compensation in accordance with principles described herein. These figures use a series of bar charts 700-A, 700-B, and 700-C to visually break down the detailed logic of the three primary compensation stages, which may be performed by the first circuitry, second circuitry, and third circuitry, respectively. The sequence shown across these figures illustrates a preferred “same-color first” waterfall sequence, where each stage operates on any brightness deficit that remains uncompensated by the previous stage. It will be understood that the fill patterns used in the bar charts are consistent with the key described previously; a darkened fill pattern indicates compensation from a same-color subpixel (red, in this example), and a dotted fill pattern indicates compensation from an other-color subpixel (green, in this example).

FIG. 7A shows aspects of the first stage of the illustrative algorithm, which performs capability-aware symmetric same-color healing. Bar chart 700-A illustrates a scenario with a defective red subpixel (“Pixel x”), which has a negative headroom, indicating that its capability is less than its target value for a given image. The “missing brightness” of this defective subpixel, which represents the defect or deficit for the present image, may be determined by calculating the difference between the subpixel's target brightness and its known capability.

The logic for determining the amount of compensation in this first stage is designed to prioritize symmetry. As shown in bar chart 700-A, the missing brightness of the defect is scaled by a “Heal Strength” parameter to determine a request value (e.g., one half of the deficit in this example). This request value is then compared to the available headroom of a second subpixel (“Pixel x−1”) and a headroom of a third subpixel (“Pixel x+1”), which are the two recruited same-color neighbors. To ensure symmetry, the amount of compensation is limited to the minimum common headroom of these two recruited subpixels. A value for the second subpixel in the image and a value for the third subpixel in the image are then increased by this same, symmetrical amount of compensation (the “First Stage symmetrical request” labeled “1”). Any portion of the deficit that is not compensated in this stage becomes the “remaining missing brightness” (“FR”) that is passed to the next stage.

FIG. 7B shows aspects of the second stage of the illustrative algorithm, which performs content-aware other-color healing. As shown in bar chart 700-B, this stage may recruit a subpixel of a different color, such as a green subpixel of the same pixel as the deficient red subpixel (“Pixel x”), to at least partially compensate for the remaining defect. This stage operates on the “remaining missing brightness” (“FR”) from the first stage. However, as shown, the missing brightness to be addressed by this stage may be scaled by a strength parameter, referred to as the “Other Strength.” This parameter may incorporate a conversion factor that accounts for the difference in luminance efficiency between the recruited green subpixel and the deficient red subpixel, ensuring that the perceived brightness of the added light accurately compensates for the missing light.

The operation of this stage may be conditional, employing a content-aware gate to prevent the introduction of chromatic artifacts. As illustrated in bar chart 700-B, a determination is made as to whether a value for the fourth subpixel (e.g., the other-color subpixel) in the image exceeds a threshold, which is referred to as the “Other Threshold.” Other-color healing is permitted to proceed only in response to a determination that the value for the fourth subpixel exceeds the threshold.

If permitted, a request value based on the remaining defect is used to determine an amount of compensation, which is limited by a headroom of the fourth subpixel. The value for the fourth subpixel is then increased by this amount (the “Stage 2 other-color request” labeled “2”). Any portion of the deficit that is not compensated in this stage becomes the “second stage remaining brightness” that is passed to the next stage. However, as shown, the remaining deficit is scaled by a second strength parameter, referred to as the “Other Reciprocal Strength.” This parameter may incorporate a conversion factor that accounts for the difference in luminance efficiency between the recruited green subpixel and the deficient red subpixel, ensuring that the perceived brightness of the added light accurately compensates for the missing light.

FIG. 7C shows aspects of the third stage of the illustrative algorithm, which performs residual, asymmetric same-color healing. This “clean-up” stage operates on any portion of the defect that may still remain after the completion of the first and second stages. Bar chart 700-C illustrates how this stage addresses a final, remaining deficit.

This final stage uses any remaining, individual headroom in the same-color subpixels to at least partially compensate for the remaining portion of the defect. As shown in bar chart 700-C, a first amount of compensation may be determined based on the remaining portion of the defect and a remaining headroom of the second subpixel (Pixel x−1), and a second amount of compensation may be determined based on the remaining portion of the defect and a remaining headroom of the third subpixel (Pixel x+1). Because these amounts are determined based on the individual remaining headrooms, they may be different, resulting in an asymmetric application of the final compensation. The overall sequence across FIGS. 7A-7C provides an example of a waterfall process where a first circuitry compensates for a first portion of a defect, a second circuitry compensates for a second portion of the defect, and a third circuitry compensates for a third portion of the defect.

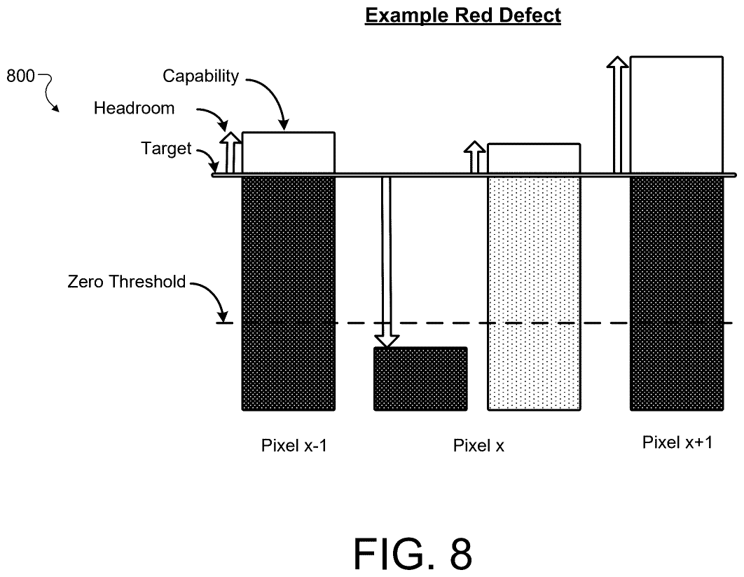

FIG. 8 shows aspects of illustrative parameters used in subpixel defect compensation in accordance with principles described herein. The bar chart 800 provides a visual key for certain terms and concepts used in the determination and compensation of subpixel defects. For example, the figure illustrates a Target brightness level for an image, which is the desired output for a subpixel, and a Capability, which is the maximum achievable output for that subpixel. As with FIGS. 7A-7C, the fill patterns used in bar chart 800 are consistent with the key described previously; a darkened fill pattern indicates compensation from a same-color subpixel (red, in this example), and a dotted fill pattern indicates compensation from an other-color subpixel (green, in this example).

As depicted in bar chart 800, these terms are used to define other key parameters. A subpixel's Headroom is the available capacity for additional output, representing the difference between its Capability and its current value, which for a healthy subpixel is at the Target level. For a defective subpixel, a defect or deficit represents a performance shortfall, corresponding to the difference between the Target value for the subpixel in the image and the subpixel's Capability. This visual representation provides context for the process of determining a defect, as the circuitry may determine the defect by determining a difference between the value for a subpixel in the image and the capability of that subpixel.

Bar chart 800 also illustrates a “Zero Threshold” (Z Threshold), which is a configurable level used to classify a subpixel's target value as being effectively “on” or “off” for a given image. This classification can be used to control spatial artifacts at the boundaries of high-contrast image content. For example, a “Zero Factor” parameter may be used to scale down the amount of compensation requested from a recruited subpixel that is classified as “off” based on the Zero Threshold. This scaling serves to “feather” the healing effect, preventing the creation of a harsh or distracting point of light where a previously unlit subpixel is turned on to compensate for a neighbor, thereby improving the visual quality of the compensated image.

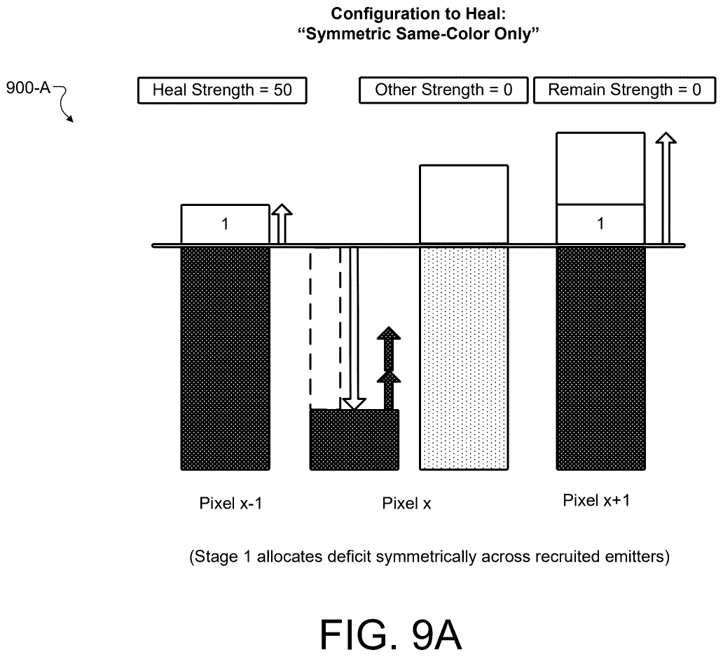

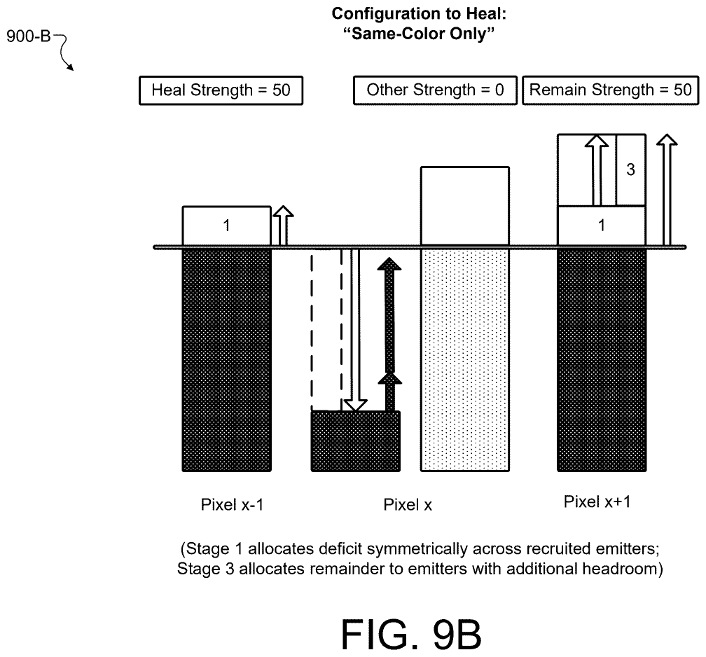

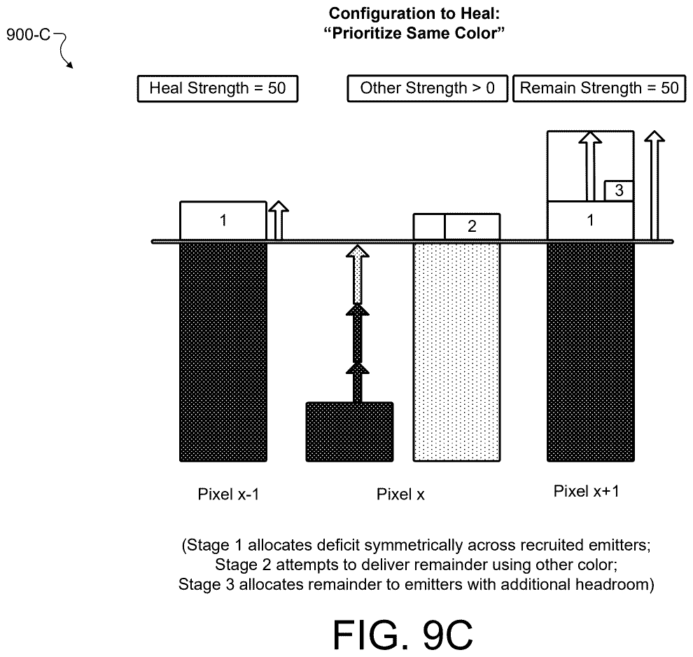

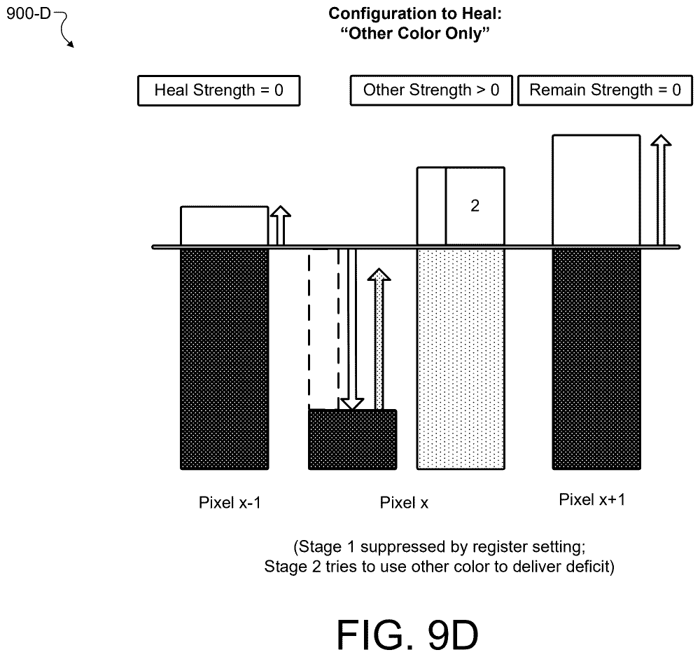

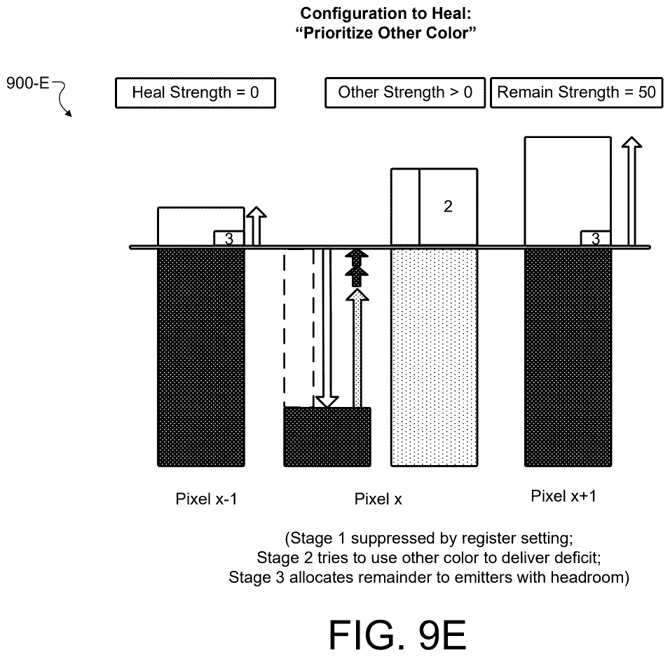

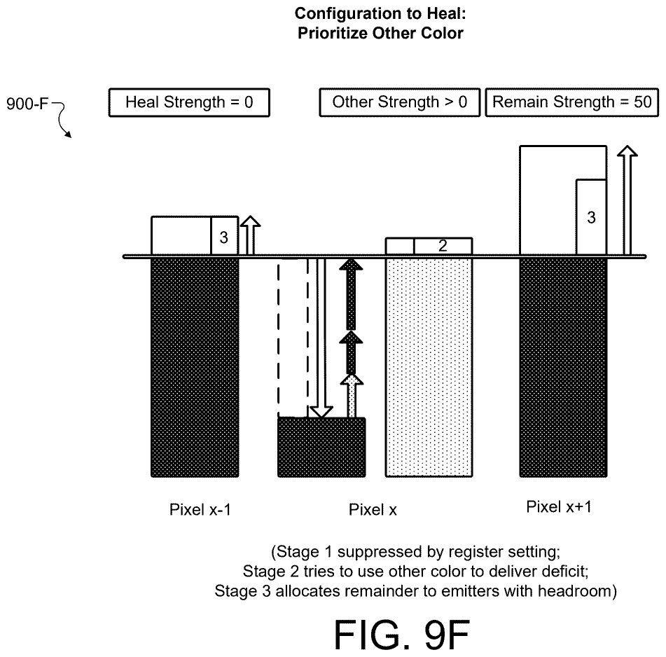

FIGS. 9A-9F show aspects of illustrative operational modes 900-A through 900-F for configurable subpixel defect compensation in accordance with principles described herein. These figures demonstrate how adjusting one or more configuration parameters, such as the various strength parameters, may allow a controller to selectively enable, disable, and prioritize the different compensation stages of the algorithm. The ability for a parameter to enable at least one of the first circuitry or the second circuitry provides a flexible toolkit of compensation strategies. The selection module of a controller may use these parameters to orchestrate the operation of the compensation circuitry. Once again, as with FIGS. 7A-8, the fill patterns used in FIGS. 9A-9F are consistent with the key described previously; a darkened fill pattern indicates compensation from a same-color subpixel (red, in these examples), and a dotted fill pattern indicates compensation from an other-color subpixel (green, in these examples).

FIG. 9A illustrates a “Symmetric Same Color Only” mode 900-A. More specifically, as FIG. 9A indicates, “Stage 1 allocates deficit symmetrically across recruited emitters.” In this operational mode, the parameters are set such that Heal Strength is greater than zero, while Other Strength and Remain Strength are set to zero. As depicted in the bar chart, this configuration enables only the first stage of compensation. The deficit is partially and symmetrically allocated across the two recruited same-color subpixels, limited by their minimum common headroom. Any remaining deficit would then be left uncompensated in this example.

FIG. 9B illustrates a “Same Color Only” mode 900-B. More specifically, as FIG. 9B indicates, “Stage 1 allocates deficit symmetrically across recruited emitters,” while “Stage 3 allocates remainder to emitters with additional headroom.” In this mode, the Heal Strength and Remain Strength parameters are set to be greater than zero, while the Other Strength parameter is set to zero, disabling the second, other-color compensation stage. As a result, the first stage allocates the deficit symmetrically across the recruited emitters. Then, the third stage is engaged to allocate any remaining deficit to the same-color emitters based on their individual remaining headroom, which may result in an asymmetric application of compensation (e.g., more compensation from Pixel x+1 (“1”+“3”) than from Pixel x−1 (“1” only), in this example).

FIG. 9C illustrates a “Prioritize Same Color” mode 900-C. More specifically, as FIG. 9C indicates, “Stage 1 allocates deficit symmetrically across recruited emitters; Stage 2 attempts to deliver remainder using other color,” and “Stage 3 allocates remainder to emitters with additional headroom.” In this mode, all three strength parameters (Heal Strength, Other Strength, and Remain Strength) are set to be greater than zero. This configuration enables the full, three-stage waterfall process. As depicted, the first stage performs a symmetric, same-color compensation. The second stage then uses an other-color subpixel to compensate for a portion of the remainder. Finally, the third stage allocates any final remaining deficit to the same-color emitters based on their available headroom.

FIG. 9D illustrates an “Other Color Only” mode 900-D. More specifically, as FIG. 9D indicates, “Stage 1 suppressed by register setting,” while “Stage 2 tries to use other color to deliver deficit.” In this configuration, the Other Strength parameter is set to be greater than zero, while the Heal Strength and Remain Strength parameters are set to zero. These parameter settings suppress the first and third compensation stages. As a result, only the second, other-color compensation stage is active, and the system attempts to use an other-color subpixel to address the deficit.

FIG. 9E illustrates a “Prioritize Other Color” mode 900-E. More specifically, as FIG. 9E indicates, “Stage 1 suppressed by register setting; Stage 2 tries to use other color to deliver deficit;” and “Stage 3 allocates remainder to emitters with headroom.” In this mode, the Heal Strength is set to zero to suppress the first stage, while the Other Strength and Remain Strength are set to be greater than zero. This prioritizes the use of a different-colored subpixel. The second stage first attempts to use an other-color subpixel to deliver compensation for the deficit. The third stage then allocates any remaining portion of the deficit to the same-color subpixels based on their available headroom.

FIG. 9F provides a further illustration of a “Prioritize Other Color” mode 900-F, showing a scenario where there may be insufficient headroom in the other-color subpixel. Here again, FIG. 9F indicates, “Stage 1 suppressed by register setting; Stage 2 tries to use other color to deliver deficit;” and “Stage 3 allocates remainder to emitters with headroom.” Similar to the mode of FIG. 9E, the Heal Strength is set to zero, while Other Strength and Remain Strength are set greater than zero. The second stage attempts to use the other-color subpixel, and the third stage allocates any remainder to the same-color subpixels based on their individual headroom.

It will be understood that certain methods and processes described herein may be implemented at least in part as instructions embodied in a non-transitory computer-readable medium and executable by one or more computing devices. In general, a processor (e.g., a microprocessor) receives instructions, from a non-transitory computer-readable medium (e.g., a memory, etc.), and executes those instructions, thereby performing one or more operations such as the operations described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random-access memory (DRAM), which typically constitutes a main memory.

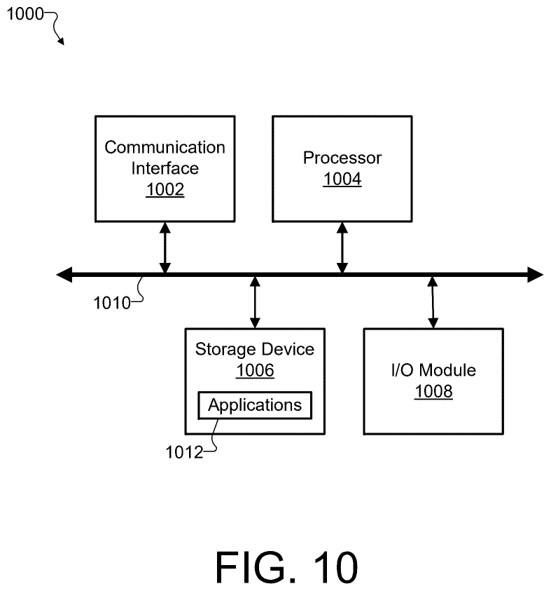

FIG. 10 shows a block diagram of an illustrative computing system 1000 upon which the systems and methods described herein may be implemented. In certain implementations, system 1000 may be configured to operate as a controller, such as controller 108 of system 100 or controller 206 of system 200, to perform the defect identification and compensation operations described herein. An implementation of computing system 1000 may be used to implement various devices and/or systems described below. For example, computing system 1000 may include or implement (or partially implement) display systems (e.g., display system 1300) or devices (e.g., device 1700) described herein, any implementations thereof, any components thereof, and/or other devices used therewith.

As shown in FIG. 10, computing system 1000 may include a communication interface 1002, a processor 1004, a storage device 1006, and an input/output (I/O) module 1008 communicatively connected via a communication infrastructure 1010. While an illustrative computing system 1000 is shown in FIG. 10, the components illustrated in FIG. 10 are not intended to be limiting. Additional or alternative components may be used in other embodiments. Components of computing system 1000 shown in FIG. 10 will now be described in additional detail.

Communication interface 1002 may be configured to communicate with one or more computing devices. Examples of communication interface 1002 include, without limitation, a wired network interface (such as a network interface card), a wireless network interface (such as a wireless network interface card), a modem, an audio/video connection, and any other suitable interface.

Processor 1004 generally represents any type or form of processing unit capable of processing data or interpreting, executing, and/or directing execution of one or more of the instructions, processes, and/or operations described herein. Processor 1004 may direct execution of operations in accordance with one or more applications 1012 or other computer-executable instructions such as may be stored in storage device 1006 or another computer-readable medium.

Storage device 1006 may include one or more data storage media, devices, or configurations and may employ any type, form, and combination of data storage media and/or device. For example, storage device 1006 may include, but is not limited to, a hard drive, network drive, flash drive, magnetic disc, optical disc, RAM, dynamic RAM, other non-volatile and/or volatile data storage units, or a combination or sub-combination thereof. Electronic data, including data described herein, may be temporarily and/or permanently stored in storage device 1006. For example, data representative of one or more executable applications 1012 configured to direct processor 1004 to perform any of the operations described herein may be stored within storage device 1006. In some examples, data may be arranged in one or more databases residing within storage device 1006.

I/O module 1008 may include one or more I/O modules configured to receive user input and provide user output. One or more I/O modules may be used to receive input for a single virtual experience. I/O module 1008 may include any hardware, firmware, software, or combination thereof supportive of input and output capabilities. For example, I/O module 1008 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1008 is configured to provide graphical data to a display for presentation to a user. The graphical data may be representative of one or more graphical user interfaces and/or any other graphical content as may serve a particular implementation.

It will be understood that the various circuitry elements described herein, such as identification module 208, first circuitry 210-1, second circuitry 210-2, third circuitry 210-3, and selection module 212, may be implemented by one or more components of system 1000. For example, the functionality of these circuits may be implemented by processor 1004 executing instructions stored in storage device 1006, or by dedicated hardware logic integrated within system 1000.

The preceding description, with reference to FIGS. 1-10, has detailed various aspects of a configurable compensation framework for addressing subpixel defects. This framework has been described as a flexible, hardware-based “toolkit” that includes various circuits for performing different types of compensation, such as capability-aware symmetric same-color compensation and content-aware other-color compensation. Various recruitment geometries (e.g., LINE, HALF, and FULL), multi-stage waterfall algorithms, and configurable operational modes have been illustrated to provide comprehensive technical solutions for healing defects while systematically mitigating visual artifacts.

Having described this comprehensive framework, the description will now turn to a more detailed discussion certain principles of heterochromatic (other color) compensation. As noted in the summary and introduction above, using different-colored subpixels for compensation can be a powerful technique that functions based on certain characteristics of the human visual system. The following section will explore these principles in greater depth. Similar to the preceding section, this discussion will begin with an introduction that lays out certain foundational concepts, technical problems, technical solutions, and benefits associated specifically with using different-colored subpixels for compensation. Following this introduction, a variety of illustrative architectures, subpixel layouts, and methods will be described in detail with reference to FIGS. 11-17.

As mentioned previously, despite significant efforts to perfect manufacturing processes, certain pixels of an image display may occasionally be deficient (e.g., dim, dead, etc.), creating an irritating dark spot for a viewer of the image display or, in certain cases, creating a yield or cost issue for the manufacturer. As described in detail herein, neighboring subpixels may help compensate for pixels that are determined to be deficient in these ways by, for example, producing more light than they would have otherwise to compensate for light not being produced by the deficient subpixel. While these compensating subpixels (referred to herein as surrogate subpixels) may be selected so as to produce the same color of light as the deficient subpixel they are compensating for, differently colored subpixels may also be used for this compensating role under certain circumstances described herein.

Image displays include large arrays of pixels that are configured to emit light of varying colors and brightness levels to recreate images represented in image data provided to the image displays. While thousands or millions of such pixels may be included in a given image display, even one or a small number of pixels, if not functioning properly, could reduce the perceived quality of the display. For example, if one or more pixels on a display is completely non-functional, annoying dark spots could be noticeable in any image the display presents. Even if functional pixels are underperforming (e.g., not capable of emitting light at a target brightness level for a given image), the consequence could be similarly negative for a viewer of the display. While it is possible to test newly manufactured image displays to determine whether deficient pixels are present, a practice of discarding image displays due to a few deficient pixels may be inefficient and wasteful and may add significantly to the cost of producing the image displays.

Color pixels and color displays (also referred to herein as full-color displays when primary colors such as red, green, and blue are available to produce a full spectrum of color) may be designed in a variety of ways. As one example, a television screen or computer monitor may be implemented by a backlit pixel panel configured for direct viewing by users in front of the display. As another example, a head-mounted display such as may be included within a head-mounted extended reality device (e.g., a virtual reality headset, a pair of mixed reality or augmented reality glasses, etc.) may be implemented by a much smaller pixel panel that is used, along with a system of optics (e.g., lenses, waveguides, etc.), to project a color image directly onto a retina of a wearer of the head-mounted device. Certain displays may also use techniques such as pixel shifting that alter the relationship between light emitters on a pixel panel (i.e., the hardware component emitting the light) and pixels visible on the image display (i.e., presented on the display after various optical transformations and/or other manipulation of the light produced by the pixel panel). For example, as will be described in more detail below, pixel shifting may be used to create more pixels on the display than there are actual light emitters on the pixel panel by mapping individual light emitters to more than one position on the array of pixels presented to the viewer.

For any of these or other types of full-color displays, the color pixels forming the images that are presented may each include several monochrome subpixels configured to emit different fundamental frequencies of light (e.g., primary colors) that can be combined to produce the various colors that the pixel may be called upon to generate. For example, the monochrome subpixels of one example pixel could include a red subpixel (i.e., a monochrome subpixel configured to produce light at a particular frequency that a user would perceive as red), a green subpixel (i.e., a monochrome subpixel configured to produce light at a particular frequency that a user would perceive as green), and a blue subpixel (i.e., a monochrome subpixel configured to produce light at a particular frequency that a user would perceive as blue). Such a pixel may be referred to as an RGB pixel (referring to the Red (‘R’), Green (‘G’), and Blue (‘B’) subpixels), and an array of such RGB pixels may form a full-color RGB display.

In some examples, some or all of the pixels on a display may include different numbers of monochrome subpixels, such as including multiple red pixels for each green and blue pixel or including extra green pixels. Additionally, primary color gamuts other than RGB could be used and/or additional monochrome subpixels (e.g., yellow (‘Y’) pixels, etc.) could be included with the red, green, and blue monochrome subpixels within some or all of the pixels (to thereby create RGBY pixels). Other types of subpixels such as polychrome subpixels (e.g., white (‘W’) subpixels) or non-visible subpixels (e.g., infrared (‘Ir’) subpixels) may also be used in certain display technologies (e.g., to form RGBW pixels, IrRGB pixels, etc.).

For a full-color display featuring an array of many thousands or millions of monochrome subpixels, it may be a difficult technical problem to ensure that every single subpixel is capable of performing up to specification. Indeed, despite careful and deliberate manufacturing techniques and testing techniques, it is virtually unavoidable that an occasional subpixel will fail to meet a threshold brightness level (e.g., a manufacturing test threshold, a target performance threshold specified for the subpixels, etc.). Such subpixels are referred to herein as deficient subpixels and will be understood to be deficient or defective in some way, such as by being completely non-functional or at least being unable to perform at a desired performance level (e.g., being unable to produce a target brightness level, etc.). Certain subpixels could be deficient due to (largely unavoidable) fabrication issues, while other subpixels may become deficient later, after a period of functional use. In either case, the technical problem of deficient pixels threatens to reduce yield (e.g., if image displays with a threshold number of deficient pixels are deemed inoperable and are discarded, etc.), reduce quality (e.g., if image displays with deficient pixels are used by users who can perceive dead or dim pixels, etc.), and/or lead to other undesirable outcomes.

Methods and systems described herein for subpixel defect compensation provide technical solutions to these technical problems. One technical solution that may be used to address subpixel deficiency is referred to herein as homochromatic subpixel defect compensation. As suggested by the term homochromatic (meaning “same color”), this approach involves compensating for a deficient monochrome subpixel using a nearby subpixel of the same color. A subpixel that meets the threshold brightness level (i.e., so as not to be deficient itself) and that is used to compensate for a deficient subpixel is referred to herein as a surrogate subpixel. For example, if a green subpixel in an array of monochrome subpixels is detected to be deficient, another green subpixel in the vicinity of the deficient one may be used to compensate for the missing light (e.g., shining bright enough to produce a brightness level that both green subpixels are assigned to produce in combination). As another example of homochromatic subpixel defect compensation, a deficient white polychrome subpixel (e.g., on an RGBW display) could be compensated for by a combination of nearby red, green, and blue monochrome subpixels (which, when each emitting additional light beyond what they are assigned, may combine to produce the white light the deficient white subpixel fails to emit).

Another technical solution used to address subpixel deficiency is referred to herein as heterochromatic subpixel defect compensation. As the focus of the present disclosure, heterochromatic (meaning “different color” or “other color”) subpixel defect compensation is described in detail herein. Similar to homochromatic subpixel defect compensation, heterochromatic subpixel defect compensation described herein involves using light from one or more nearby surrogate subpixels to compensate for light that a deficient subpixel is assigned, but fails, to produce. However, rather than reproducing light of the same color as the light that is missing (as a result of the deficiency of the defective monochrome subpixel), heterochromatic subpixel defect compensation involves matching the brightness level that a deficient subpixel fails to provide with light that is a different color than what the deficient subpixel would provide if it were fully functional.

With relatively low angular pixel resolution (i.e., the number of pixels per degree of vision is relatively low and the pixels are perceived as relatively large), heterochromatic subpixel defect compensation may help conceal deficient subpixels while still producing inferior perceived results compared to if there was no deficient subpixel or if the deficient subpixel were to be compensated for by a subpixel of the same color. In such cases, additional light of the wrong color but near the position of the deficient subpixel may be perceivable as a defect while being less noticeable or irritating than a dark spot would be. As will be described and illustrated in more detail below, it will be understood that, unless otherwise noted, distances described herein between subpixels (as well as related concepts such as pixel resolution) may refer to pixel positions as finally received on the retina of a viewer. Such distances may be quantified, for instance, in terms of pixel per degree (ppd), arcminutes, or using another suitable unit. In certain cases, such distances may be directly related to the distances of physical subpixel emitters emitting light on a pixel panel or physical display. In other cases (as will be detailed below), however, such distances could be independent from the distances of the physical subpixels (e.g., such as for a display that uses optics to combine light from different pixel panels and form an image directly on the retina).

At a sufficiently high angular pixel resolution (i.e., in which the number of pixels per degree of vision is relatively high and the pixels are perceived as relatively small and close together), the human visual system becomes achromatic. That is, the viewer of a sufficiently high-resolution display may be able to perceive brightness level at a given spot without being able to resolve details about the color or the precise position where the light is emitted. In this scenario, then, heterochromatic subpixel defect compensation may be highly effective in concealing deficient subpixels such that it would be impossible (or highly unlikely) for the human visual system to even detect or notice a defect. In essence, neurons in the retina and/or the brain may spatially sum pixel luminances (i.e., brightness levels) for an angular area that is smaller than a certain threshold that the human visual system is capable of resolving. For example, any light within a small enough segment of a person's visual field may be spatially summed by the eye and/or brain of the user to detect only the brightness level produced by that segment, without being sensitive to the color. For example, a threshold where this effect may be at least partially observed (e.g., for at least some people) could begin around 30 pixels per degree (ppd), around 40 ppd, around 50 ppd, or at another perceived resolution. For lower resolutions (i.e. larger pixels), partial summation following Piper's law (square root summation), or Pieron's law (cube root summation) may occur to achieve a similar effect, albeit to a more limited degree.

Optical blur is another factor that may impact how effective heterochromatic subpixel defect compensation may be for a given display scenario. Just as very high resolution may help hide the fact that a surrogate subpixel produces light of a different color than a deficient subpixel might be assigned to produce, blur similarly makes it more difficult for the human visual system to distinguish color on a very fine scale. For example, optical blur or pixel crosstalk may reduce the edge contrast of a pixel, therefore resulting in a light mixture with nearby pixels that reduces color differences between them. While blur is generally considered undesirable, some amount of blur tends to be present in any real-world image display as a result of imperfect optics (e.g., light bleeding through diffractive waveguides, etc.), the display itself (e.g., light traveling laterally between subpixels), diffraction by small optical features, and the like. Advantageously, such blur may thus help make heterochromatic subpixel defect compensation more effective as a technical solution to the problem of deficient subpixels. In some examples, known attributes of optical blur for a given image display (e.g., a characterization showing there is more horizontal blur than vertical blur, etc.) may be accounted for to more efficiently leverage the positive benefit of otherwise parasitic blur.

While it may be desirable to manufacture image displays so as to have as few deficient subpixels as possible, there are significant technical effects and benefits from being able to compensate for pixel defects when they inevitably occur with real-world displays. For example, one technical effect mentioned above relates to higher quality of displays (with fewer or no perceivable deficient pixels) and higher manufacturing yields (as fewer units fail quality tests as their deficiencies can be corrected). These technical effects hold for both homochromatic and heterochromatic subpixel defect compensation techniques described herein.

Certain additional technical effects and advantages may also arise specifically from heterochromatic subpixel defect compensation described herein. For example, heterochromatic subpixel defect compensation for a given image display may be performed by a single color of monochrome subpixels, providing efficient options (described and illustrated in detail below) for subpixel arrangements with dedicated surrogate subpixels. For example, green monochrome subpixels, yellow monochrome subpixels, or other suitable colors (e.g., colors that tend to appear very bright for a given amount of energy used) may be interspersed among other subpixels (e.g., RGB subpixels) to serve as surrogate subpixels for any subpixels that turn out to be deficient. Being able to use the same color for all the surrogate subpixels may also allow for power efficiencies (e.g., since certain colors provide more perceived brightness for a given unit of power), manufacturing efficiencies (e.g., since it may be more efficient for all the dedicated surrogate subpixels to be of a certain color than to produce surrogate subpixels of a variety of colors), and other benefits.

Various implementations will now be described in more detail with reference to the figures. It will be understood that particular implementations described below are provided as non-limiting examples and may be applied in various situations. Additionally, it will be understood that other implementations not explicitly described herein may also fall within the scope of the claims set forth below. Methods and systems for subpixel defect compensation (and heterochromatic subpixel defect compensation in particular) in a display system may result in any or all of the technical benefits mentioned above, as well as various additional and/or alternative technical effects and benefits that will be described and/or made apparent below.

FIG. 11 shows certain aspects of an illustrative implementation of heterochromatic subpixel defect compensation in accordance with principles described herein. In this example, as shown, an array 1102 of monochrome subpixels (square subpixels in this example) is shown to be arranged in rows and columns on a rectilinear lattice. As indicated by a key 1104, the monochrome subpixels of array 1102 are arranged according to color. The line and fill patterns used to represent the different colors in key 1104, and in the other figures of this disclosure, are consistent with the key described previously in relation to FIG. 1.

It will be understood that, in this figure and other figures in the present disclosure, the illustrated subpixels of the array (e.g., array 1102) may represent only a small portion of the total number of monochrome subpixels that the array may include. For example, certain arrays may include thousands or millions of monochrome subpixels to produce high-resolution images (e.g., on a color display, directly on the user's retina using optics, etc.). It will also be understood that pixels may correspond to the illustrated subpixels of FIG. 11 and other figures herein in any manner as may serve a particular implementation. For example, triplets of adjacent monochrome subpixels including one red subpixel, one green subpixel, and one blue subpixel may serve as a full-color pixel in certain pixel arrays. In other pixel arrays, each pixel may include different numbers of the monochrome subpixels (e.g., one green, one blue, and two red subpixels; one red, one blue, one green, and one dedicated surrogate subpixel that is yellow or green; etc.). For purposes of the present disclosure, the precise mapping of monochrome subpixels to full-color pixels (capable of producing a variety of color shades using at least one of each primary color) will be emphasized less than the individual colors of the monochrome subpixels that make up the pixels. As a result, it is noted that descriptions of subpixel defect compensation disclosed herein are distinguishable from the somewhat related concept of mura compensation and other similar calibration techniques that are performed to correct for natural luminance variability across pixels in a display.

Each monochrome subpixel within array 1102 may be implemented by any suitable light emitter of the indicated color (e.g., red, green, or blue in this example). As will be described and illustrated in more detail below, the light of each subpixel may be presented directly to a viewer of the display or may emitted and presented only after processing by a system of optics (e.g., lenses, waveguides, diffraction gratings, etc.) that prepare the light in various ways to be viewable by the user in a desirable way. One way that the monochrome subpixels of array 1102 may be implemented is by an array of micro light emitting diodes (microLEDs), which may provide various power and size advantages over other technologies. However, while microLED technology may be presumed for various examples in this disclosure, it will be understood that principles described herein may apply to various other LED and non-LED-related display technologies (e.g., OLEDs, pixels of an LCOS panel, etc.). Additionally, while a red-green-blue (RGB) color scheme relying on the red, green, and blue primary colors is shown in FIG. 11 and used for many examples herein, it will be understood that the principles may apply to displays using other color schemes (e.g., red-green-blue-white (RGBW), red-green-blue-cyan (RGBC), red-green-blue-yellow (RGBY), etc.).

As shown near the middle of the portion of array 1102 illustrated in FIG. 11 (in the middle of a row of blue subpixels), array 1102 includes a deficient subpixel 1106. While this particular subpixel may have been manufactured and intended to be a blue subpixel (as illustrated by its dotted outline and its position with respect to other subpixels of the array), deficient subpixel 1106 will be understood to have been identified as being deficient or defective in some way, such that it will need assistance to be able to reach at least some target brightness levels it could be assigned for certain image content. In some cases, a deficient subpixel such as deficient subpixel 1106 may be entirely non-functional (i.e., a dead pixel) that is incapable of producing any light. For this reason, deficient subpixel 1106 is drawn with a black ‘X’ to indicate that it does not emit light like the other subpixels do. In other cases, a deficient subpixel such as deficient subpixel 1106 may be partially-functional and able to produce monochrome light at a certain brightness level, but may be dim and incapable of operating throughout the range of brightness levels that may be specified for each subpixel to be considered fully-functional. In these cases, rather than being non-functional, deficient subpixel 1106 would be referred to herein as an underperforming subpixel.

FIG. 11 shows several possible ways that heterochromatic subpixel defect compensation in accordance with principles described herein may be performed. To illustrate, a 3×3 block of subpixels that includes deficient subpixel 1106 in the middle (outlined by a dashed-line box) is shown in several possible configurations on the right side of array 1102 in FIG. 11. At the top of the figure, a configuration 1108 of these nine subpixels illustrates example target brightness levels that the subpixels may be assigned to produce for a particular image. While the content of a given image may call for a variety of different brightness levels of different pixels, each of the illustrated pixels in configuration 1108 is shown, for clarity of illustration, to be assigned a target brightness level of 110 units. This quantity of 110 will be understood to be a generic quantity that could represent any suitable brightness in an example using actual units of brightness (e.g., nits, lumens, candelas, etc.).

While deficient subpixel 1106 (in the middle of configuration 1108 and the other configurations below it) is shown to have, like the other subpixels, a target brightness level of 10, the deficiency of this particular subpixels means that it will not be able to meet that target. Depending on the circumstances of a particular scenario, several possible configurations are shown in which heterochromatic subpixel defect compensation of deficient subpixel 1106 may be performed. First, configurations 1110-1 and 1110-2 show possible ways that heterochromatic subpixel defect compensation may be performed in the case that deficient subpixel 1106 is completely non-functional. As shown, the non-functional example of deficient subpixel 1106 in these configurations is indicated to produce a brightness level of 0 (i.e., no light). Configurations 1112-1 and 1112-2 then show possible ways that heterochromatic subpixel defect compensation may be performed in the case that deficient subpixel 1106 is merely underperforming, but not completely dead. As shown, the underperforming example of deficient subpixel 1106 in these configurations is indicated to produce a brightness level of 5 (i.e., some light but well below the target brightness level of 10). Each of these configurations 1110-1, 1110-2, 1112-1, and 1112-2 will now be described in more detail.

In configuration 1110-1, the deficient subpixel 1106 is shown to be a non-functional subpixel that is assigned to produce a first target brightness level (i.e., a brightness level of 10) for the presentation of the image, but that actually produces no light at all (i.e., a brightness level of 0). In this example, a surrogate subpixel directly above deficient subpixel 1106 is selected to help compensate for this deficiency. As shown by the dashed lines (and as seen in context within array 1102 to the left), this selected surrogate is a green subpixel. The surrogate subpixel may be assigned to produce a second target brightness level for the presentation of the image. While the second target brightness level in this example is the same as the first target brightness level (i.e., 10), it will be understood that this would often not necessarily be the case. Rather, the surrogate subpixel could be assigned to be brighter or dimmer than the surrogate subpixel based on the content of the image. The use of the surrogate subpixel to compensate for deficient subpixel 1106 includes, in this example, the surrogate subpixel producing a brightness level equivalent to a sum of the first target brightness level (i.e., 10) and the second target brightness level (i.e., 10). In other words, as shown within configuration 1110-1, the surrogate subpixel above deficient subpixel 1106 (which produces brightness level 0) is shown to produce brightness level 20. As a result, the total brightness level of 20 that is assigned to the combination of these two pixels is still provided and, assuming the angular pixel resolution is sufficiently high (as described above), the human visual system will be unable to distinguish that color difference or the reality that a deficient subpixel is present, since the total amount of luminance produced by the area of the deficient subpixel is the assigned amount. Here and elsewhere, it will be understood that the actual brightness level of the surrogate subpixel may not be exactly 20. Rather, in some examples, the brightness of the surrogate pixel (or pixels) may be driven with a brightness configured to facilitate user perception of a uniform brightness.

In configuration 1110-2, the deficient subpixel 1106 is again shown to be a non-functional subpixel that is assigned to produce the target brightness level of 10 but that actually produces the brightness level of 0. In contrast to configuration 1110-1, however, configuration 1110-2 shows an example in which multiple surrogate subpixels may be selected to work together to compensate for deficient subpixel 1106. Specifically, along with selecting the same surrogate subpixel above deficient subpixel 1106 (as described above in configuration 1110-1), configuration 1110-2 shows an example of further selecting, based on the position of deficient subpixel 1106, an additional surrogate subpixel within the array, this one located directly below the deficient subpixel 1106 within the array. As shown by the solid lines (and as seen in context within array 1102 to the left), this additional selected surrogate is a red subpixel. As such, the surrogate subpixel (the green subpixel above) and the additional surrogate subpixel (the red subpixel below) may be used together to compensate for the blue deficient subpixel 1106 for (e.g., during) the presentation of the image.

More particularly, while both surrogate subpixels may be assigned to produce the same target brightness level of 10 in this example (which again, is a convenience for illustrative purposes but may not necessarily be the case for many images), the actual brightness levels the surrogate subpixels each produce may be configured to collectively compensate for the brightness assigned to deficient subpixel 1106. Specifically, since each of the surrogate subpixels is shown to produce a brightness level of 15, rather than 10 (as assigned), the two surrogate subpixels collectively emit 10 extra units of brightness to compensate for the 10 units assigned to deficient subpixel 1106 that it fails to produce. As a result, the total brightness level of 30 that is assigned to the combination of these three pixels is provided and, assuming the resolution is sufficiently high (as described above), the human visual system will be unable to distinguish the color difference or the reality that a deficient subpixel is present, since the total amount of luminance produced by the area of the deficient subpixel is the assigned amount. Additionally, another potential benefit of this type of configuration is that no singular subpixel is responsible for bearing the entire load of the deficient subpixel, but, rather, the load is distributed to a plurality of nearby subpixels. This could be advantageous if, for example, the subpixels were not able to produce light at a brightness level of 20 and the single-subpixel compensation illustrated in configuration 1110-1 were not realizable.

In the example of configuration 1110-2, the two surrogate subpixels are each configured to emit light that is different in color not only from deficient subpixel 1106 but also from one another. Specifically, in this example, the brightness level of a blue subpixel is compensated for by both green light (from the surrogate subpixel above) and red light (from the surrogate subpixel below). It will be understood that other combinations may also be possible, however. For example, one surrogate subpixel could be a different color than the deficient subpixel (e.g., green, rather than blue), while the other surrogate subpixel could be the same color as the deficient subpixel (e.g., a blue subpixel next to deficient subpixel 1106). As another example, both surrogate subpixels could be different in color from the deficient subpixel (e.g., green, rather than blue), but could be the same color as one another (e.g., two green subpixels from the row above the deficient subpixel 1106). In still other examples, more than two surrogate subpixels could be used for heterochromatic subpixel defect compensation in other similar ways, depending on the display resolution and perceived proximity of the surrogate subpixels to the deficient subpixel. As another specific example of how multiple monochrome subpixels may be used as surrogates to compensate for deficient monochrome subpixels, either a deficient green subpixel or a deficient red subpixel could be compensated for by a combination of both a green surrogate subpixel and a red surrogate subpixel (which together could be perceived as brighter than either subpixel alone). As yet another example, a yellow monochrome subpixel could be combined with any other color to compensate for a red, green, or blue deficient subpixel.

In each of these cases, high angular pixel resolution (and/or sufficient blur) of the display may, as has been described, take advantage of limitations of the human visual system to replace light that one deficient subpixel is unable to produce by light of a different color that another surrogate subpixel has capacity to produce. It is notable that the light in these examples is not only different in color, but is a different primary color (e.g., green rather than blue, green and red rather than blue, etc.) that is essentially orthogonal to the color assigned by the image. This contrasts with examples in which, for example, light that is homochromatic or partially homochromatic (i.e., included within) what is assigned is used, such as if green light or green and red light were used to compensate for missing white light.

In configuration 1112-1, the deficient subpixel 1106 is shown to be an underperforming subpixel that is assigned to produce a first target brightness level (i.e., a brightness level of 10) for the presentation of the image, but, since that first target brightness level exceeds a maximum brightness level achievable by the underperforming subpixel by a margin brightness level, actually produces less than that (i.e., a brightness level of 5). In other words, since the target brightness level in this example is 10 and the produced brightness level is only 5, the margin brightness level would be 10−5=5.

Similar to configuration 1110-1, a surrogate subpixel directly above deficient subpixel 1106 is selected in this example to help compensate for the deficiency. Again, the surrogate subpixel may be assigned to produce a second target brightness level (i.e., 10) for the presentation of the image. The using of the surrogate subpixel to compensate for deficient subpixel 1106 includes, in this example, the surrogate subpixel producing a brightness level equivalent to a sum of the margin brightness level (i.e., 5) and the second target brightness level (i.e., 10). In other words, as shown within configuration 1112-1, the surrogate subpixel above deficient subpixel 1106 (which produces brightness level 5) is shown to produce brightness level 15. As a result, the total brightness level of 20 that is assigned to the combination of these two pixels is still provided and, assuming the angular pixel resolution perceived by the user is sufficiently high (as described above), the human visual system will be unable to distinguish that color difference or the reality of the deficient subpixel's presence due to the total amount of luminance produced by the area being the assigned amount.

In configuration 1112-2, the deficient subpixel 1106 is again shown to be an underperforming subpixel that is assigned to produce the target brightness level or 10 but that actually produces the brightness level of 5. In contrast to configuration 1112-1, however, configuration 1112-2 shows an example in which multiple surrogate subpixels may be selected to work together to compensate for deficient subpixel 1106, similar to configuration 1110-2 above. Specifically, along with selecting the same surrogate subpixel above deficient subpixel 1106 (as described above in configuration 1110-1), configuration 1112-2 shows an example of further selecting, based on the position of deficient subpixel 1106, an additional surrogate subpixel located directly below the deficient subpixel 1106 within the array. Here again, the actual brightness levels produced by the surrogate subpixels is shown to collectively compensate for the brightness assigned to deficient subpixel 1106. Specifically, the green surrogate subpixel is shown to produce a brightness level of 13, the red surrogate subpixel is shown to produce a brightness level of 12, and, with the 5 units provided by the underperforming pixel, the total brightness level of 30 that is assigned to the combination of these three pixels is provided. Assuming the angular pixel resolution is sufficiently high (as described above), the human visual system will be unable to distinguish the color difference or the reality of the deficient subpixel since the total amount of luminance produced by the area of the deficient subpixel is the assigned amount. Additionally, as mentioned above, the load is distributed to more than one proximate subpixel to avoid placing all the load on a singular subpixel.

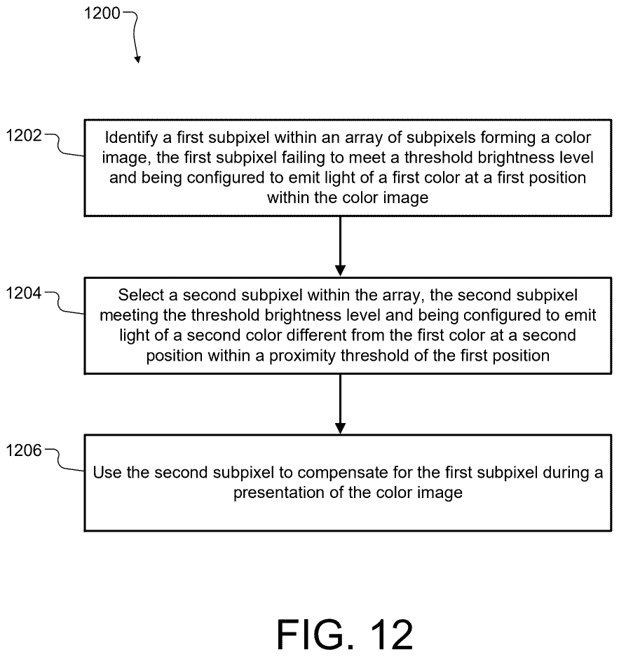

FIG. 12 shows an illustrative method 1200 for heterochromatic subpixel defect compensation in accordance with principles described herein. For example, method 1200 may be performed by a display system that includes a full-color image display formed from an array of monochrome subpixels such as array 1102 described above. The method could be carried out, for instance, during and/or in response to a self-calibration sequence by the display system. In other examples, method 1200 may be performed by or in connection with a test or calibration system used for testing and/or calibrating a display system, such as at a time of manufacturing, repair, or the like. While FIG. 12 shows illustrative operations according to a specific implementation, it will be understood that other implementations of these methods may omit, add to, reorder, and/or modify any of operations 1202-1206 that are explicitly represented in FIG. 12. Additionally, while operations 1202-1206 are illustrated with arrows suggestive of a sequential order of operation, it will be understood that some or all of the operations of method 1200 may be performed concurrently (e.g., in parallel) with one another. Each of the operations of method 1200 will now be described in more detail.

At operation 1202, a first subpixel within an array of subpixels forming a color image may be identified as a deficient subpixel. For example, the first subpixel may be identified, based on a brightness threshold (e.g., a threshold brightness level), as a subpixel that fails to meet the brightness threshold. This may be performed by, for example, a display system that performs a self-test or self-calibration process (e.g., at a time of manufacturing or in the field when the system is powered on, etc.). These types of processes may be performed to allow the display system to determine which of its subpixels may be deficient in some way (e.g., non-functional, underperforming, etc.). As another example, a separate device configured to facilitate testing and/or calibration of the display system could be used to make a similar determination. In either case, the identified first subpixel (i.e., the deficient subpixel that has been discovered or identified as part of operation 1202) may be configured to emit light of a first color at a first position within the color image (i.e. a position within the image as it is received at the user's retina and perceived by the user).

At operation 1204, this first position of this first subpixel (i.e., the deficient subpixel) identified at operation 1202 may be used to select a second subpixel within the array of subpixels. The second subpixel may also be selected based on the brightness threshold (e.g., the threshold brightness level) in that the second subpixel is identified to meet the brightness threshold (i.e., so that, unlike the first subpixel, it is not deficient) and may be selected at operation 1204 for use as a surrogate subpixel. For this function, the second subpixel may be selected based on a second position of the second subpixel within the color image (again, as the image is perceived by the user). For example, the second subpixel may be selected based on the proximity of its position (i.e., the second position) to the first position of the first subpixel. More particularly, the second subpixel may be selected so as to be within a proximity threshold of the first position within the image, such that the surrogate compensation for the first pixel's light will be effective. This proximity threshold may be based on distance (e.g., measured as a threshold number of microns or millimeters), based on angular distance with respect to an intended viewing distance (e.g., measured as a threshold number of arcminutes, etc.), based on the pitch of the subpixel array (e.g., measured as a number of pixels, etc.), or in any other suitable way. In any case, the second subpixel may be selected as a pixel that is proximate enough to the first subpixel so that the compensatory role of the surrogate subpixel will be at least partially effective.

In some examples, an image is formed in angular space (e.g., at the retina of a user), and the resolution of the image is at least 30 ppd (e.g. at least 40 ppd, 45 ppd, 50 ppd, 60 ppd, etc.). In some examples, the angular distance between a deficient subpixel and a surrogate subpixel is less than two arcminutes (e.g. less than one arcminute, less than 0.5 arcminute).

In some cases, the proximity between the first and second positions may be an immediate adjacency. In other words, similar to the examples illustrated in relation to FIG. 11, a surrogate subpixel could be selected that is adjacent to (e.g., immediately above or immediately below, as illustrated in the example of FIG. 11) the deficient subpixel. In other cases, however, the proximity may not necessarily be quite so immediate, particularly if the array has a high angular pixel resolution and the monochrome subpixels are very small and close to one another. In these examples, it could be the case that the selected surrogate subpixel may skip over one or more subpixels and be a little further away, though the second position is still relatively proximate to the first position (within a few subpixels) and is selected based on the first position. While, as mentioned above, homochromatic subpixel defect compensation with a surrogate subpixel of the same color as the deficient subpixel may be performed in certain scenarios, the heterochromatic subpixel defect compensation performed by method 1200 means that the surrogate subpixel selected at operation 1204 will be configured to emit light of a second color different from the first color emitted by the deficient subpixel.

At operation 1206, the second subpixel (i.e., the surrogate subpixel) may be used to compensate for the first subpixel (i.e., the deficient subpixel) during a presentation of the color image (e.g., a presentation on a color display, a projection directly onto the user's retina using optics, etc.). For example, as described and illustrated above, this compensation could involve one or more surrogate subpixels (selected at operation 1204) being used to compensate for the target brightness level assigned to a non-functional deficient subpixel, as illustrated by configurations 1110-1 and 1110-2 in FIG. 11. Alternatively, the compensation could involve one or more surrogate subpixels being used to compensate only for a margin brightness level that an underperforming deficient subpixel is unable to achieve (i.e., the difference between the target brightness level the deficient subpixel is assigned and the maximum brightness level the underperformer is capable of emitting), as illustrated by configurations 1112-1 and 1112-2 in FIG. 11.

In either case, the use of the surrogate subpixel for the compensation of operation 1206 may be performed in various ways, depending on the posture of system performing method 1200 with respect to the display system (i.e., whether it is the same system, a different system, etc.). As one example, the display system itself could use the surrogate subpixel to compensate for the deficient subpixel in accordance with operation 1206 by, for instance, overdriving the surrogate subpixel in a manner that compensates for the brightness that the deficient subpixel fails to provide (as illustrated and described in relation to FIG. 11). As another example, an external system (e.g., a test or calibration system used to calibrate and configure the display system at a time of manufacturing, a time of testing/repair, etc.) could use the surrogate subpixel to compensate for the deficient subpixel in accordance with operation 1206 by, for instance, populating a data structure (e.g., a look-up table, a memory, etc.) with data that causes a target brightness level assigned to the deficient subpixel, for any particular image, to be reassigned to the surrogate subpixel (and/or to be redistributed to a plurality of surrogate subpixels, as has been described). Still other types of systems and/or other components of the systems mentioned above could perform method 1200 in other ways in certain implementations, with an end result that one or more surrogate subpixels proximate to a deficient subpixel are overdriven so as to compensate for the deficient subpixel in any of the ways described herein.

In some implementations, a method such as method 1200 may be embodied as a process within a memory. For example, method 1200 may be embodied by instructions stored in memories described and illustrated herein. More particularly, a non-transitory computer-readable medium may store instructions that, when executed, cause a processor of a computing device (e.g., a display system, a calibration system, etc.) to perform a process embodying method 1200. Specifically, when executing the instructions on the non-transitory computer-readable medium, the processor may: 1) identify a first subpixel (e.g., a deficient subpixel) within an array of subpixels (e.g., monochrome subpixels) forming a color image, the first subpixel being identified based on a brightness threshold (e.g., because the first subpixel fails to meet a threshold brightness level) and being configured to emit light of a first color at a first position within the color image; 2) select a second subpixel (e.g., a surrogate subpixel) within the array of subpixels, the second subpixel being selected based on the first position and the brightness threshold (e.g., because the second subpixel meets the threshold brightness level) and being configured to emit light of a second color different from the first color at a second position within a proximity threshold of the first position within the color image; and 3) use the second subpixel to compensate for the first subpixel in any of the ways described herein for (e.g., during) a presentation of the color image.

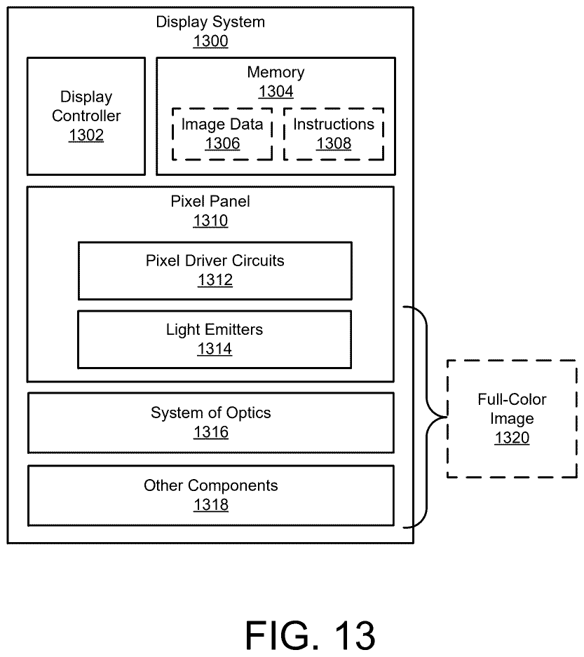

FIG. 13 shows a block diagram of an illustrative display system 1300 configured to perform heterochromatic subpixel defect compensation in accordance with principles described herein. As shown, display system 1300 may feature a display controller 1302 and a memory 1304 that stores image data 1306 that is to be displayed by display system 1300, as well as instructions 1308 to be performed by the system (e.g., such as the instructions described above as invoking method 1200). Display system 1300 is further shown to include a pixel panel 1310 that includes an array of pixel driver circuits 1312 and an array of light emitters 1314. Together with a system of optics 1316 and, possibly, other components 1318 (e.g., an actuator for a pixel shifting scheme, a screen onto which emitted light may be projected, etc.), these light emitters 1314 produce light that forms a full-color image 1320 either on a screen that can be viewed by a user of display system 1300, or, in some examples, directly on the retina of an eye of the user. Each of the components of display system 1300 will now be described in more detail.

Display controller 1302 may operate using data stored in memory 1304 to control pixel panel 1310 so that images may be presented on full-color image 1320. For example, by executing instructions 1308 stored in memory 1304, display controller 1302 may determine how bright each monochrome subpixel is to be driven for each image frame represented in image data 1306 and may direct pixel panel 1310 to drive light emitters 1314 accordingly (using pixel driver circuits 1312). In some examples, pixel driver circuits 1312 may be configured to drive different light emitters 1314 to different target brightness levels (in accordance with direction from display controller 1302) by applying different analog voltages or currents to the different light emitters 1314. In other examples, pixel driver circuits 1312 may be configured to produce the different target brightness levels using a binary pulse-width-modulation (PWM) scheme. For example, within a single frame time (i.e., to display one particular image), light emitters 1314 may be driven off and on at a fixed brightness such that the total amount of time per frame they are on modulates the brightness level they are perceived to have. A light emitter that is driven on for most of the frame time may appear brighter, for example, than a light emitter that is driven on for only a small portion of the frame time.

Light emitters 1314 may be implemented by an array of monochrome subpixels that forms (after light from the emitters is processed or treated by optics 1316 and/or other components 1318) the full-color image 1320. In other words, as used herein, light emitters 1314 may refer specifically to the hardware emitters on the pixel panel (e.g., microLEDs, OLEDs, pixels of an LCOS panel, etc.), while these same emitters may be referred to as subpixels (e.g., monochrome subpixels) of the array after the emitted light has traveled through any optical and/or other light treatment (e.g., waveguides, magnification, filtering, projection, reflection, etc.) as may occur prior to being presented (e.g., on a display or directly at the user's retina, etc.) as full-color image 1320. The array of monochrome subpixels implemented by light emitters 1314 and driven by pixel driver circuits 1312 in this way may include one or more deficient subpixels for which surrogate subpixels may be selected and associated. For instance, one deficient subpixel may be presented at a first position within the image and may be configured to emit light of a first color. A surrogate subpixel presented at a second position proximate to the first position within the image may then be configured to emit light of a second color different from the first color, such that the display controller 1302 may be configured to cause the array of monochrome subpixels to present full-color image 1320 using the surrogate subpixel to compensate for the deficient subpixel.

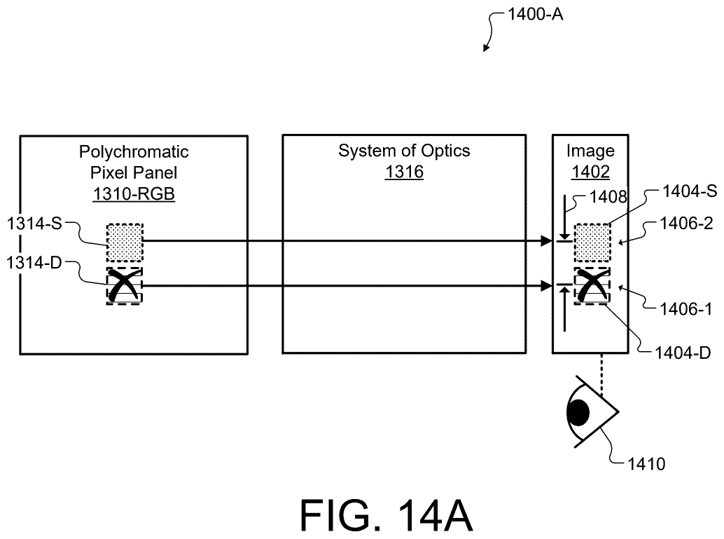

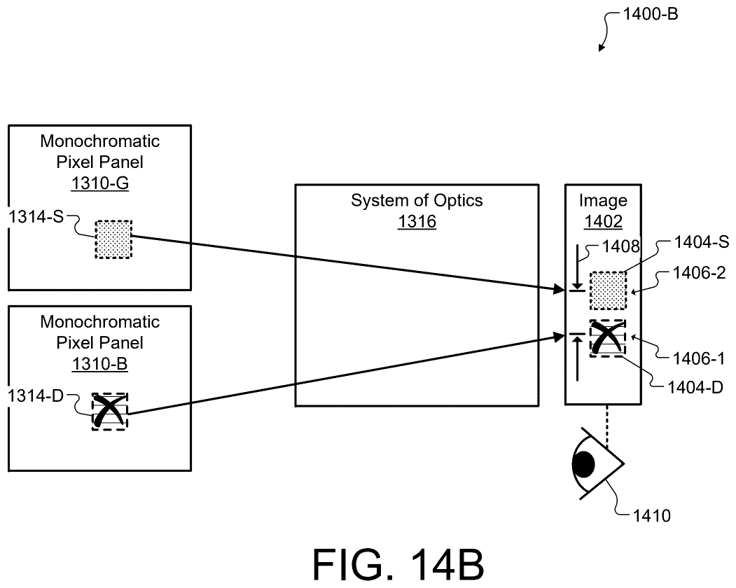

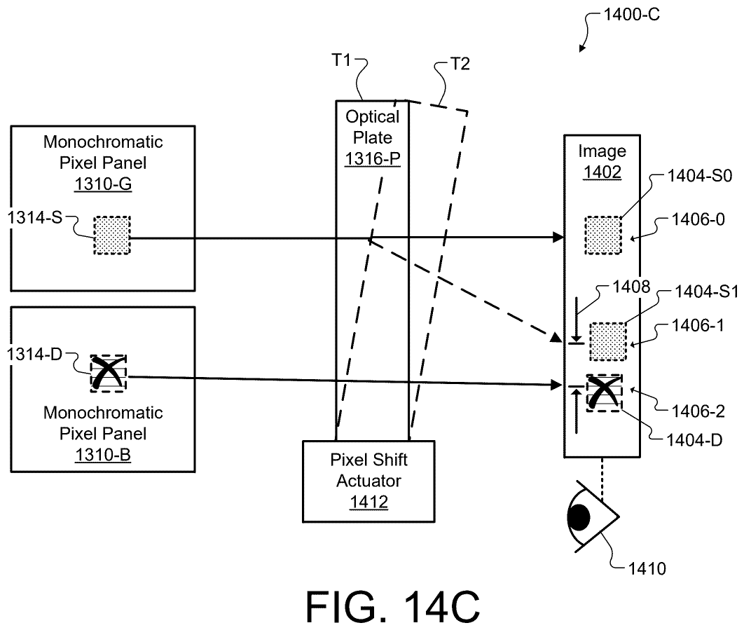

The array of monochrome subpixels implemented by light emitters 1314 may be configured to present full-color image 1320 in connection with different systems of optics 1316 and/or other components 1318 in a variety of ways for different devices and applications. A few example architectures by which full-color image 1320 may be produced will be described and illustrated with reference to FIGS. 14A-14C. In each of these examples, the locations of the physical light emitters on their pixel panels will be understood to be of less importance than the positions of the subpixels as they are perceived by a user viewing the full-color image 1320. It is the proximity of these subpixel positions that allows for heterochromatic subpixel defect compensation to be effectively performed.

FIG. 14A shows how heterochromatic subpixel defect compensation may be performed for a first image display architecture 1400-A in accordance with principles described herein. In this example, the array of monochrome subpixels is implemented by an array of monochrome light emitters of different colors disposed together on a polychromatic pixel panel 1310-RGB. As such, full-color image 1320 is produced by polychromatic pixel panel 1310-RGB and a system of optics 1316 through which polychromatic pixel panel 1310-RGB emits light.

More particularly, polychromatic pixel panel 1310-RGB may include pixels of each of the three primary colors red, green, and blue, similarly as illustrated, for example, by array 1102 in FIG. 11. Accordingly, a light emitter 1314-S (‘S’ for surrogate) and a light emitter 1314-D (‘D’ for deficient) may happen to be proximate to one another both on the pixel panel as well as within an image 1402 that is perceived by a user after the light travels through any system of optics 1316 as may be implemented within the display device (e.g., lenses for magnification, a cover glass for protecting the pixel panel, a waveguide for displaying the image in a different location than the pixel panel, etc.). This type of direct-to-retina image projection shown in image display architecture 1400-A may be implemented within a head-mounted extended reality device (e.g., augmented reality glasses, a virtual reality headset, etc.), though it will be understood that, in other examples, the image could similarly be presented (with or without optics 1316) on a display of another suitable type of device described herein (e.g., a smartwatch, a smartphone, a television, a screen on a vehicle or appliance, etc.).

As shown, light emitted by light emitter 1314-D (in the event that light emitter 1314-D is an underperforming pixel and not completely non-functional) and light emitter 1314-S is shown to be processed by optics 1316 before being perceived within image 1402 as, respectively, a deficient subpixel 1404-D at a first position 1406-1 and a surrogate subpixel 1404-S at a second position 1406-2. These positions 1406-1 and 1406-2 are shown to be immediately proximate to one another, just as the light emitters 1314-D and 1314-S on polychromatic pixel panel 1310-RGB are in this example. Given a distance 1408 small enough between positions 1406-1 and 1406-2 within image 1402, a human viewer, on whose retina 1410 (represented by an eye in the figure) image 1402 is formed, will only perceive the brightness of the green surrogate subpixel 1404-S, and not its color difference from deficient subpixel 1404-D. As such, the green surrogate subpixel 1404-S may effectively compensate for the blue deficient subpixel 1404-D as perceived by the viewer.

FIG. 14B shows how heterochromatic subpixel defect compensation may be performed for a second image display architecture 1400-B in which the positions of the light emitters 1314-D and 1314-S do not necessarily have the same proximity relationship as the corresponding positions of the subpixels 1404-D and 1404-S within the image. In this example, the array of monochrome subpixels is implemented by at least a first array of monochrome light emitters of the first color (blue) disposed on a first monochromatic pixel panel 1310-B, and a second array of monochrome light emitters of the second color (green) disposed on a second monochromatic pixel panel (1310-G). In other words, monochromatic pixel panel 1310-B may include an array of blue light emitters (and no other colors) and may be separate from monochromatic pixel panel 1310-G, which may include an array of green light emitters. While not shown in FIG. 14B (since the illustrative deficient subpixel is blue and the surrogate subpixel is green in this example), it will be understood that another monochromatic pixel panel including an array of red light emitters may also be included in the display system together with the green and blue monochromatic pixel panels.

In this example, the full-color image 1320 is produced by overlaying, using a system of optics 1316, first light (e.g., blue light) emitted by monochromatic pixel panel 1310-B and second light (e.g., green light) emitted by monochromatic pixel panel 1310-G. Additionally, red light emitted by a red monochromatic pixel panel (not shown in FIG. 14B) could also be overlaid with the light from the other panels. The optics 1316 may guide, move, filter, magnify, and/or otherwise process the light emitted by the monochromatic pixels panels to cause the light to be presented within an image 1402 that is perceived by a user to be similar to the example using a polychromatic pixel panel described above in relation to FIG. 14A. As such, a blue light emitter 1314-D (‘D’ for deficient) and a green light emitter 1314-S (‘S’ for surrogate) that are included on separate pixel panels (and thus do not happen to be particularly proximate to one another) are shown to be associated, respectively, with a blue deficient subpixel 1404-D and a green surrogate subpixel 1404-S that are proximate to one another within image 1402 after the light has traveled through the system of optics 1316. This image display architecture 1400-B may be especially well-suited for implementing a display of head-mounted extended reality device (e.g., augmented reality glasses, a virtual reality headset, etc.).

As similarly described above in relation to FIG. 14A, respective positions 1406-1 and 1406-2 of the subpixels 1404-D and 1404-S within image 1402 are shown to be immediately proximate to one another, despite the non-proximity of the associated light emitters 1314-D and 1314-S on their respective monochromatic pixel panels in this example. In this example, a distance 1408 between positions 1406-1 and 1406-2 (similar to distance 1408 in FIG. 14A), will be understood to be small enough for a human viewer, on whose retina 1410 (represented by an eye in the figure) image 1402 is formed, to only perceive the brightness of the green surrogate subpixel 1404-S and not its color. As such, the green surrogate subpixel 1404-S may again compensate effectively for the blue deficient subpixel 1404-D as perceived by the viewer. In this example, it could also be the case that distance 1408 could be even smaller (e.g., a distance of zero), since system of optics 1316 could direct the light emitted by green light emitter 1314-S to the exact same position as the light emitted by blue light emitter 1314-D (or at least an overlapping position or a position closer than illustrated by distance 1408). In other words, the different monochrome subpixels of a single polychrome pixel could be stacked or overlaid directly on top of one another in certain implementations, thereby reducing the need for the angular resolution to be sufficiently high for proper heterochromatic subpixel defect compensation.

FIG. 14C shows how heterochromatic subpixel defect compensation may be performed for a third image display architecture 1400-C in which the positions of the monochrome subpixels within the image may be changing in accordance with a pixel shifting scheme (also referred to as a wobulation scheme). For pixel shifting architectures such as shown by image display architecture 1400-C, light emitters 1314-D and 1314-S may or may not have the same proximity relationship as the corresponding subpixels 1404-D and 1404-S on the display. That is, while separate monochromatic pixel panels 1310-B and 1310-G are shown for this example (similar to FIG. 14B), it will be understood that the pixel shifting principles illustrated by image display architecture 1400-C could similarly be implemented using a singular polychromatic pixel panel 1310-RGB (similar to FIG. 14A).

The difference in image display architecture 1400-C is that the array of monochrome subpixels is implemented by an array of monochrome light emitters emitting light that is shifted, by action of a pixel shift actuator 1412, between at least two subarrays of the array of monochrome subpixels forming the full-color image. As shown, pixel shift actuator 1412 may control an optical plate 1316-P (e.g., a glass plate or a plate constructed of another material with suitable optical properties) to oscillate it between a first position (shown by a solid outline) at a time T1 and a second position (shown by a dashed outline) at a time T2. As the plate oscillates, FIG. 14C shows how light passing through optical plate 1316-P (which may be included with other optics 1316, not explicitly shown) may be directed to different positions 1406-0 and 1406-1 within an image 1402 as it is viewed by a human viewer on whose retina 1410 (represented by an eye in the figure) image 1402 is formed. By alternating between these positions rapidly, the light from green light emitter 1314-S could implement both 1) a first subpixel 1404-S0 at the position 1406-0 that is not particularly proximate to position 1406-2 of blue deficient subpixel 1404-D, and 2) a second subpixel 1404-S1 at the position 1406-1 that is more proximate to position 1406-2 of blue deficient subpixel 1404-D. For example, pixel shifting in this way could allow a surrogate subpixel that is several subpixels away (and perhaps not close enough to meet a resolution target represented by distance 1408) to be moved into position proximate to deficient subpixel 1404-D at position 1406-2 where the viewer will see the surrogate subpixel 1404-S close enough to deficient subpixel 1404-D to effectively compensate for it.

In some examples, more than two positions could be used and the actuator (or a plurality of actuators acting in concert) could shift the pixels to more than two (possibly non-linear) subarrays. While light from monochromatic pixel panel 1310-B is also shown to pass through optical plate 1316-P (meaning that blue deficient subpixel 1404-D would also pixel shift, though this is not explicitly shown), it will be understood that monochromatic pixel panel 1310-B may not undergo the same pixel shifting as monochromatic pixel panel 1310-G in certain implementations (e.g., if monochromatic pixel panel 1310-G were solely dedicated to hosting dedicated, pixel-shifted surrogate subpixels).

Pixel-shifting in accordance with the example of image display architecture 1400-C could include shifting by a half subpixel (or other suitable fraction), a full subpixel, a plurality of subpixels (e.g., a full pixel), or by any other suitable amount. As such, and as similarly described above in relation to FIG. 14B, it will be understood that pixel-shifted light for a surrogate subpixel could be shifted to directly overlay the deficient subpixel (i.e., producing a distance 1408 of 0), or could at least be shifted to overlap or be closer to the deficient subpixel (i.e., producing a smaller distance 1408 than is shown).

While the pixel shifting shown in FIG. 14C is shown to be implemented by a wobulation action of optical plate 1316-P, it will also be understood that other pixel shifting mechanisms (e.g., involving oscillating pixel panels rather than or in addition to oscillating optics, involving reflective optics rather than a diffractive optical plate, involving polarized light or non-mechanical shifting mechanisms, etc.) could additionally or alternatively be used. Additionally, it will be understood that other types of time-varying signals (besides shifting subarrays of subpixels) could be used in certain implementations. For instance, several optical signals (e.g. red, green, blue) could be varied in space and time, so that a given position of the image formed on retina 1410 receives multiple signals, either at the same time or over a short period of time. This type of time multiplexing of various optical signals could be applied, for instance, by a presentation analogous to a laser rastering presentation or the like. In these examples, the intensity of a first optical signal could be deficient (e.g., the signal being generated by a deficient emitter), such that the intensity of a second optical signal could be increased to compensate.

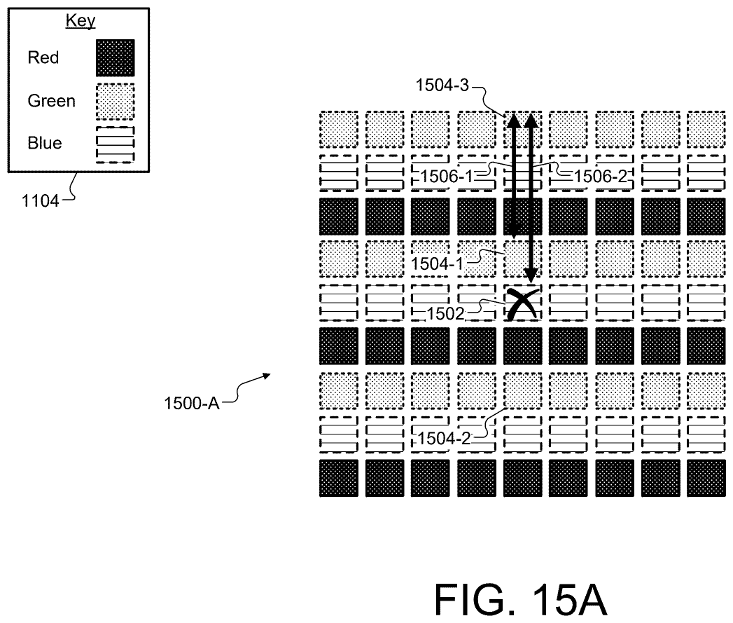

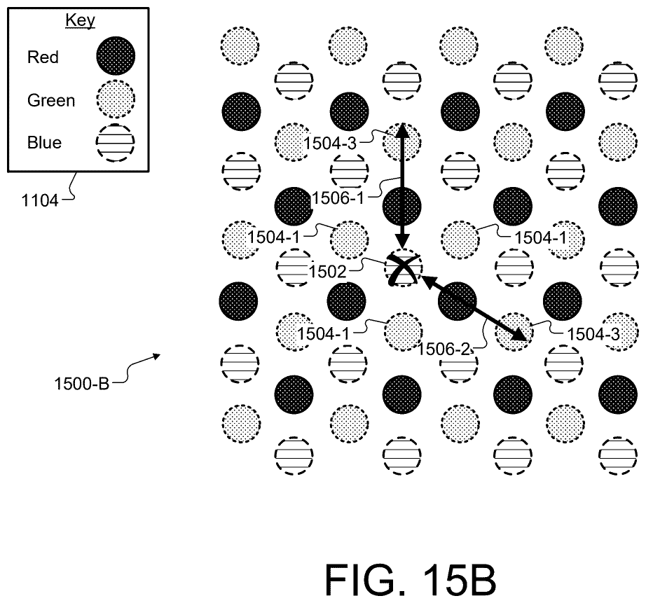

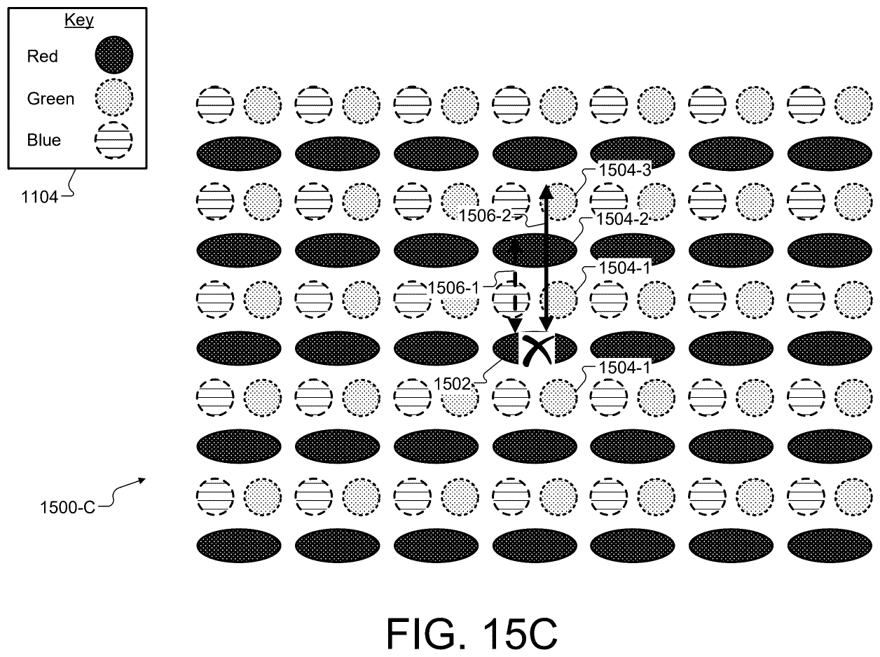

FIGS. 15A-15C show different types of arrangements for arrays of monochrome subpixels that are configured to form full-color images in any of the ways that have been described (e.g., in accordance with any of image display architectures 1400-A through 1400-C or other suitable image display architectures). It will be understood that the subpixel arrangements shown in FIGS. 15A-15C represent the subpixels as presented on the retina of the user (i.e., as perceived by the user) and are thus intended to be agnostic as to what type of architecture produces the viewable arrangement. In other words, for example, while different colors of monochrome subpixels are shown to be arranged in the various illustrated arrays, it could be the case that separate monochromatic pixel panels and/or pixel shifting mechanisms such as described above could help to produce the arrays as illustrated in FIGS. 15A-15C.

In each of the arrays 1500-A, 1500-B, and 1500-C shown respectively in FIGS. 15A-15C, a deficient subpixel 1502 is shown with a black ‘X’ symbol (similar to deficient subpixel 1106 in FIG. 11) and other subpixels are drawn following the same color notation that has been described and that is shown for reference in a key 1104 in each figure. Certain of the subpixels in the vicinity of deficient subpixel 1502 in each array may be used as surrogate subpixels for deficient subpixel 1502. These subpixels are labeled as surrogate subpixels 1504-1, 1504-2, and 1504-3 and will be understood to represent non-limiting examples specific to the illustrated subpixel arrangements shown. It will be understood that other possible surrogate subpixels could also be selected within each of these arrangements, and that suitable surrogate subpixels may be selected given the unique features characterizing other types of arrangements.

In selecting surrogate subpixels to achieve heterochromatic subpixel defect compensation in accordance with principles described herein, it will be understood that different colors selected for surrogate subpixels may have different characteristics and are thus not necessarily interchangeable. For example, certain colors may, for reasons beyond the scope of this disclosure, tend to appear brighter to the human eye than other colors, all other things being equal (i.e., if the different colors of light are emitted using the same amount of energy, etc.). In particular, green light produced by green light emitters in an RGB display may be perceived as particularly bright as a function of the energy used to produce the light.

These principles reflect general trends that may vary from person to person and/or may be affected by other circumstances and factors. However, these general characteristics will be assumed for the following examination of what colors of subpixels may be selected to stand in as surrogates for other colors in various heterochromatic subpixel defect compensation scenarios. With these characteristics in mind, each of FIGS. 15A-15C will now be described in more detail.

In FIG. 15A, array 1500-A is shown to be an array of monochrome subpixels arranged on a rectilinear lattice, similar to the arrangement illustrated and described above in relation to FIG. 11. As was further described in relation to FIG. 11, a first surrogate subpixel 1504-1 (a green subpixel in this example) is shown at a position that overlaps or is adjacent to a position of deficient subpixel 1502 (e.g., a blue subpixel in this example) within the color image. In this case, surrogate subpixel 1504-1 is directly above deficient subpixel 1502 in the array, though it will be understood that surrogate subpixel 1504-1 could be even closer to deficient subpixel 1502 (e.g., overlapping or in the same location) for certain types of image display architectures that use optics to present pixels in different configurations than their associated light emitters (see, e.g., image display architectures 1400-B and 1400-C above).

A second surrogate subpixel 1504-2 is shown at a position that is non-adjacent to the position of deficient subpixel 1502 within the color image. In this case, surrogate subpixel 1504-2 is below deficient subpixel 1502 in the array, though not directly below. Rather, due to the layout of the rows, a row of red subpixels is shown to be skipped to get to the green surrogate subpixel 1504-2. While it may be generally preferable to select a surrogate subpixel that is as proximate as possible to the deficient subpixel, there may be a variety of reasons to select a surrogate subpixel that is a little further away. For instance, surrogate subpixel 1504-2 could be selected if surrogate subpixel 1504-1 was already being used as a surrogate subpixel for another subpixel or if surrogate subpixel 1504-1 was already called upon (based on the image content) to operate at or near capacity (i.e., such that there is not enough extra capacity to cover its own target brightness level and that of deficient subpixel 1502). Additionally, as has been described, both of these surrogate subpixels 1504-1 and 1504-2 could be used in combination in certain cases.

A third surrogate subpixel 1504-3 (also green in this example) is shown at a position that is even further away from deficient subpixel 1502. However, two pixel-shift indicators 1506-1 and 1506-2 illustrate possible ways that this pixel could be shifted to be closer to the position of deficient subpixel 1502 during at least part of the frame time. For example, pixel-shift indicator 1506-1 shows that surrogate subpixel 1504-3 could be shifted into the same position as surrogate subpixel 1504-1, directly proximate to the position of deficient subpixel 1502. Pixel-shift indicator 1506-2 shows an example in which surrogate subpixel 1504-3 could be shifted right on top of the position of deficient subpixel 1502.

In FIG. 15B, array 1500-B is shown to be an array of monochrome subpixels (circular, rather than square, subpixels in this example) that is arranged on a non-rectilinear lattice. In this example, the subpixels are arranged on a triangular lattice, though it will be understood that other geometric lattice types (e.g., hexagonal, etc.) or irregular lattices could be used to similar effect. In FIG. 15B, several green surrogate subpixels 1504-1 are shown at a position immediately adjacent to a position of the blue deficient subpixel 1502. The geometric nature of the triangular lattice and the arrangement of the colors within it is shown to provide even more options for immediately adjacent green pixels around the blue deficient subpixel 1502 than were offered by the rectilinear lattice of array 1500-A. One or several of these subpixels (or other subpixels in the area) may therefore be suitable for use as surrogate subpixels 1504-1 to compensate for deficient subpixel 1502. In like manner as described above in relation to the surrogate subpixel 1504-3 in array 1500-A, array 1500-B is also shown to include multiple non-adjacent green surrogate subpixels 1504-2 that, when pixel shifted in accordance with respective pixel-shift indicators 1506-1 and 1506-2, could be shifted to be much more proximate (e.g., right on top of) the position of deficient subpixel 1502. While not explicitly labeled as surrogate subpixels in FIG. 15B, it will also be understood that one or more non-green surrogate subpixels (e.g., red subpixels just above deficient subpixel 1502 or just below it to either side) could additionally or alternatively be used to compensate for deficient subpixel 1502.

In FIG. 15C, array 1500-C is shown to be an irregular array of monochrome subpixels arranged on a rectilinear lattice but including different sizes and shapes of subpixels. Specifically, as shown, blue and green subpixels are shown to be circular and relatively small in this example, while red subpixels are shown to be larger and oval (e.g., to help compensate for the lack of perceived brightness associated with red light). In other examples, a large red hexagonal subpixel could be flanked by smaller triangular subpixels or green and blue, or any other such arrangement may be used as may serve a particular implementation.

For illustrative variety, and in contrast to other examples above, array 1500-C shows an example of a red deficient subpixel 1502. Proximate green surrogate subpixels 1504-1 directly adjacent to (above and below) subpixel 1502 are shown to represent one potential selection that could be made to compensate for the red light that deficient subpixel 1502 fails to produce. For example, either or both of these green surrogate subpixels 1504-1 could be selected to serve as surrogate subpixels for a given image. Another red subpixel 1504-2 is shown to provide a homochromatic subpixel defect compensation option, particularly if the red subpixel 1504-2 is shifted down in accordance with a pixel-shift indicator 1506-1. A potential green option that is less proximate to deficient subpixel 1502, but that may be shifted to be closer in accordance with pixel-shift indicator 1506-2, is also labeled as another potential surrogate subpixel that could be selected. In several of these examples, deficient subpixel 1502 is shown to be a first size (i.e., a larger size in this example) while the one or more surrogate subpixels are shown to be a second size that is different from the first size (i.e., a smaller size in this example).

For any particular arrangement (e.g., lattice type, subpixel size, subpixel shape, etc.) that may be used for an array of monochrome subpixels, the colors of the subpixels may be strategically arranged to facilitate subpixel defect compensation in various ways. In some implementations, a standard arrangement may be used that makes no special provision for subpixel defect compensation. Rather, as has been described and illustrated, regular subpixels that are also being used to present the image content may be overdriven to perform the compensative role. In other implementations, however, subpixels of certain colors may be more numerous or may even be dedicated to performing the subpixel defect compensation. For example, given that green subpixels have greater apparent brightness than red or blue subpixels, it may be desirable for there to be more green subpixels within an array than red or blue subpixels. In some cases, the extra green subpixels could even be dedicated exclusively for use in subpixel defect compensation (e.g., either homochromatically for green deficient subpixels or heterochromatically for red and/or blue deficient subpixels), such that these dedicated subpixels would only be used when determined to be proximate to a deficient subpixel in need of compensation. Similarly, dedicated subpixels for subpixel defect compensation could be another color outside of the set of primary colors. For example, if the primary colors being used to display content are red, green, and blue (for an RGB display), the dedicated compensation subpixels could be yellow or another suitable color.

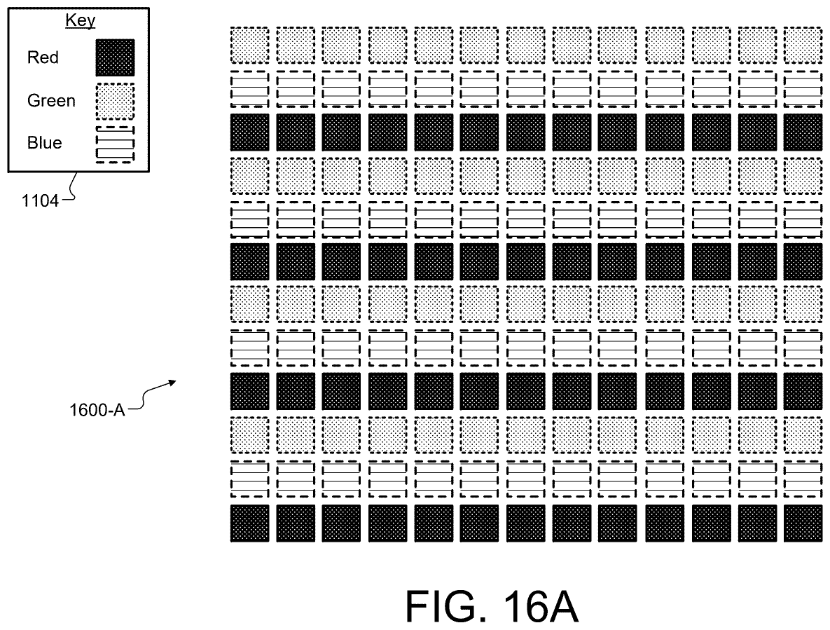

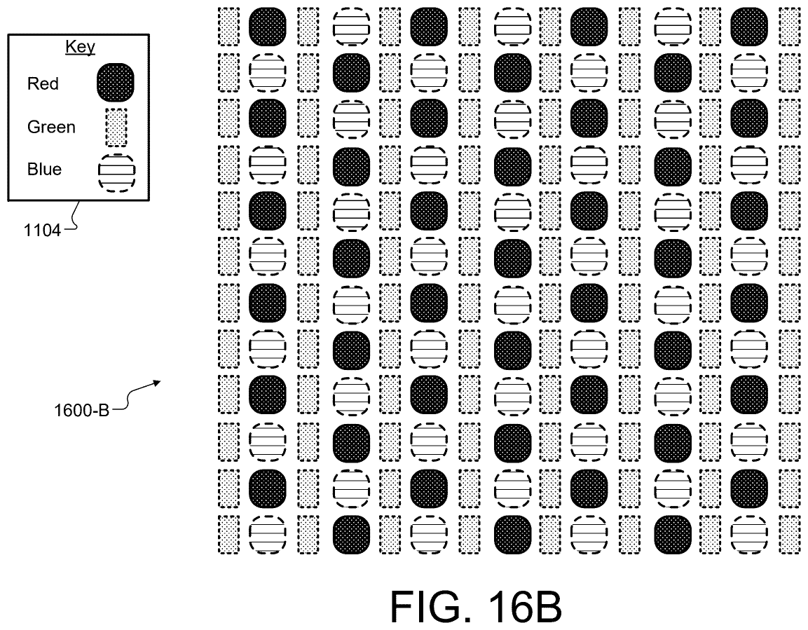

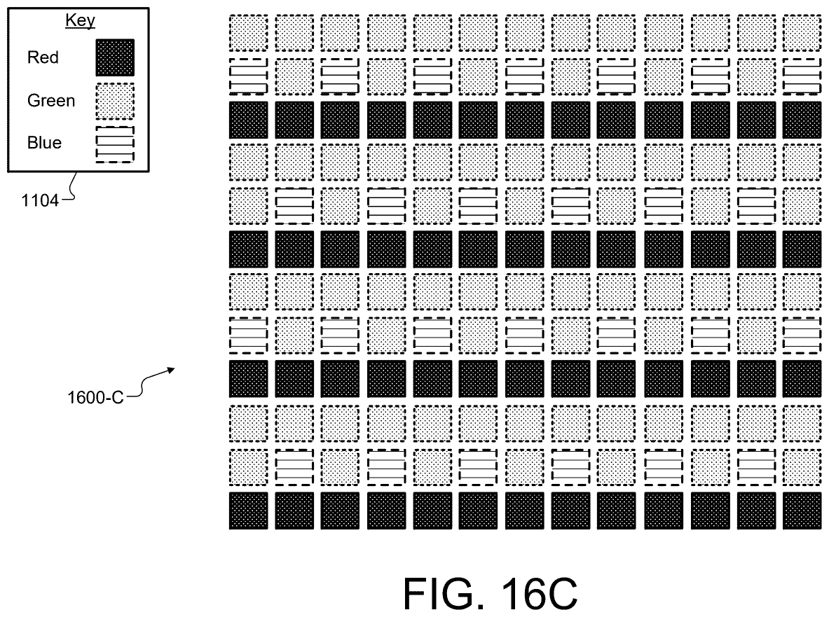

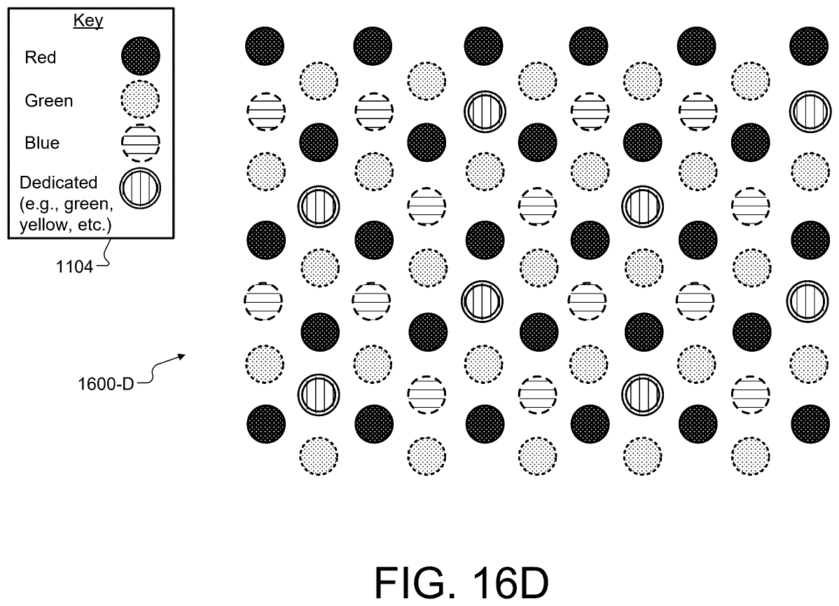

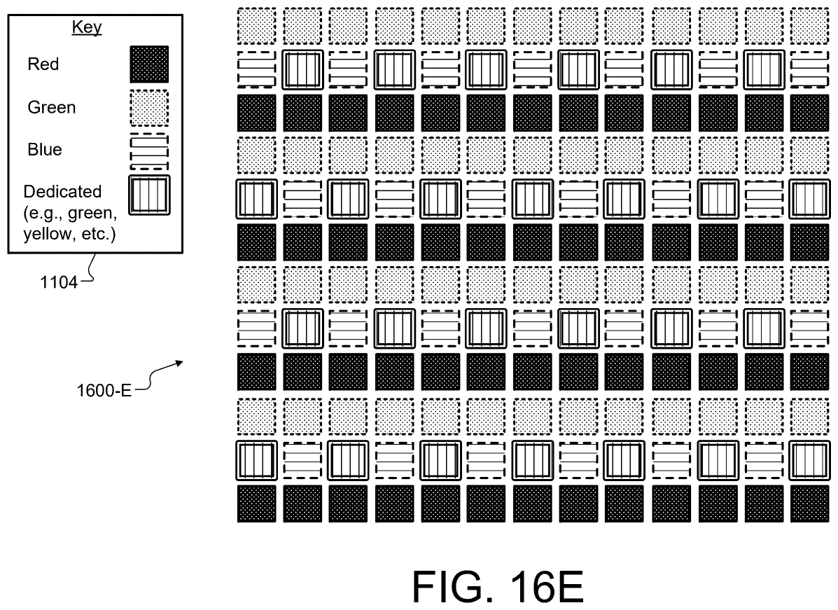

These and other similar aspects will now be illustrated and described in more detail with reference to FIGS. 16A-16E. While each of the arrays 1600-A through 1600-E shown, respectively, in FIGS. 16A-16E are illustrated on specific types of lattices and with particular shapes of subpixels, it will be understood that the same principles may apply to other types of lattices besides those explicitly illustrated.

FIG. 16A shows an illustrative arrangement for an array 1600-A of monochrome subpixels configured to perform heterochromatic subpixel defect compensation using non-dedicated surrogate subpixels in accordance with principles described herein. In other words, as described in relation to FIG. 11, for example, any surrogate subpixel selected within array 1600-A may be a non-dedicated surrogate subpixel. As used herein, non-dedicated surrogate subpixels are those that are assigned to produce, for the presentation of a particular image, their own target brightness level that is independent of any compensation brightness level that they may also take responsibility for in compensating for a nearby deficient subpixel. Non-dedicated surrogate subpixel may therefore be regular subpixels that are being overdriven to produce not only the target brightness level assigned to them but also to at least partially produce a margin brightness level of a nearby deficient subpixel.

For instance, for the array 1600-A of monochrome subpixels implemented as an RGB array, a first set of monochrome subpixels (with lines types and fill patterns as shown in key 1104) may be configured to emit red light, a second set of monochrome subpixels may be configured to emit green light, and a third set of monochrome subpixels may be configured to emit blue light. In such scenarios, a first color of a deficient subpixel may be red or blue (the deficient subpixel being located in the first set or the third set of monochrome subpixels), while a second color of a selected surrogate subpixel may be green (the surrogate subpixel being located in the second set of monochrome subpixels).

FIG. 16B shows another illustrative arrangement for an array 1600-B of subpixels configured to perform heterochromatic subpixel defect compensation using non-dedicated surrogate subpixels in accordance with principles described herein. Similar to array 1600-A, array 1600-B shows an arrangement with red, green, and blue subpixels. However, rather than being equally distributed as in array 1600-A, array 1600-B is shown to include: 1) a first set of monochrome subpixels configured to emit green light; 2) a second set of monochrome subpixels configured to emit red light; and 3) a third set of monochrome subpixels configured to emit blue light; wherein the second set and the third set both include fewer monochrome subpixels than the first set. More particularly, as shown in array 1600-B, rows including all green subpixels are alternated in this example with rows that include both red and blue subpixels, such that there are two green subpixels for every blue subpixel (while there are equal numbers of red and blue subpixels). This color imbalance may be advantageous given the characteristics of how different colors may be perceived, as described above.

Moreover, it is noted that research indicates that the human visual system may have a greater capacity for perceiving fine pixel resolution with green light (as compared to other colors). As such, even setting subpixel defect compensation objectives aside, array 1600-B may have the advantage of being perceived as having a higher resolution than other arrangements that do not emphasize green subpixels to the same extent (e.g., such as array 1600-A). This arrangement may therefore be advantageous both for allowing the viewer to perceive higher pixel resolution, as well as for having plenty of green subpixels ready to act as surrogate for any nearby subpixel of any color that might be deficient.

While array 1600-B is described herein as using non-dedicated surrogate subpixels (so that all the green subpixels can be used in ordinary operation to provide the higher perceived resolution), it will be understood that an arrangement like this could also incorporate green subpixels that are dedicated surrogate subpixels. For example, of every grouping of one red, one blue, and two green subpixels, one of those two green subpixels could be a dedicated surrogate subpixel or could be a dedicated surrogate subpixel of another color (e.g., yellow). As shown, the subpixels in FIG. 16B are different shapes and sizes for the various colors. More particularly, the green subpixels are smaller, narrower, and differently shaped than the red and blue subpixels, as illustrated. Accordingly, certain implementations may feature a density of green subpixels that is higher (e.g., 1.5 times higher, 2 times higher, etc.) than a density of red subpixels and/or a density of blue subpixels. In these implementations, some of the green subpixels may act as surrogate subpixels.

FIG. 16C shows an illustrative arrangement for an array 1600-C of monochrome subpixels configured to perform heterochromatic subpixel defect compensation using either non-dedicated or dedicated surrogate subpixels in accordance with principles described herein. Similar to arrays 1600-A and 1600-B, array 1600-C shows an arrangement with red, green, and blue subpixels. However, rather than being equally distributed as in array 1600-A, or having two colors that have the same distributions as in array 1600-B, array 1600-C includes different number of subpixels for each of the three primary colors. Specifically, as shown, array 1600-C includes: 1) a first set of monochrome subpixels configured to emit green light; 2) a second set of monochrome subpixels configured to emit red light, the second set including fewer monochrome subpixels than the first set; and 3) a third set of monochrome subpixels configured to emit blue light, the third set including fewer monochrome subpixels than the second set. In other words, as shown, green subpixels have replaced every other blue subpixel of array 1600-A, such that there are more green subpixels than any other color, and there are more red subpixels than blue subpixels (of which there are the lowest quantity). This color imbalance may be suitable given the characteristics of the different colors and how they are perceived, as described above. For example, it may be advantageous to have many green pixels for use as nearby surrogate subpixels to any subpixel (red, green, or blue) that may turn out to be deficient. It may also be advantageous to have plenty of red pixels to ensure that the red light they produce will be bright enough. Then the blue subpixels may be the least important since human retinal resolution tends to be poor for blue (making a sparser blue array more acceptable than such sparse arrays of other colors).

Whereas a balanced arrangement such as array 1600-A may be configured such that any color could be used as a surrogate subpixel (though green may still be preferable where possible), an arrangement such as 1600-C may be configured such that all surrogate subpixels are the same color (e.g., green in this example, since there are so many more green subpixels than the other colors). In certain examples, a subset of the subpixels of this color could be dedicated surrogate subpixels, such that these subpixels would not be assigned to produce, for the presentation of any image, any target brightness level independent of a compensation brightness level associated with a deficient subpixel. In other words, if dedicated surrogate subpixels are used in a certain implementation, the dedicated surrogates would not be used in the presentation of an image except to facilitate subpixel defect compensation in the ways described herein. If a dedicated surrogate subpixel is not proximate to any deficient subpixel, it would simply remain off in these examples.

Array 1600-C shows one way that dedicated surrogate subpixels could be integrated into an array. For instance, the full rows of green subpixels in array 1600-C could be used as regular (non-dedicated) green subpixels for presenting images, while the green subpixels interleaved with the blue subpixels on the other rows in array 1600-C could be dedicated surrogate subpixels that are only used for subpixel defect compensation operations. In this case, green deficient subpixel would be compensated for homochromatically by the dedicated green surrogate subpixels, while red and blue deficient subpixels would be compensated for heterochromatically by the dedicated green surrogate subpixels.

While array 1600-C shows an example where the color emitted by the set of dedicated surrogate subpixels is a primary color included within a set of primary colors associated with the image (i.e., green), it will be understood that this need not be the case. In other examples, the color emitted by the set of dedicated surrogate subpixels could be a compensation color excluded from a set of primary colors associated with the image. For instance, if the primary colors are red, green, and blue, the compensation color could be yellow or white or another suitable color. To illustrate, FIGS. 16D and 16E show additional illustrative arrangements for respective arrays of subpixels configured to perform heterochromatic subpixel defect compensation using dedicated subpixels that, as illustrated in the respective keys 1104, could be green or another color such as yellow. It will be understood that other subpixels in these arrangements that are not dedicated surrogate subpixels (e.g., regular green subpixels) could also be used as in the surrogate role (i.e., non-dedicated surrogate subpixels) to help compensate for deficient subpixels (e.g., alone or in connection with one or more other subpixels such as one of the dedicated surrogate subpixels).

In FIG. 16D, an array 1600-D is shown to be arranged in a triangular lattice with circular pixels. Array 1600-D is shown to include a distribution with equal numbers of red and green subpixels with fewer blue subpixels (for reasons that have been described). Interspersed on the rows that otherwise include the blue subpixels, array 1600-D includes one dedicated surrogate subpixel (e.g., an extra green subpixel, a yellow subpixel, etc.) for every 8 regular subpixels. More particularly, for every group of three green subpixels, three red subpixels and two blue subpixels, array 1600-D is shown to include one dedicated surrogate subpixel that, in certain implementations, could be proximate enough to serve as a surrogate for any of the eight should it be deficient.

FIG. 16E then shows another illustrative arrangement for an array 1600-E of square monochrome subpixels on a rectilinear lattice. Here again, array 1600-E shows that a set of dedicated surrogate subpixels (i.e., the subpixels interleaved with the blue subpixels on the rows that are otherwise blue) could be a primary color such as green, or a non-primary color such as yellow (as shown in the key 1104). These dedicated surrogate subpixels may again be dedicated in the sense that they would not be powered on unless they are being used for heterochromatic subpixel defect compensation purposes.

In the event that yellow surrogate subpixels are employed, arrays such as array 1600-D or 1600-E may thus be implemented as red-green-blue-yellow (RGBY) arrays that includes a first set of monochrome subpixels configured to emit red light, a second set of monochrome subpixels configured to emit green light, a third set of monochrome subpixels configured to emit blue light, and a fourth set of monochrome subpixels configured to emit yellow light. A first color of a deficient subpixel could therefore be red, green, or blue (the deficient subpixel being located in the first set, the second set, or the third set of monochrome subpixels), while a second color of the surrogate subpixel would be yellow in this example (the surrogate subpixel being located in the fourth set of monochrome subpixels).

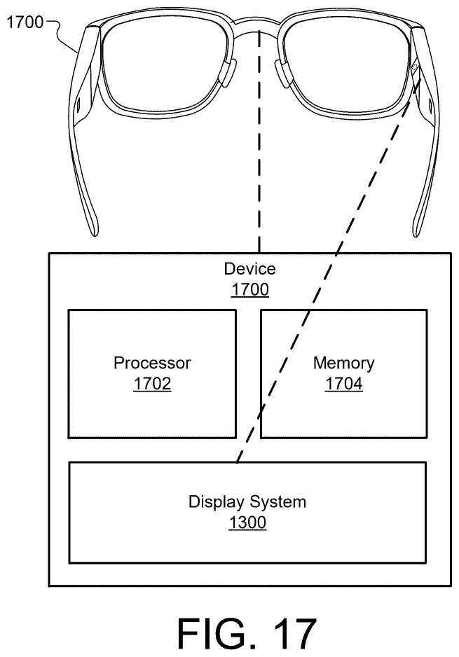

A display system in accordance with principles described herein may be used in a variety of different types of devices to achieve various benefits and advantages as have been described. To illustrate, FIG. 17 shows an illustrative device 1700 including an implementation of display system 1300 configured to perform heterochromatic and/or homochromatic subpixel defect compensation in accordance with principles described herein.

In this example, device 1700 is illustrated as being implemented as an extended reality presentation device. More particularly, the display system 1300 is shown to be integrated into a pair of augmented reality glasses for this implementation. In other words, for this example, the color image (e.g., full-color image 1320) would be presented by the head-mounted extended reality device of device 1700 (e.g., by forming the image directly on each retina of a person wearing the glasses). MicroLED panels such as may be implemented by display system 1300 may be ideal for this type of a device due to their extremely small size, potent brightness, and power efficiency. However, it will be understood that display systems such as display system 1300 may not be limited to extended reality devices such as device 1700. To the contrary, a display system 1300 could be used in devices such as a smartwatch, a mobile device (e.g., a phone, a tablet, etc.), a laptop display, a television, a display panel of an appliance or vehicle, and various other types of devices as may serve a particular implementation.

In virtually any of these example devices, the display system implementation may interoperate with other electronic and/or computing resources. As such, device 1700 shows a processor 1702 and a memory 1704 implemented within device 1700 with display system 1300. It will be understood that processor 1702 and memory 1704 may be implemented as any suitable types of processor and storage resources. Additionally, various other elements not shown may further be integrated into a device such as device 1700. For example, audio equipment for sound detection and playback, camera devices for capturing images, sensors of various types, input/output interfaces, and various other resources may further be included within the device as may serve a particular implementation.

The following clauses describe implementations of configurable subpixel defect compensation in accordance with principles described herein. It will be understood that the following clauses describe further illustrative implementations and are not intended to be limiting. The features described in these clauses are not mutually exclusive and may be combined with one another in any manner that is not contradictory. For example, a feature described in one clause may be combined with features described in any other clause, and any combination of features described herein is contemplated, even if that specific combination is not explicitly recited in a single clause.
Clause 1. A system comprising: a panel configured to display an image using a plurality of subpixels; and a controller including: a module configured to identify a defect of a first subpixel configured to emit light of a first color, the defect being identified based on a value for the first subpixel in the image; first circuitry configured to at least partially compensate for the defect using a second subpixel and a third subpixel configured to emit light of the first color; and second circuitry configured to at least partially compensate for the defect using a fourth subpixel configured to emit light of a second color different from the first color; wherein at least one of the first circuitry or the second circuitry is enabled based on a criterion.
Clause 2. The system of clause 1, wherein: the criterion is a parameter set to enable operation of the first circuitry; and the first circuitry is configured to at least partially compensate for the defect by: determining a request value based on a portion of the defect that is not yet compensated; determining an amount of compensation based on: the request value, a headroom of the second subpixel for the image, and a headroom of the third subpixel for the image; and increasing a value for the second subpixel in the image and a value for the third subpixel in the image by the amount of compensation.
Clause 3. The system of clause 1, wherein: the criterion is a parameter set to enable operation of the second circuitry; and in response to a determination that a value for the fourth subpixel in the image exceeds a threshold, the second circuitry is configured to at least partially compensate for the defect by: determining a request value based on a portion of the defect that is not yet compensated; determining an amount of compensation based on: the request value, and a headroom of the fourth subpixel for the image; and increasing the value for the fourth subpixel by the amount of compensation.
Clause 4. The system of clause 3, wherein the determining of the amount of compensation includes limiting the amount of compensation such that the amount of compensation does not exceed at least one of a predetermined limit or a predetermined portion of the value for the first subpixel in the image.
Clause 5. The system of clause 1, further comprising third circuitry configured to at least partially compensate for the defect using the second subpixel and the third subpixel, wherein: the third circuitry is enabled based on a parameter; and the third circuitry is configured to at least partially compensate for the defect by: determining a first amount of compensation based on a portion of the defect that is not yet compensated and a headroom of the second subpixel for the image; determining a second amount of compensation based on the portion of the defect that is not yet compensated and a headroom of the third subpixel for the image; and increasing a value for the second subpixel by the first amount of compensation and increasing a value for the third subpixel by the second amount of compensation.
Clause 6. The system of clause 1, further comprising third circuitry configured to at least partially compensate for the defect using the second subpixel and the third subpixel, wherein the criterion is a parameter set to: enable operation of the first circuitry to compensate for a first portion of the defect; enable operation of the second circuitry to compensate for a second portion of the defect that remains after the first portion is compensated for by the first circuitry; and enable operation of the third circuitry to compensate for a third portion of the defect that remains after the second portion is compensated for by the second circuitry.
Clause 7. The system of clause 1, wherein: the second subpixel and the third subpixel are located on a same scan line of the panel as the first subpixel; the second subpixel is located on a first side of the first subpixel; and the third subpixel is located on a second side of the first subpixel, the second side being opposite the first side.
Clause 8. The system of clause 1, wherein: the first circuitry is configured to at least partially compensate for the defect using a set of subpixels configured to emit light of the first color, the set of subpixels including the second subpixel, the third subpixel, and a fifth subpixel; the first subpixel, the second subpixel, and the third subpixel are located on a first scan line of the panel; and the fifth subpixel is located on a second scan line of the panel, the second scan line being subsequent to the first scan line.
Clause 9. The system of clause 8, wherein the first circuitry is configured to: compensate for a first subportion of a portion of the defect that is not yet compensated using a first subset of the set of subpixels, the first subset including the second subpixel and the third subpixel; and in response to determining that a second subportion of the portion remains after compensating for the first subportion, compensate for the second subportion of the portion of the defect using a second subset of the set of subpixels, the second subset including the fifth subpixel.
Clause 10. The system of clause 1, wherein the module is configured to identify the defect by determining a difference between: the value for the first subpixel in the image, and a capability of the first subpixel, the capability being determined during a calibration process and stored in a memory communicatively coupled to the controller.
Clause 11. The system of clause 10, wherein: the memory includes a map storing performance data for each of the plurality of subpixels, the performance data being determined as part of the calibration process and being configured to facilitate a uniform appearance of the panel; and the capability is determined based on performance data for the first subpixel that is stored in the map.
Clause 12. The system of clause 1, wherein at least one of the first circuitry or the second circuitry is configured to: determine a portion of the defect that is not yet compensated; and determine a request value by scaling the portion of the defect by a strength parameter, the strength parameter being based on a number of subpixels used to compensate for the portion of the defect.
Clause 13. The system of clause 12, wherein: the criterion is a parameter set to enable operation of the second circuitry; the second circuitry determines the portion of the defect and the request value; and the strength parameter for the second circuitry is further based on a ratio of luminance efficiency between the first color and the second color.
Clause 14. The system of clause 1, wherein: the plurality of subpixels includes a plurality of micro light-emitting diodes (microLEDs); and the plurality of subpixels are arranged on the panel in a non-rectilinear lattice.
Clause 15. A method comprising: identifying a defect of a deficient subpixel configured to emit light of a first color, the defect being identified based on a value for the deficient subpixel in an image and including a portion of the defect that is not yet compensated; determining a request value, a headroom of a first same-color surrogate subpixel for the image, and a headroom of a second same-color surrogate subpixel for the image, the first same-color surrogate subpixel and the second same-color surrogate subpixel being configured to emit light of the first color and the request value being based on the portion of the defect; determining an amount of compensation based on the request value, the headroom of the first same-color surrogate subpixel, and the headroom of the second same-color surrogate subpixel; and increasing a value for the first same-color surrogate subpixel in the image and a value for the second same-color surrogate subpixel in the image by the amount of compensation.
Clause 16. The method of clause 15, further comprising: determining a second request value based on a first subportion of the defect that is not yet compensated after the increasing of the value for the first same-color surrogate subpixel and the value for the second same-color surrogate subpixel; determining that a value for a different-color surrogate subpixel in the image exceeds a threshold, the different-color surrogate subpixel being configured to emit light of a second color different from the first color; determining, based on the determining that the value for the different-color surrogate subpixel exceeds the threshold, a headroom of the different-color surrogate subpixel for the image; determining a second amount of compensation based on the second request value and the headroom of the different-color surrogate subpixel; and increasing the value for the different-color surrogate subpixel by the second amount of compensation.
Clause 17. The method of clause 16, further comprising: determining a second subportion of the defect that is not yet compensated after the increasing of the value for the first same-color surrogate subpixel and the value for the second same-color surrogate subpixel and the increasing of the value for the different-color surrogate subpixel; determining a third amount of compensation based on the second subportion of the defect and a remaining headroom of the first same-color surrogate subpixel for the image; determining a fourth amount of compensation based on the second subportion of the defect and a remaining headroom of the second same-color surrogate subpixel for the image; and increasing the value for the first same-color surrogate subpixel by the third amount of compensation and increasing the value for the second same-color surrogate subpixel by the fourth amount of compensation.
Clause 18. A method comprising: determining a defect of a deficient subpixel configured to emit light of a first color, the defect being determined based on a value for the deficient subpixel in an image and including a portion of the defect that is not yet compensated; determining that a value for a different-color surrogate subpixel in the image exceeds a threshold, the different-color surrogate subpixel being configured to emit light of a second color different from the first color; determining, in response to the determining that the value for the different-color surrogate subpixel exceeds the threshold, a request value and a headroom of the different-color surrogate subpixel for the image, the request value being based on the portion of the defect; determining an amount of compensation based on the request value and the headroom of the different-color surrogate subpixel; and increasing the value for the different-color surrogate subpixel by the amount of compensation.
Clause 19. The method of clause 18, further comprising: determining a first subportion of the defect that is not yet compensated after the increasing of the value for the different-color surrogate subpixel; determining a second request value, a headroom of a first same-color surrogate subpixel for the image, and a headroom of a second same-color surrogate subpixel for the image, the first same-color surrogate subpixel and the second same-color surrogate subpixel being configured to emit light of the first color and the second request value being based on the first subportion of the defect; determining a second amount of compensation based on the second request value, the headroom of the first same-color surrogate subpixel, and the headroom of the second same-color surrogate subpixel; and increasing a value for the first same-color surrogate subpixel in the image and a value for the second same-color surrogate subpixel in the image by the second amount of compensation.
Clause 20. The method of clause 19, further comprising: determining a second subportion of the defect that is not yet compensated after the increasing of the value for the first same-color surrogate subpixel and the value for the second same-color surrogate subpixel and the increasing of the value for the different-color surrogate subpixel; determining a third amount of compensation based on the second subportion of the defect and a remaining headroom of the first same-color surrogate subpixel for the image; determining a fourth amount of compensation based on the second subportion of the defect and a remaining headroom of the second same-color surrogate subpixel for the image; and increasing the value for the first same-color surrogate subpixel by the third amount of compensation and increasing the value for the second same-color surrogate subpixel by the fourth amount of compensation.
Clause 21. A method comprising: identifying a first subpixel within an array of subpixels forming a color image, the first subpixel being identified based on a brightness threshold and being configured to emit light of a first color at a first position within the color image; selecting a second subpixel within the array of subpixels, the second subpixel being selected based on the first position and the brightness threshold and being configured to emit light of a second color different from the first color at a second position within a proximity threshold of the first position within the color image; and using the second subpixel to compensate for the first subpixel for a presentation of the color image.
Clause 22. The method of clause 21, wherein: the array of subpixels is implemented by an array of monochrome light emitters of different colors disposed together on a polychromatic pixel panel; and the color image is produced by the polychromatic pixel panel and a system of optics through which the polychromatic pixel panel emits light.
Clause 23. The method of clause 21, wherein: the array of subpixels is implemented by at least: a first array of monochrome light emitters of the first color disposed on a first monochromatic pixel panel, and a second array of monochrome light emitters of the second color disposed on a second monochromatic pixel panel; and the color image is produced by overlaying, using a system of optics, first light emitted by the first monochromatic pixel panel and second light emitted by the second monochromatic pixel panel.
Clause 24. The method of clause 21, wherein the array of subpixels is implemented by an array of monochrome light emitters emitting light that is shifted, by action of a pixel shift actuator, between at least two subarrays of the array of subpixels forming the color image.
Clause 25. The method of clause 21, wherein the second position of the second subpixel overlaps or is adjacent to the first position of the first subpixel within the color image.
Clause 26. The method of clause 21, wherein the second position of the second subpixel is non-adjacent to the first position of the first subpixel within the color image.
Clause 27. The method of clause 21, further comprising selecting, based on the first position, a third subpixel within the array of subpixels, the third subpixel meeting the brightness threshold and being configured to emit light at a third position within the proximity threshold of the first position; wherein the second subpixel and the third subpixel are used together to compensate for the first subpixel for the presentation of the color image.
Clause 28. The method of clause 27, wherein the third subpixel is configured to emit light of a third color different from the second color.
Clause 29. The method of clause 21, wherein: the first subpixel is a non-functional subpixel assigned to produce a first target brightness for the presentation of the color image; the second subpixel is assigned to produce a second target brightness for the presentation of the color image; and the using of the second subpixel to compensate for the first subpixel includes the second subpixel producing a brightness equivalent to a sum of the first target brightness and the second target brightness.
Clause 30. The method of clause 21, wherein: the first subpixel is an underperforming subpixel assigned to produce a first target brightness for the presentation of the color image, the first target brightness exceeding a maximum brightness achievable by the underperforming subpixel by a margin brightness; the second subpixel is assigned to produce a second target brightness for the presentation of the color image; and the using of the second subpixel to compensate for the first subpixel includes the second subpixel producing a brightness equivalent to a sum of the margin brightness and the second target brightness.
Clause 31. The method of clause 21, wherein the array of subpixels is arranged on a rectilinear lattice.
Clause 32. The method of clause 21, wherein the array of subpixels is arranged on a non-rectilinear lattice.
Clause 33. The method of clause 21, wherein the first subpixel is a first size and the second subpixel is a second size different from the first size.
Clause 34. The method of clause 21, wherein: the array of subpixels is implemented as a red-green-blue (RGB) array that includes a first set of monochrome subpixels configured to emit red light, a second set of monochrome subpixels configured to emit green light, and a third set of monochrome subpixels configured to emit blue light; the first color is red or blue, the first subpixel being located in the first set of monochrome subpixels or the third set of monochrome subpixels; and the second color is green, the second subpixel being located in the second set of monochrome subpixels.
Clause 35. The method of clause 21, wherein: the array of subpixels is implemented as a red-green-blue-yellow (RGBY) array that includes a first set of monochrome subpixels configured to emit red light, a second set of monochrome subpixels configured to emit green light, a third set of monochrome subpixels configured to emit blue light, and a fourth set of monochrome subpixels configured to emit yellow light; the first color is red, green, or blue, the first subpixel being located in the first set of monochrome subpixels, the second set of monochrome subpixels, or the third set of monochrome subpixels; and the second color is yellow, the second subpixel being located in the fourth set of monochrome subpixels.
Clause 36. The method of clause 21, wherein the array of subpixels includes: a first set of monochrome subpixels configured to emit green light; a second set of monochrome subpixels configured to emit red light, the second set of monochrome subpixels including fewer monochrome subpixels than the first set of monochrome subpixels; and a third set of monochrome subpixels configured to emit blue light, the third set of monochrome subpixels including fewer monochrome subpixels than the second set of monochrome subpixels.
Clause 37. The method of clause 21, wherein the second subpixel is a non-dedicated surrogate subpixel that is assigned to produce, for the presentation of the color image, a target brightness that is independent of a compensation brightness associated with the first subpixel.
Clause 38. The method of clause 21, wherein the second subpixel is a dedicated surrogate subpixel that is not assigned to produce, for the presentation of the color image, any target brightness independent of a compensation brightness associated with the first subpixel.
Clause 39. The method of clause 38, wherein: the dedicated surrogate subpixel is included in a set of dedicated surrogate subpixels within the array of monochrome subpixels; and each subpixel in the set of dedicated surrogate subpixels is configured to emit light of the second color.
Clause 40. The method of clause 39, wherein the second color emitted by the set of dedicated surrogate subpixels is a primary color included within a set of primary colors associated with the color image.
Clause 41. The method of clause 39, wherein the second color emitted by the set of dedicated surrogate subpixels is a compensation color excluded from a set of primary colors associated with the color image.
Clause 42. The method of clause 21, wherein the array of subpixels is implemented by an array of micro light emitting diodes (microLEDs).
Clause 43. The method of clause 21, wherein the color image is formed on a retina of a user by a head-mounted extended reality device.
Clause 44. The method of clause 21, wherein the array of subpixels includes a smaller number of subpixels configured to emit light of the first color than of subpixels configured to emit light of the second color.
Clause 45. The method of clause 21, wherein the image has a resolution of at least 40 pixels per degree.
Clause 46. A non-transitory computer-readable medium storing instructions that, when executed, cause a processor of a computing device to perform a process comprising: identifying a first subpixel within an array of subpixels forming a color image, the first subpixel being identified based on a brightness threshold and being configured to emit light of a first color at a first position within the color image; selecting a second subpixel within the array of subpixels, the second subpixel being selected based on the first position and the brightness threshold and being configured to emit light of a second color different from the first color at a second position within a proximity threshold of the first position within the color image; and using the second subpixel to compensate for the first subpixel for a presentation of the color image.
Clause 47. The non-transitory computer-readable medium of clause 46, wherein: the array of subpixels is implemented by an array of monochrome light emitters of different colors disposed together on a polychromatic pixel panel; and the color image is produced by the polychromatic pixel panel and a system of optics through which the polychromatic pixel panel emits light.
Clause 48. The non-transitory computer-readable medium of clause 46, wherein: the array of subpixels is implemented by at least: a first array of monochrome light emitters of the first color disposed on a first monochromatic pixel panel, and a second array of monochrome light emitters of the second color disposed on a second monochromatic pixel panel; and the color image is produced by overlaying, using a system of optics, first light emitted by the first monochromatic pixel panel and second light emitted by the second monochromatic pixel panel.
Clause 49. The non-transitory computer-readable medium of clause 46, wherein the array of subpixels is implemented by an array of monochrome light emitters emitting light that is shifted, by action of a pixel shift actuator, between at least two subarrays of the array of subpixels forming the color image.
Clause 50. The non-transitory computer-readable medium of clause 46, wherein: the first subpixel is a non-functional subpixel assigned to produce a first target brightness for the presentation of the color image; the second subpixel is assigned to produce a second target brightness for the presentation of the color image; and the using of the second subpixel to compensate for the first subpixel includes the second subpixel producing a brightness equivalent to a sum of the first target brightness and the second target brightness.
Clause 51. The non-transitory computer-readable medium of clause 46, wherein: the first subpixel is an underperforming subpixel assigned to produce a first target brightness for the presentation of the color image, the first target brightness exceeding a maximum brightness achievable by the underperforming subpixel by a margin brightness; the second subpixel is assigned to produce a second target brightness for the presentation of the color image; and the using of the second subpixel to compensate for the first subpixel includes the second subpixel producing a brightness equivalent to a sum of the margin brightness and the second target brightness.
Clause 52. A display system comprising: an array of subpixels configured to form a color image, the array including: a first subpixel that fails to meet a threshold brightness level and is configured to emit light of a first color at a first position within the color image, and a second subpixel that meets the threshold brightness level and is configured to emit light of a second color different from the first color at a second position within a proximity threshold of the first position within the color image; and a display controller configured to cause the array of subpixels to present the color image using the second subpixel to compensate for the first subpixel.
Clause 53. The display system of clause 52, wherein: the array of subpixels is implemented by an array of monochrome light emitters of different colors disposed together on a polychromatic pixel panel; and the color image is produced by the polychromatic pixel panel and a system of optics through which the polychromatic pixel panel emits light.
Clause 54. The display system of clause 52, wherein: the array of subpixels is implemented by at least: a first array of monochrome light emitters of the first color disposed on a first monochromatic pixel panel, and a second array of monochrome light emitters of the second color disposed on a second monochromatic pixel panel; and the color image is produced by overlaying, using a system of optics, first light emitted by the first monochromatic pixel panel onto second light emitted by the second monochromatic pixel panel.
Clause 55. The display system of clause 52, wherein the array of subpixels is implemented by an array of monochrome light emitters emitting light that is shifted, by action of a pixel shift actuator, between at least two subarrays of the array of subpixels forming the color image.
Clause 56. The display system of clause 52, wherein the array of subpixels is arranged on a rectilinear lattice.
Clause 57. The display system of clause 52, wherein the array of subpixels is arranged on a non-rectilinear lattice.
Clause 58. The display system of clause 52, wherein the second subpixel is a non-dedicated surrogate subpixel that is assigned to produce, for the presentation of the color image, a target brightness level that is independent of a compensation brightness level associated with the first subpixel.
Clause 59. The display system of clause 52, wherein the second subpixel is a dedicated surrogate subpixel that is not assigned to produce, for the presentation of the color image, any target brightness level independent of a compensation brightness level associated with the first subpixel.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A number of implementations have been described. It will be understood that various modifications may be made without departing from the spirit and scope of the description and claims. The described implementations are examples, and that other systems can be used to perform similar functions. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the implementations of the disclosure.

The terminology used herein is for the purpose of describing particular implementations only and is not intended to be limiting of the implementations. As used herein, the singular forms “a,” “an,” and “the” are intended to include the plural forms as well, unless the context clearly indicates otherwise. It will be further understood that the term “comprising,” when used in this specification, specifies the presence of the stated features, steps, operations, elements, and/or components, but does not preclude the presence or addition of one or more other features, steps, operations, elements, components, and/or groups thereof.

It will be understood that when an element is referred to as being “coupled” or “connected” to another element, it can be directly coupled or connected to the other element, or intervening elements may also be present. In contrast, when an element is referred to as being “directly coupled” or “directly connected” to another element, there are no intervening elements present.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (e.g., rotated 90 degrees or at other orientations) and the spatially relative descriptors used herein may be interpreted accordingly.

Further to the descriptions above, a user may be provided with controls allowing the user to make an election as to both if and when systems, programs, or features described herein may enable collection of user information (e.g., information about a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized, such as to a city, zip code, or state level, so that a particular location of a user cannot be determined. Thus, the user may have control over what information is collected about the user, how that information is used, and what information is provided to the user.

While certain features of the described implementations have been illustrated as described herein, many modifications, substitutions, changes, and equivalents may occur to those skilled in the art. It is therefore to be understood that the appended claims are intended to cover such modifications and changes as fall within the scope of the implementations. It will be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described. As such, the scope of the present disclosure is not limited to the particular combinations hereafter claimed, but instead extends to encompass any combination of features or example implementations described herein irrespective of whether or not that particular combination has been specifically enumerated in the accompanying claims at this time.

What is claimed is:

1. A system comprising:
a panel configured to display an image using a plurality of subpixels; and
a controller including:
a module configured to identify a defect of a first subpixel configured to emit light of a first color, the defect being identified based on a value for the first subpixel in the image;
first circuitry configured to at least partially compensate for the defect using a second subpixel and a third subpixel configured to emit light of the first color; and
second circuitry configured to at least partially compensate for the defect using a fourth subpixel configured to emit light of a second color different from the first color;
wherein at least one of the first circuitry or the second circuitry is enabled based on a criterion.

2. The system of claim 1, wherein:
the criterion is a parameter set to enable operation of the first circuitry; and
the first circuitry is configured to at least partially compensate for the defect by:
determining a request value based on a portion of the defect that is not yet compensated;
determining an amount of compensation based on:
the request value,
a headroom of the second subpixel for the image, and
a headroom of the third subpixel for the image; and
increasing a value for the second subpixel in the image and a value for the third subpixel in the image by the amount of compensation.

3. The system of claim 1, wherein:
the criterion is a parameter set to enable operation of the second circuitry; and
in response to a determination that a value for the fourth subpixel in the image exceeds a threshold, the second circuitry is configured to at least partially compensate for the defect by:
determining a request value based on a portion of the defect that is not yet compensated;
determining an amount of compensation based on:
the request value, and
a headroom of the fourth subpixel for the image; and
increasing the value for the fourth subpixel by the amount of compensation.

4. The system of claim 3, wherein the determining of the amount of compensation includes limiting the amount of compensation such that the amount of compensation does not exceed at least one of a predetermined limit or a predetermined portion of the value for the first subpixel in the image.

5. The system of claim 1, further comprising third circuitry configured to at least partially compensate for the defect using the second subpixel and the third subpixel, wherein:
the third circuitry is enabled based on a parameter; and
the third circuitry is configured to at least partially compensate for the defect by:
determining a first amount of compensation based on a portion of the defect that is not yet compensated and a headroom of the second subpixel for the image;
determining a second amount of compensation based on the portion of the defect that is not yet compensated and a headroom of the third subpixel for the image; and
increasing a value for the second subpixel by the first amount of compensation and increasing a value for the third subpixel by the second amount of compensation.

6. The system of claim 1, further comprising third circuitry configured to at least partially compensate for the defect using the second subpixel and the third subpixel, wherein the criterion is a parameter set to:
enable operation of the first circuitry to compensate for a first portion of the defect;
enable operation of the second circuitry to compensate for a second portion of the defect that remains after the first portion is compensated for by the first circuitry; and
enable operation of the third circuitry to compensate for a third portion of the defect that remains after the second portion is compensated for by the second circuitry.

7. The system of claim 1, wherein:
the second subpixel and the third subpixel are located on a same scan line of the panel as the first subpixel;
the second subpixel is located on a first side of the first subpixel; and
the third subpixel is located on a second side of the first subpixel, the second side being opposite the first side.

8. The system of claim 1, wherein:
the first circuitry is configured to at least partially compensate for the defect using a set of subpixels configured to emit light of the first color, the set of subpixels including the second subpixel, the third subpixel, and a fifth subpixel;
the first subpixel, the second subpixel, and the third subpixel are located on a first scan line of the panel; and
the fifth subpixel is located on a second scan line of the panel, the second scan line being subsequent to the first scan line.

9. The system of claim 8, wherein the first circuitry is configured to:
compensate for a first subportion of a portion of the defect that is not yet compensated using a first subset of the set of subpixels, the first subset including the second subpixel and the third subpixel; and
in response to determining that a second subportion of the portion remains after compensating for the first subportion, compensate for the second subportion of the portion of the defect using a second subset of the set of subpixels, the second subset including the fifth subpixel.

10. The system of claim 1, wherein the module is configured to identify the defect by determining a difference between:
the value for the first subpixel in the image, and
a capability of the first subpixel, the capability being determined during a calibration process and stored in a memory communicatively coupled to the controller.

11. The system of claim 10, wherein:
the memory includes a map storing performance data for each of the plurality of subpixels, the performance data being determined as part of the calibration process and being configured to facilitate a uniform appearance of the panel; and
the capability is determined based on performance data for the first subpixel that is stored in the map.

12. The system of claim 1, wherein at least one of the first circuitry or the second circuitry is configured to:
determine a portion of the defect that is not yet compensated; and
determine a request value by scaling the portion of the defect by a strength parameter, the strength parameter being based on a number of subpixels used to compensate for the portion of the defect.

13. The system of claim 12, wherein:
the criterion is a parameter set to enable operation of the second circuitry;
the second circuitry determines the portion of the defect and the request value; and
the strength parameter for the second circuitry is further based on a ratio of luminance efficiency between the first color and the second color.

14. The system of claim 1, wherein:
the plurality of subpixels includes a plurality of micro light-emitting diodes (microLEDs); and
the plurality of subpixels are arranged on the panel in a non-rectilinear lattice.

15. A method comprising:
identifying a defect of a deficient subpixel configured to emit light of a first color, the defect being identified based on a value for the deficient subpixel in an image and including a portion of the defect that is not yet compensated;
determining a request value, a headroom of a first same-color surrogate subpixel for the image, and a headroom of a second same-color surrogate subpixel for the image, the first same-color surrogate subpixel and the second same-color surrogate subpixel being configured to emit light of the first color and the request value being based on the portion of the defect;
determining an amount of compensation based on the request value, the headroom of the first same-color surrogate subpixel, and the headroom of the second same-color surrogate subpixel; and
increasing a value for the first same-color surrogate subpixel in the image and a value for the second same-color surrogate subpixel in the image by the amount of compensation.

16. The method of claim 15, further comprising:
determining a second request value based on a first subportion of the defect that is not yet compensated after the increasing of the value for the first same-color surrogate subpixel and the value for the second same-color surrogate subpixel;
determining that a value for a different-color surrogate subpixel in the image exceeds a threshold, the different-color surrogate subpixel being configured to emit light of a second color different from the first color;
determining, based on the determining that the value for the different-color surrogate subpixel exceeds the threshold, a headroom of the different-color surrogate subpixel for the image;
determining a second amount of compensation based on the second request value and the headroom of the different-color surrogate subpixel; and
increasing the value for the different-color surrogate subpixel by the second amount of compensation.

17. The method of claim 16, further comprising:
determining a second subportion of the defect that is not yet compensated after the increasing of the value for the first same-color surrogate subpixel and the value for the second same-color surrogate subpixel and the increasing of the value for the different-color surrogate subpixel;
determining a third amount of compensation based on the second subportion of the defect and a remaining headroom of the first same-color surrogate subpixel for the image;
determining a fourth amount of compensation based on the second subportion of the defect and a remaining headroom of the second same-color surrogate subpixel for the image; and
increasing the value for the first same-color surrogate subpixel by the third amount of compensation and increasing the value for the second same-color surrogate subpixel by the fourth amount of compensation.

18. A method comprising:
determining a defect of a deficient subpixel configured to emit light of a first color, the defect being determined based on a value for the deficient subpixel in an image and including a portion of the defect that is not yet compensated;
determining that a value for a different-color surrogate subpixel in the image exceeds a threshold, the different-color surrogate subpixel being configured to emit light of a second color different from the first color;
determining, in response to the determining that the value for the different-color surrogate subpixel exceeds the threshold, a request value and a headroom of the different-color surrogate subpixel for the image, the request value being based on the portion of the defect;
determining an amount of compensation based on the request value and the headroom of the different-color surrogate subpixel; and
increasing the value for the different-color surrogate subpixel by the amount of compensation.

19. The method of claim 18, further comprising:
determining a first subportion of the defect that is not yet compensated after the increasing of the value for the different-color surrogate subpixel;
determining a second request value, a headroom of a first same-color surrogate subpixel for the image, and a headroom of a second same-color surrogate subpixel for the image, the first same-color surrogate subpixel and the second same-color surrogate subpixel being configured to emit light of the first color and the second request value being based on the first subportion of the defect;
determining a second amount of compensation based on the second request value, the headroom of the first same-color surrogate subpixel, and the headroom of the second same-color surrogate subpixel; and
increasing a value for the first same-color surrogate subpixel in the image and a value for the second same-color surrogate subpixel in the image by the second amount of compensation.

20. The method of claim 19, further comprising:
determining a second subportion of the defect that is not yet compensated after the increasing of the value for the first same-color surrogate subpixel and the value for the second same-color surrogate subpixel and the increasing of the value for the different-color surrogate subpixel;
determining a third amount of compensation based on the second subportion of the defect and a remaining headroom of the first same-color surrogate subpixel for the image;
determining a fourth amount of compensation based on the second subportion of the defect and a remaining headroom of the second same-color surrogate subpixel for the image; and
increasing the value for the first same-color surrogate subpixel by the third amount of compensation and increasing the value for the second same-color surrogate subpixel by the fourth amount of compensation.

21. A method comprising:
identifying a first subpixel within an array of subpixels forming a color image, the first subpixel being identified based on a brightness threshold and being configured to emit light of a first color at a first position within the color image;
selecting a second subpixel within the array of subpixels, the second subpixel being selected based on the first position and the brightness threshold and being configured to emit light of a second color different from the first color at a second position within a proximity threshold of the first position within the color image; and
using the second subpixel to compensate for the first subpixel for a presentation of the color image.

22. The method of claim 21, wherein:
the array of subpixels is implemented by an array of monochrome light emitters of different colors disposed together on a polychromatic pixel panel; and
the color image is produced by the polychromatic pixel panel and a system of optics through which the polychromatic pixel panel emits light.

23. The method of claim 21, wherein:
the array of subpixels is implemented by at least:
a first array of monochrome light emitters of the first color disposed on a first monochromatic pixel panel, and
a second array of monochrome light emitters of the second color disposed on a second monochromatic pixel panel; and
the color image is produced by overlaying, using a system of optics, first light emitted by the first monochromatic pixel panel and second light emitted by the second monochromatic pixel panel.
